(19) United States
(12) Patent Application Publication
(10) Pub. No.: US 2025/0153718 A1
(43) Pub. Date: May 15, 2025

(54) DRIVING ASSISTANCE APPARATUS, DRIVING ASSISTANCE SYSTEM, AND DRIVING ASSISTANCE METHOD

(71) Applicant: Panasonic Automotive Systems Co., Ltd., Kanagawa (JP)

(72) Inventors: Takaaki SEKI, Osaka (JP); Koichi EMURA, Kanagawa (JP); Masataka KATO, Kanagawa (JP)

(73) Assignee: Panasonic Automotive Systems Co., Ltd., Kanagawa (JP)

(21) Appl. No.: 19/025,480

(22) Filed: Jan. 16, 2025

Related U.S. Application Data
(63) Continuation of application No. PCT/JP2023/025912, filed on Jul. 13, 2023.

(30) Foreign Application Priority Data
Oct. 13, 2022 (JP) 2022-165091

(51) Int. Cl. B60W 40/08; B60W 10/06; B60W 10/18; B60W 50/00; B60W 50/14; G06V 20/56; G06V 20/59

(52) U.S. Cl. CPC B60W 40/08; B60W 10/06; B60W 10/18; B60W 50/0097; B60W 50/14; G06V 20/56; G06V 20/597; B60W 2420/403; B60W 2540/229; B60W 2710/06; B60W 2710/18; B60W 2720/106

(57) ABSTRACT

A driving assistance apparatus according to the present disclosure includes a memory and a processor. The processor is coupled to the memory, and configured to: calculate a prediction error that is a difference between a predicted image and an actual image, the predicted image being predicted from an image in a traveling direction of a vehicle captured by a vehicle exterior camera that captures a periphery of the vehicle, an actual situation being captured in the actual image; estimate an attention state of a driver, based on the prediction error; and output driving assistance information for prompting an attention state and/or a behavior change and/or a consciousness change in relation to a driving manipulation, which are more appropriate for driving at that time, based on the attention state.

### CROSS-REFERENCE TO RELATED APPLICATIONS

This application is a continuation of International Application No. PCT/JP2023/025912, filed on Jul. 13, 2023 which claims the benefit of priority of the prior Japanese Patent Application No. 2022-165091, filed on Oct. 13, 2022, the entire contents of which are incorporated herein by reference.

### FIELD

The present disclosure relates to a driving assistance apparatus, a driving assistance system, and a driving assistance method.

### BACKGROUND

A driver drives a vehicle in accordance with traffic regulations while paying attention to a pedestrian, an obstacle, and the like based on a traffic light, a road sign, a lane, and the like. Since a road situation on which the vehicle travels changes from moment to moment, if information for assisting driving can be presented in accordance with the change in the road situation, it is possible to contribute to safe driving and the like.

For example, JP 2021-130389 A discloses a method of estimating an attention function degraded state of a driver based on a surrounding environment of the driver and movement of a gaze of the driver and performing driving assistance. Furthermore, WO 2020/208804 A discloses a method of calculating a visual recognition level indicating ease of recognition by vision of a driver based on gaze direction information, traveling environment information, driving skill information, and the like, and controlling a display position or the like of display information to be presented to the driver.

However, even when there is no attention function degradation due to fatigue or the like or when a traffic environment is easily recognized visually, a person may cause a traffic accident or a traffic near miss event due to a cognitive factor. Therefore, even with techniques of JP 2021-130389 A and WO 2020/208804 A, it is difficult to sufficiently suppress the traffic accident or the traffic near miss event due to the cognitive factor of the driver.

An object of the present disclosure is to provide a driving assistance apparatus, a driving assistance system, and a driving assistance method which are capable of grasping a state in which it is difficult to pay attention to a target to be noted despite a perfect condition for driving and/or a situation in which it is easy to recognize a traffic environment, and appropriately presenting information to the driver.

### SUMMARY

A driving assistance apparatus according to the present disclosure includes a memory and a processor. The processor is coupled to the memory, and configured to: calculate a prediction error that is a difference between a predicted image and an actual image, the predicted image being predicted from an image in a traveling direction of a vehicle captured by a vehicle exterior camera that captures a periphery of the vehicle, an actual situation being captured in the actual image; estimate an attention state of a driver, based on the prediction error; and output driving assistance information for prompting an attention state and/or a behavior change and/or a consciousness change in relation to a driving manipulation, which are more appropriate for driving at that time, based on the attention state.

### BRIEF DESCRIPTION OF THE DRAWINGS

FIG. 1 is a block diagram illustrating an example of a configuration of a vehicle according to a first embodiment;

FIG. 2 is a block diagram illustrating an example of a functional configuration of a driving assistance apparatus according to the first embodiment together with peripheral devices;

FIG. 3 is a schematic view illustrating a flow of an operation of calculating a prediction error by the driving assistance apparatus according to the first embodiment;

FIG. 4 is a graph illustrating a correlation between a prediction error on which the driving assistance apparatus according to the first embodiment relies and a destination of a gaze of a participant of an experiment;

FIG. 5 is a schematic view illustrating a flow of an information presentation operation of the driving assistance apparatus according to the first embodiment;

FIGS. 6A and 6B are schematic views illustrating another example of information presentation by the driving assistance apparatus according to the first embodiment;

FIG. 7 is a flowchart illustrating an example of a procedure of driving assistance processing performed by the driving assistance apparatus according to the first embodiment;

FIGS. 8A and 8B are schematic views illustrating an example of a case where a driving assistance apparatus according to a first modification of the first embodiment changes the number of pieces or amount of presentation information;

FIGS. 9A and 9B are schematic views illustrating an example of a case where the driving assistance apparatus according to the first modification of the first embodiment changes a type of presentation information;

FIGS. 10A and 10B are schematic views illustrating an example of the case in which the driving assistance apparatus according to the first modification of the first embodiment changes a type of presentation information;

FIG. 11 is a schematic view illustrating an example of a case where the driving assistance apparatus according to the first modification of the first embodiment changes a position of presentation information;

FIG. 12 is a schematic view illustrating an example of driving assistance information generated by a driving assistance apparatus according to a second modification of the first embodiment in a case where areas with large prediction errors are scattered in time series;

FIGS. 13A and 13B are schematic views illustrating another example of information presentation by the driving assistance apparatus according to the second modification of the first embodiment in a case where an attention state of a driver is biased;

FIG. 14 is a schematic view illustrating another example of information presentation by the driving assistance apparatus according to the second modification of the first embodiment in the case where the attention state of the driver is biased;

FIGS. 15A and 15B are schematic views illustrating another example of information presentation by the driving assistance apparatus according to the second modification of the first embodiment in the case where the attention state of the driver is biased;

FIG. 16 is a schematic view illustrating an example of driving assistance information generated by the driving assistance apparatus according to the second modification of the first embodiment in a case where areas with large prediction errors are localized in time series;

FIG. 17 is a schematic view illustrating an example of driving assistance information generated by the driving assistance apparatus according to the second modification of the first embodiment in a case where areas with large prediction errors are ubiquitous in time series;

FIG. 18 is a schematic view illustrating an example of driving assistance information generated by the driving assistance apparatus according to the second modification of the first embodiment in a case where the number of areas with large prediction errors increases or decreases in time series;

FIG. 19 is a schematic view illustrating an example of driving assistance information generated by the driving assistance apparatus according to the second modification of the first embodiment in a case where an area with a large prediction error hardly occurs in time series;

FIGS. 20A and 20B are schematic views illustrating another example of presentation in a case where the driving assistance apparatus according to the second modification of the first embodiment suppresses careless driving of the driver;

FIGS. 21A and 21B are schematic views illustrating still another example of presentation in a case where the driving assistance apparatus according to the second modification of the first embodiment suppresses careless driving of the driver;

FIGS. 22A and 22B are schematic views illustrating an example in which a driving assistance apparatus according to a third modification of the first embodiment bisects an image to generate driving assistance information;

FIGS. 23A and 23B are schematic views illustrating another example in which the driving assistance apparatus according to the third modification of the first embodiment bisects the image to generate driving assistance information;

FIG. 24 is a block diagram illustrating an example of a functional configuration of a driving assistance apparatus according to a fourth modification of the first embodiment together with peripheral devices;

FIGS. 25A and 25B are schematic views illustrating an example of information presentation by the driving assistance apparatus according to the fourth modification of the first embodiment;

FIG. 26 is a block diagram illustrating an example of a functional configuration of a driving assistance apparatus according to a fifth modification of the first embodiment together with peripheral devices;

FIGS. 27A and 27B are schematic views illustrating an example of information presentation by the driving assistance apparatus according to the fifth modification of the first embodiment;

FIGS. 28A and 28B are schematic views illustrating another example of information presentation by the driving assistance apparatus according to the fifth modification of the first embodiment;

FIG. 29 is a schematic view illustrating an example of a configuration of a meter display on which the driving assistance apparatus according to the fifth modification of the first embodiment presents latent information;

FIG. 30 is a schematic view illustrating an example of presentation of latent information on the meter display by the driving assistance apparatus according to the fifth modification of the first embodiment;

FIG. 31 is a schematic view illustrating an example in which presentation information generated by the driving assistance apparatus according to the fifth modification of the first embodiment is divided and displayed on an HUD and the meter display;

FIGS. 32A to 32C are schematic view illustrating another example in which presentation information generated by the driving assistance apparatus according to the fifth modification of the first embodiment is divided and displayed on the HUD and the meter display;

FIG. 33 is a schematic view illustrating an example of a configuration of a pillar display on which the driving assistance apparatus according to the fifth modification of the first embodiment presents latent information;

FIG. 34 is a schematic view illustrating an example of presentation of latent information on the pillar display by the driving assistance apparatus according to the fifth modification of the first embodiment;

FIG. 35 is a schematic view illustrating an example in which presentation information generated by the driving assistance apparatus according to the fifth modification of the first embodiment is divided and displayed on the HUD and the pillar display;

FIGS. 36A and 36B are schematic views illustrating another example in which presentation information generated by the driving assistance apparatus according to the fifth modification of the first embodiment is divided and displayed on the HUD and the pillar display;

FIG. 37 is a schematic view illustrating an example in which presentation information generated by the driving assistance apparatus according to the fifth modification of the first embodiment is divided and presented through the HUD and a speaker;

FIGS. 38A and 38B are schematic views illustrating another example in which presentation information generated by the driving assistance apparatus according to the fifth modification of the first embodiment is divided and displayed through the HUD and the speaker;

FIG. 39 is a schematic view illustrating an example of presentation of latent information on an outer peripheral area of the HUD by the driving assistance apparatus according to the fifth modification of the first embodiment;

FIG. 40 is a schematic view illustrating an example of a configuration of an LED display on which the driving assistance apparatus according to the fifth modification of the first embodiment presents latent information;

FIG. 41 is a schematic view illustrating an example of presentation of latent information on the LED display by the driving assistance apparatus according to the fifth modification of the first embodiment;

FIGS. 42A and 42B are schematic views illustrating an example in which presentation information generated by the driving assistance apparatus according to the fifth modification of the first embodiment is presented on the LED display by blinking of LEDS;

FIGS. 43A and 43B are schematic views illustrating an example in which presentation information generated by the driving assistance apparatus according to the fifth modification of the first embodiment is presented on the LED display by lighting the LEDs in a plurality of colors;

FIG. 44 is a schematic view illustrating an example of a configuration of a mirror display on which the driving assistance apparatus according to the fifth modification of the first embodiment presents latent information;

FIG. 45 is a schematic view illustrating an example of presentation of latent information on the mirror display by the driving assistance apparatus according to the fifth modification of the first embodiment;

FIG. 46 is a block diagram illustrating an example of a functional configuration of a driving assistance apparatus according to a sixth modification of the first embodiment together with peripheral devices;

FIGS. 47A and 47B are schematic views illustrating an example of information presentation by the driving assistance apparatus according to the sixth modification of the first embodiment;

FIGS. 48A and 48B are schematic views illustrating another example of information presentation by the driving assistance apparatus according to the sixth modification of the first embodiment;

FIG. 49 is a schematic view illustrating still another example of information presentation by the driving assistance apparatus according to the sixth modification of the first embodiment;

FIG. 50 is a block diagram illustrating an example of a functional configuration of a driving assistance apparatus according to a seventh modification of the first embodiment together with peripheral devices;

FIG. 51 is a block diagram illustrating an example of a functional configuration of a driving assistance apparatus according to a second embodiment together with peripheral devices;

FIG. 52 is a flowchart illustrating an example of a procedure of driving assistance processing performed by the driving assistance apparatus according to the second embodiment;

FIG. 53 is a block diagram illustrating an example of a functional configuration of a driving assistance apparatus according to a third embodiment together with peripheral devices; and

FIG. 54 is a flowchart illustrating an example of a procedure of driving assistance processing performed by the driving assistance apparatus according to the third embodiment.

### DETAILED DESCRIPTION

Hereinafter, embodiments of a driving assistance apparatus, a driving assistance system, and a driving assistance method according to the present disclosure will be described with reference to the drawings.

### First Embodiment

A first embodiment will be described with reference to the drawings.

### (Example of Configuration of Vehicle)

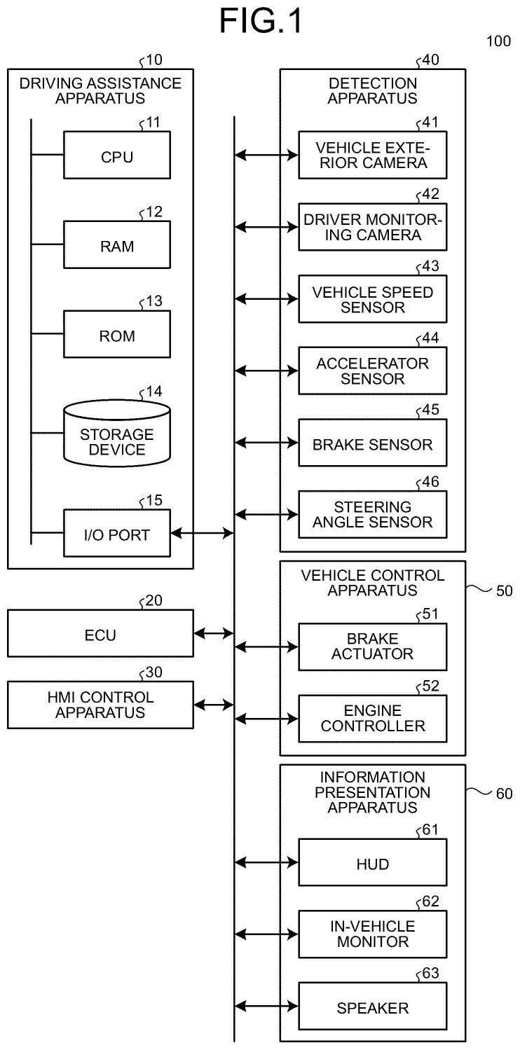

FIG. 1 is a block diagram illustrating an example of a configuration of a vehicle 100 according to the first embodiment. FIG. 1 illustrates various on-vehicle apparatuses mounted in the vehicle 100.

As illustrated in FIG. 1, the vehicle 100 according to the first embodiment includes a driving assistance apparatus 10, an electronic control unit (ECU, on-vehicle electronic controller) 20, a human machine interface (HMI) controller 30, a detection apparatus 40, a vehicle control apparatus 50, and an information presentation apparatus 60.

These on-vehicle apparatuses included in the vehicle 100 are connected by an on-vehicle network such as a controller area network (CAN) so as to be able to transmit and receive information to and from each other.

The driving assistance apparatus 10 is configured as a computer including, for example, a central processing unit (CPU) 11, a read only memory (ROM) 12, a random access memory (RAM) 13, a storage device 14, and an in/out (I/O) port 15. The driving assistance apparatus 10 may be one of ECUs mounted in the vehicle 100.

The CPU 11 controls the entire driving assistance apparatus 10. The ROM 12 functions as a storage area in the driving assistance apparatus 10. The information stored in the ROM 12 is retained even when the driving assistance apparatus 10 is powered off. The RAM 13 functions as a primary storage device and serves as a work area of the CPU 11.

The CPU 11 loads, for example, a control program stored in the ROM 12 or the like into the RAM 13 and executes the control program, thereby implementing various functions of the driving assistance apparatus 10 to be described in detail below.

The storage device 14 is a hard disk drive (HDD), a solid state drive (SSD), or the like, and functions as an auxiliary storage device of the CPU 11. The I/O port 15 is configured to be able to transmit and receive various types of information to and from, for example, the HMI control apparatus 30, a vehicle exterior camera 41 to be described later, and the like.

With such a configuration, the driving assistance apparatus 10 presents information for calling attention to at least a specific area in a traveling direction of the vehicle 100 to a driver of the vehicle 100 through the HMI control apparatus 30 and the information presentation apparatus 60, and assists the driver in driving the vehicle 100.

The ECU 20 is configured as a computer such as an on-vehicle electronic unit including, for example, a CPU, a ROM, a RAM, and the like (not illustrated). The ECU 20 receives a detection result from the detection apparatus 40 that detects a state of each part of the vehicle 100. Furthermore, the ECU 20 transmits various commands to the vehicle control apparatus 50 based on the received detection result to control the operation of the vehicle 100.

The HMI control apparatus 30 as an information presentation control apparatus is configured as a computer including, for example, a CPU, a ROM, a RAM, and the like (not illustrated). The HMI control apparatus 30 may include a graphics processing unit (GPU) instead of or in addition to the CPU. The HMI control apparatus 30 controls the information presentation apparatus 60 that presents various types of information to the driver of the vehicle 100 to present various types of information output from the driving assistance apparatus 10.

The detection apparatus 40 includes the vehicle exterior camera 41, a driver monitoring camera 42, a vehicle speed sensor 43, an accelerator sensor 44, a brake sensor 45, a steering angle sensor 46, and the like, detects a state of each part of the vehicle 100, and transmits the state to the ECU 20.

The vehicle exterior camera 41 and the driver monitoring camera 42 are digital cameras each incorporating an imaging element such as a charge coupled device (CCD) or a CMOS image sensor (CIS), for example.

The vehicle exterior camera 41 captures an image of the periphery of the vehicle 100. A plurality of the vehicle exterior cameras 41 respectively capturing images of the front, rear, side, and the like of the vehicle 100 may be attached to the vehicle 100. The vehicle exterior camera 41 transmits image data obtained by capturing at least the traveling direction of the vehicle 100 to the driving assistance apparatus 10.

The driver monitoring camera 42 is attached to the interior of a passenger compartment of the vehicle 100, and captures an image of a state inside the passenger compartment, such as the face of the driver.

The vehicle speed sensor 43 detects the speed of the vehicle 100 from a rotation amount of wheels included in the vehicle 100. The accelerator sensor 44 detects an amount of manipulation of an accelerator pedal by the driver. The brake sensor 45 detects an amount of manipulation of a brake pedal by the driver. The steering angle sensor 46 detects an amount of manipulation of a steering wheel by the driver, that is, a steering angle.

The vehicle control apparatus 50 includes a brake actuator 51 and an engine controller 52, and performs an operation of avoiding a danger on the vehicle 100 by decelerating the vehicle 100 or the like according to a command from the ECU 20.

The brake actuator 51 brakes the wheels of the vehicle 100 based on a detection result of the brake sensor 45 during normal traveling. The engine controller 52 performs output control of an engine based on a detection result of the accelerator sensor 44 during normal traveling, and executes acceleration/deceleration control of the vehicle 100.

The vehicle control apparatus 50 controls, for example, the brake actuator 51 according to a command from the ECU 20 to brake the vehicle 100, thereby avoiding a collision between the vehicle 100 and an obstacle or the like. Alternatively or in addition, the vehicle control apparatus 50 causes the engine controller 52 to reduce the output of the engine for, for example, several seconds to reduce the acceleration of the vehicle 100, thereby avoiding the collision between the vehicle 100 and the obstacle or the like.

The information presentation apparatus 60 includes a head-up display (HUD) 61, an in-vehicle monitor 62, a speaker 63, and the like in the passenger compartment of the vehicle 100, and presents various types of information to the driver according to a command from the HMI control apparatus 30.

The HUD 61 projects a speed, a shift position, travel guidance, a warning, and the like on a front window (windshield) in front of the driver's seat.

The in-vehicle monitor 62 is, for example, an in-dash monitor or an on-dash monitor configured as a liquid crystal display (LCD), an organic electro luminescence (EL) display, or the like. The in-vehicle monitor 62 displays an image of the periphery of the vehicle 100, traveling guidance, a warning, and the like.

The speaker 63 is incorporated in, for example, a dashboard or the like, and presents a surrounding environment of the vehicle 100, traveling guidance, a warning, and the like to the driver by audio.

With such a configuration, the information presentation apparatus 60 presents various types of information to the driver by video, audio, and the like. The information presentation apparatus 60 may include a display other than the above, such as a light emitting diode (LED) display. Furthermore, the information presentation apparatus 60 may have a configuration of presenting information to the driver by vibration or the like, such as a vibrator provided on the steering wheel, the accelerator pedal, the brake pedal, a seat, a headrest, a seat belt, or the like.

### (Example of Configuration of Driving Assistance Apparatus)

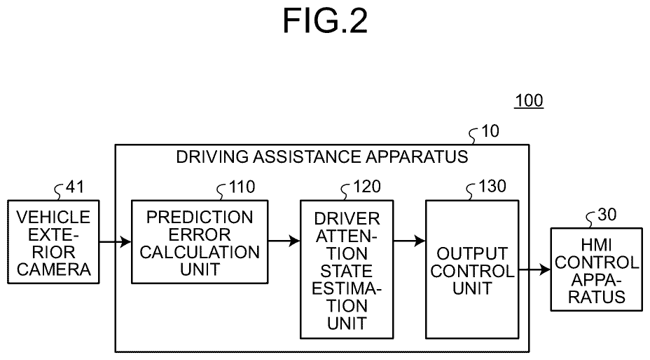

Next, a detailed configuration of the driving assistance apparatus 10 of the first embodiment will be described with reference to FIG. 2.

FIG. 2 is a block diagram illustrating an example of a functional configuration of the driving assistance apparatus 10 according to the first embodiment together with peripheral devices. As illustrated in FIG. 2, the driving assistance apparatus 10 includes a prediction error calculation unit 110, a driver attention state estimation unit 120, and an output control unit 130 as functional configurations.

The prediction error calculation unit 110 generates a predicted image obtained by predicting the future based on an image of the periphery of the vehicle 100 captured by the vehicle exterior camera 41, for example, the image in the traveling direction of the vehicle 100. Furthermore, an actual image at a point in time of the predicted image is acquired from the vehicle exterior camera 41, and an error between the predicted image and the actual image is calculated as a prediction error.

Such a function of the prediction error calculation unit 110 is implemented by, for example, the CPU 11 that executes the control program.

The driver attention state estimation unit 120 estimates an attention state of the driver based on the prediction error calculated by the prediction error calculation unit 110. At this time, the driver attention state estimation unit 120 divides the image acquired from the vehicle exterior camera 41 into a plurality of areas, and estimates how easily each of the areas attracts attention of the driver. As a result, data indicating the attention state of the driver is obtained for each individual area.

Such a function of the driver attention state estimation unit 120 is implemented by, for example, the CPU 11 that executes the control program.

The output control unit 130 determines an area to which the attention of the driver is to be called among the plurality of areas in the image based on the attention state of the driver estimated by the driver attention state estimation unit 120. Furthermore, the output control unit 130 outputs, to the HMI control apparatus 30, driving assistance information including information regarding the determined area to which the attention is to be called. The driving assistance information includes, for example, presentation information to be presented to the driver, a presentation mode, and the like in association with the area to which the attention is to be called.

Such a function of the output control unit 130 is implemented by, for example, the CPU 11 that executes the control program and the I/O port 15 that operates under the control of the CPU 11.

The HMI control apparatus 30 selects a device that causes the driver to present information from among the HUD 61, the in-vehicle monitor 62, the speaker 63, and the like included in the information presentation apparatus 60 described above based on the driving assistance information output from the driving assistance apparatus 10, and transmits a command including an area where information is to be presented, the presentation mode, and the like among the plurality of areas in the image to the selected information presentation apparatus 60.

As a result, the information presentation apparatus 60 presents information in a predetermined mode in the area to which the attention is to be called among the plurality of areas in the image, for example. That is, in a case where the HUD 61 or the in-vehicle monitor 62 of the information presentation apparatus 60 is an object by which information is presented, the HUD 61 or the in-vehicle monitor 62 displays the image of the vehicle exterior camera 41 and superimposes and displays the presentation information on the predetermined area of the image. Furthermore, in a case where the speaker 63 of the information presentation apparatus 60 is an object by which information is presented, the speaker 63 outputs an announcement for warning to pay attention to the predetermined area of the vehicle 100, such as the traveling direction of the vehicle 100, or audio such as a warning sound to the interior of the vehicle.

### (Example of Generation of Driving Assistance Information)

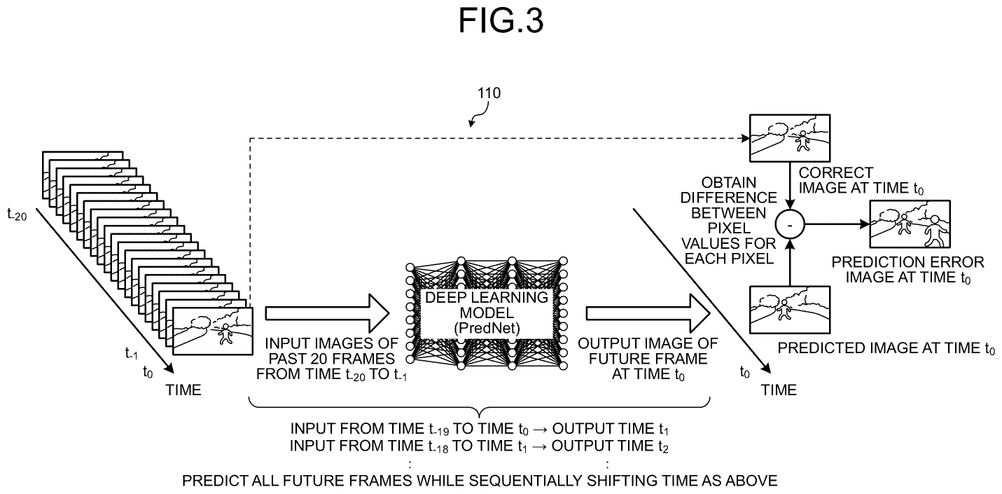

Next, an example of generation of driving assistance information by the driving assistance apparatus 10 according to the first embodiment will be described with reference to FIGS. 3 to 5.

FIG. 3 is a schematic view illustrating a flow of an operation of calculating a prediction error by the driving assistance apparatus 10 according to the first embodiment. As illustrated in FIG. 3, the prediction error calculation unit 110 of the driving assistance apparatus 10 generates a predicted image based on a prediction model “PredNet”.

Here, “PredNet” is a prediction model that mimics processing of predictive coding in the cerebral cortex and is constructed, for example, in a framework of deep learning. “PredNet” is described in detail in a document such as “Lotter, W., Kreiman, G., and Cox, D., “Deep predictive coding networks for video prediction and unsupervised learning”, https://arxiv.org/abs/1605.08104”.

Specifically, when images for a plurality of frames, such as 20 frames, captured by the vehicle exterior camera 41 are supplied, the prediction error calculation unit 110 generates a predicted image corresponding to a future frame for the images for the plurality of frames based on the prediction model “PredNet”.

That is, for example, if images from time t₋₂₀ to time t₋₁ are supplied, the prediction error calculation unit 110 generates a predicted image of a future frame at time to based on the prediction model “PredNet”. Similarly, the prediction error calculation unit 110 generates a predicted image of a future frame at time t₁ from the images from time t₋₁₉ to time t₋₀. Similarly, the prediction error calculation unit 110 generates a predicted image of a future frame at time t₂ from the images from time t₋₁₈ to time t₋₁.

As described above, the prediction error calculation unit 110 generates predicted images of future frames for all the images by using images whose time is shifted frame by frame. Note that the number of frames of images used to generate a predicted image may be any number of frames according to design or the like, such as 30 frames.

The prediction error calculation unit 110, uses an actual image, actually captured by the vehicle exterior camera 41 at the time of a generated predicted image, as a correct image, compares the generated predicted image with the correct image in units of pixels, and generates a prediction error image based on a difference between the respective pixel values of the two images.

FIG. 3 illustrates an example in which a prediction error image at the time to is generated based on a difference between pixel values of the predicted image at the time to and an actual image at the time to which is the correct image.

Furthermore, the prediction error calculation unit 110 calculates values of pixels of the prediction error image and sets the values as values of prediction errors. Furthermore, the prediction error calculation unit 110 divides the entire image area of the generated predicted image into a plurality of areas, and calculates a sum, an average, or the like of the prediction errors for each individual area.

Here, a value related to the prediction error, such as the sum or the average of the prediction errors of each individual area, is an index indicating which area is more likely to attract the attention of the driver than the other areas.

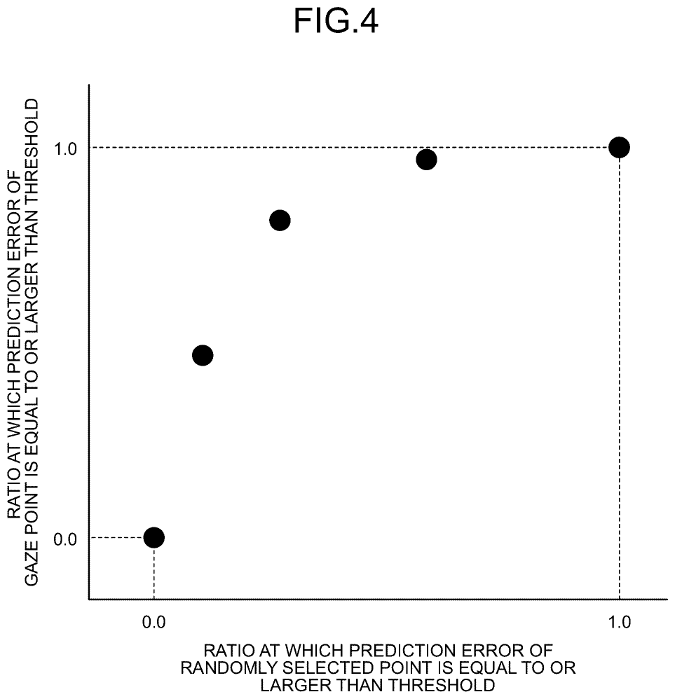

FIG. 4 is a graph illustrating a correlation between a prediction error on which the driving assistance apparatus 10 according to the first embodiment relies and a destination of a gaze of a participant of an experiment. The horizontal axis of the graph illustrated in FIG. 4 represents a ratio at which a prediction error of a randomly selected pixel is equal to or larger than a threshold. The vertical axis of the graph represents a ratio at which a prediction error of the destination of the gaze of the participant is equal to or larger than the threshold. The graph of FIG. 4 can be obtained as follows.

First, a value of a prediction error of a pixel, which is a destination of a gaze of the driver, in a front-view video during driving viewed by the driver is acquired. Furthermore, a value of a prediction error of a pixel randomly extracted from the same video is acquired. Furthermore, a threshold for the prediction errors is changed from the minimum value to the maximum value to calculate ratios at which the acquired prediction errors are equal to or larger than the threshold.

The ratio at which the prediction error of the randomly selected pixel is equal to or larger than the threshold is plotted on the horizontal axis of the graph plots, and the ratio at which the prediction error of the destination of the gaze of the participant is equal to or larger than the threshold is plotted on the vertical axis of the graph, thereby obtaining the graph illustrated in FIG. 4. As a result, the correlation between the prediction error and the destination of the gaze of the driver is evaluated from an area under curve (AUC) value of a curve drawn as in FIG. 4.

Here, it is assumed that attention tends to be attracted to a portion where the prediction error is large when the AUC value is larger than 0.5. Similarly, it is assumed that there is no correlation therebetween when the AUC value is 0.5.

The driver attention state estimation unit 120 of the driving assistance apparatus 10 is configured to estimate the attention state of the driver based on the above evaluation. That is, the driver attention state estimation unit 120 estimates an area that is likely to attract the attention of the driver based on a value of the prediction error, a variance value, or the like. More specifically, the driver attention state estimation unit 120 estimates, as the attention state of the driver, a state in a case where the area that is likely to attract the attention of the driver or an area that is less likely to attract the attention of the driver, the area being estimated from the prediction error, is biased to the left, right, or the like with respect to a central portion of the image, excessively concentrated on a part, or excessively dispersed throughout, or the like. As described above, the driver attention state estimation unit 120 estimates the attention state of the driver based on not only a magnitude of the value of the prediction error, the variance value, or the like but also a spatial arrangement of the prediction error or the like.

As an actual procedure, the driver attention state estimation unit 120 divides the entire image area of the image of the vehicle exterior camera 41 into a plurality of areas similar to the plurality of areas of the predicted image, and estimates the attention state of the driver in the plurality of areas. That is, for example, as a prediction error of a target area is larger, it is estimated that the area is more likely to attract the attention of the driver. Furthermore, the driver attention state estimation unit 120 estimates the attention states of the driver also with the spatial arrangement of the prediction error added as a determination requirement of the attention state of the driver as described above.

The output control unit 130 of the driving assistance apparatus 10 determines an area to which the attention of the driver is to be called or the like according to the attention state of the driver in each of the areas. That is, when it is estimated that the attention state of the driver is in an inappropriate state due to a bias or the like in the attention state of the driver based on the values of the prediction errors or the variance value, it is considered that there is an area to which the attention of the driver is little. Therefore, the output control unit 130 extracts an area estimated to attract little attention of the driver as an area to which it is necessary to call the attention of the driver or an area to which the attention needs to be paid to return the attention of the driver to an appropriate state.

As described above, there is a possibility that a latent danger not manifested at that time is included in the area where the driver does not pay sufficient attention and it is necessary to call the attention of the driver or to prompt correction of the attention. For example, when an event that has already occurred, such as a pedestrian jumping out to a roadway, is defined as a danger that has been manifested at that time, a situation in which the drive unconsciously pays attention to a fence at a left end of the roadway, a vehicle parked on a road, a bicycle parked on a sidewalk, or the like is likely to hinder the driver from quickly reacting to a vehicle appearing from the right or the like, and may be a latent danger. The driving assistance apparatus 10 can also present information indicating such a latent danger to the driver. Hereinafter, the information given to the driver by the driving assistance apparatus 10 is also referred to as latent information or the like.

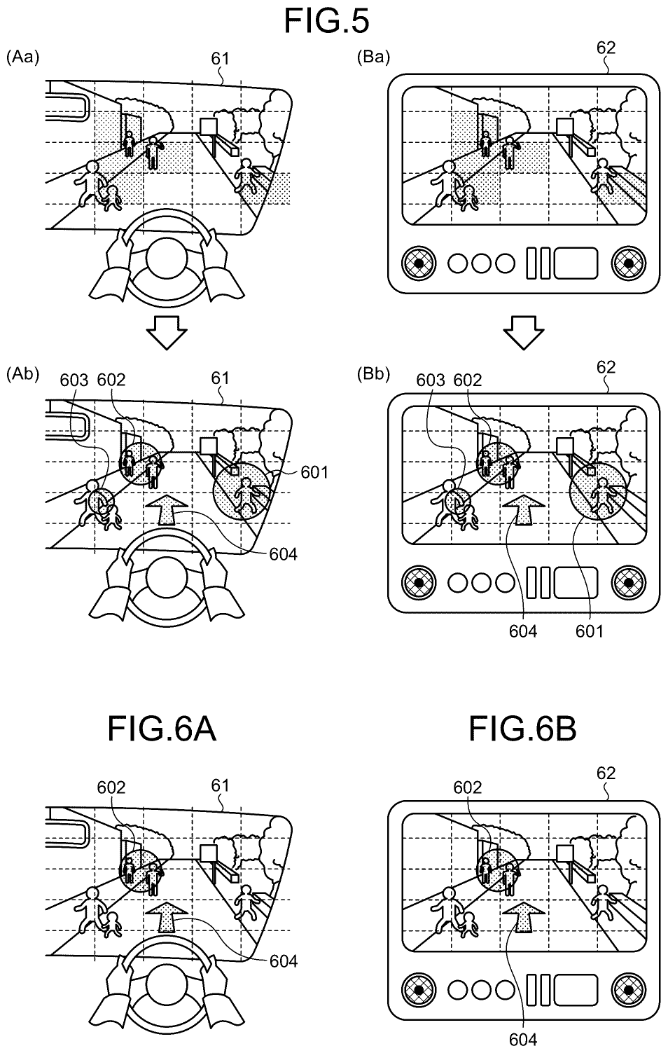

FIG. 5 illustrates display examples of the latent information on the HUD 61 and the in-vehicle monitor 62 based on the above.

FIG. 5 is a schematic view illustrating a flow of an information presentation operation of the driving assistance apparatus 10 according to the first embodiment. FIG. 5 illustrates the display example of the latent information on the HUD 61 at (Aa) to (Ab), and illustrates the display example of the latent information on the in-vehicle monitor 62 at (Ba) to (Bb).

Note that FIG. 5 is an example of a case where information is presented on at least any of the HUD 61 and the in-vehicle monitor 62. However, on the HUD 61 and the in-vehicle monitor 62, information may be presented in different modes, or different pieces of information may be presented. That is, when information is presented on both the HUD 61 and the in-vehicle monitor 62, display contents of the HUD 61 and the in-vehicle monitor 62 may be different.

As illustrated at (Aa) and (Ba) in FIG. 5, the driver attention state estimation unit 120 divides the image of the vehicle exterior camera 41 into the plurality of areas of, for example, 5×5 areas in height×width, that is, 25 areas in total, and estimates the attention state of the driver based on a sum of values of prediction errors in each of the areas.

At (Aa) and (ba) in FIG. 5, hatching is applied to areas each having a high prediction error and being likely to attract the attention of the driver. That is, in the example of (Aa) and (Ba) in FIG. 5, for example, areas including a parent accompanying a child on the near left of the image, two persons on the far left of the image, and a person walking on a sidewalk on the near right of the image, respectively, are areas where the attention state of the driver is estimated to be biased.

However, since the attention state of the driver is estimated by the internal operation of the driver attention state estimation unit 120, FIG. 5 does not illustrate actual display examples of the HUD 61 and the in-vehicle monitor 62 at (Aa) and (Ba).

The driver attention state estimation unit 120 determines values of the prediction errors, a variance value, and the like based on one or more thresholds to estimate the attention state of the driver, and accordingly, estimates a state in which an area that is likely to attract the attention of the driver or an area that is less likely to attract the attention of the driver is biased to the left, right, or the like with respect to the central portion of the image, excessively concentrated on a part, excessively dispersed throughout, or the like. That is, for example, the prediction error is sorted to low, medium, high, or the like according to the likelihood of attracting the attention of the driver based on the three thresholds, and a bias, a degree of concentration, a degree of dispersion, or the like of the attention of the driver is matched with low, medium, high, or the like.

The output control unit 130 determines an area to which the attention of the driver is to be called based on the attention state of the driver estimated by the driver attention state estimation unit 120. That is, areas on the right of the image opposite to the areas including the parent accompanying the child on the near left and the two persons on the far left, which easily attract the attention of the driver, areas on the left of the image opposite to the areas including the person walking on the sidewalk on the near right of the image, and the like may be areas for calling the attention of the driver.

The output control unit 130 outputs, to the HMI control apparatus 30, the presentation information to be displayed in the area on the right of the image and the area on the left of the image, which are opposite to the areas that are likely to attract the attention of the driver, and driving assistance information including the presentation mode and the like. At this time, the output control unit 130 may include, in the presentation mode, information on a magnitude of an intensity of attention calling of the presentation information to be displayed in each area based on the bias, the degree of concentration, the degree of dispersion, or the like of the attention of the driver estimated according to the values of the prediction errors, the variance value, or the like.

As illustrated at (Ab) and (Bb) in FIG. 5, the HMI control apparatus 30 causes the HUD 61 or the in-vehicle monitor 62 to display information to be presented to the driver based on the driving assistance information output from the driving assistance apparatus 10.

In the example of at (Ab) and (Bb) in FIG. 5, the HUD 61 or the in-vehicle monitor 62 displays, for example, latent information 601 to 603 and an arrow 604 as the presentation information. Pieces of the latent information 601 to 603 are, for example, circles indicating a pedestrian and the like. The arrow 604 indicates, for example, the front of the vehicle 100 and indicates the traveling direction of the vehicle 100.

Furthermore, pieces of the latent information 601 to 603 sequentially increases in size, that is, the diameter of the circle in the example of (Ab) and (Bb) in FIG. 5. This indicates that biases or the like of the attention of the driver estimated from the prediction errors in areas opposite to display areas of pieces of the latent information 601 to 603, respectively, increase in order.

That is, it is considered that the attention of the driver is easily attracted to the areas including the parent accompanying the child on the near left of the image, the areas opposite to the areas where the latent information 601 indicating the person on the near right of the image is displayed, and the attention of the driver is hardly attracted to the areas including the person on the near right of the image, the areas opposite to the areas where the latent information 603 indicating the parent accompanying the child is displayed. Furthermore, the bias of the attention of the driver in the areas on the far left of the image opposite to the areas where the latent information 602 indicating the two persons on the far left of the image is displayed is medium.

In practice, the driver may be attracted by the parent accompanying the child on the near left, and may pay little attention to the person on the near right. In regard to this, it is possible to more strongly call the attention of the driver by displaying a latent information 501 indicating the person on the near right to be relatively large.

As described above, the biases of the attention of the driver or the like are estimated according to the prediction errors of the respective areas, and the sizes of pieces of the latent information 601 to 603 displayed in the areas opposite to such biases are changed, so that it is possible to adjust an effect of distributing the attention of the driver.

Note that the output control unit 130 may change a brightness, a color, or the like of each piece of the latent information 601 to 603 in accordance with the bias, the degree of concentration, the degree of dispersion, or the like of the attention of the driver instead of or in addition to the size of each piece of the latent information 601 to 603, thereby adjusting the effect of distributing the attention of the driver.

Furthermore, the arrow 604 indicating the traveling direction of the vehicle 100 can return the attention of the driver who tends to be paid to the left and right of the traveling direction of the vehicle 100 to the traveling direction of the vehicle 100.

Note that, even when one or more thresholds are provided for the bias, the degree of concentration, the degree of dispersion, or the like of the attention of the driver as described above, there may be a case where the bias, the degree of concentration, the degree of dispersion, or the like of the attention of the driver having a magnitude exceeding the thresholds is not included in the image. An example of display in such a case is illustrated in FIGS. 6A and 6B.

FIGS. 6A and 6B are schematic views illustrating another example of information presentation by the driving assistance apparatus 10 according to the first embodiment. FIG. 6A is a display example of the latent information on the HUD 61, and FIG. 6B is a display example of the latent information on the in-vehicle monitor 62.

In the example of FIGS. 6A and 6B, it is assumed that only the bias of the attention of the driver corresponding to a medium magnitude among low, medium, and high is included in the image, for example, in the case where the bias, the degree of concentration, the degree of dispersion, or the like of the attention of the driver has been determined based on the three thresholds.

As illustrated in FIGS. 6A and 6B, in such a case, the driving assistance apparatus 10 causes the HUD 61 or the in-vehicle monitor 62 via the HMI control apparatus 30 to display the latent information 602 indicating the two persons in areas opposite to areas where a magnitude of the bias of the attention of the driver is medium, that is, the areas including the two persons on the far left of the image. At this time, the driving assistance apparatus 10 can output, to the HMI control apparatus 30, driving assistance information including the latent information 602 having a size corresponding to the magnitude of the bias of the attention of the driver.

Note that, also in this case, the output control unit 130 may change the brightness, color, or the like of each piece of the latent information 601 to 603 in accordance with the bias of the attention of the driver instead of or in addition to the size of each piece of the latent information 601 to 603, thereby adjusting the effect of distributing the attention of the driver.

As described above, for example, even when not all the pieces of the latent information 601 to 603 are displayed, it is preferable to display any of the latent information 601 to 603 with an intensity corresponding to the attention state of the driver.

Furthermore, the driving assistance apparatus 10 can hide the latent information, for example, when the vehicle 100 is traveling at a low speed or when the vehicle 100 is stopped. As a result, it is possible to prevent the driver from being bothered by displaying unnecessary information.

Note that a case where it is estimated that the attention of the driver is biased based on the values of the prediction errors, the variance value, or the like has been described in FIGS. 5 and 6 described above. However, as described above, the attention state of the driver also includes the degree of concentration, the degree of dispersion, and the like of the attention of the driver in addition to the case where the attention is biased, and the driving assistance apparatus 10 can comprehensively detect a case where such an attention state of the driver is estimated not to be appropriate state.

Therefore, for example, in a case where it is estimated that the attention of the driver is excessively concentrated on one point or the like based on the values of the prediction errors, the variance value, and the like, the driving assistance apparatus 10 may perform information presentation having an effect of causing the driver to pay attention to the entire periphery of the vehicle 100 or the entire image. Furthermore, in a case where it is estimated that the attention of the driver is excessively dispersed throughout, for example, based on the values of the prediction errors, the variance value, and the like, the driving assistance apparatus 10 may perform information presentation having an effect of returning the attention of the driver to the traveling direction of the vehicle 100 or the central portion of the image.

In this manner, when the area that is likely to attract the attention of the driver or the area that is less likely to attract the attention of the driver, the area being estimated from the prediction error, is biased with respect to the central portion of the image, excessively concentrated on a part, or excessively dispersed throughout, the driving assistance apparatus 10 of the first embodiment presents information for attracting the attention of the driver to an area opposite to such an area

Furthermore, in a case where information is presented by the speaker 63 or the like, the information can be presented to the driver with an intensity corresponding to the magnitude of the bias, the degree of concentration, the degree of dispersion, or the like of the attention of the driver by adjusting the volume of audio such as an announcement or a warning sound. Furthermore, in a case where information is presented by the vibrator or the like provided on the steering wheel, the accelerator pedal, the brake pedal, the seat, the headrest, the seat belt, or the like, it is possible to present the information to the driver with an intensity corresponding to the magnitude of the bias, the degree of concentration, the degree of dispersion, or the like of the attention of the driver by adjusting the intensity of vibration.

### (Example of Processing of Driving Assistance Apparatus)

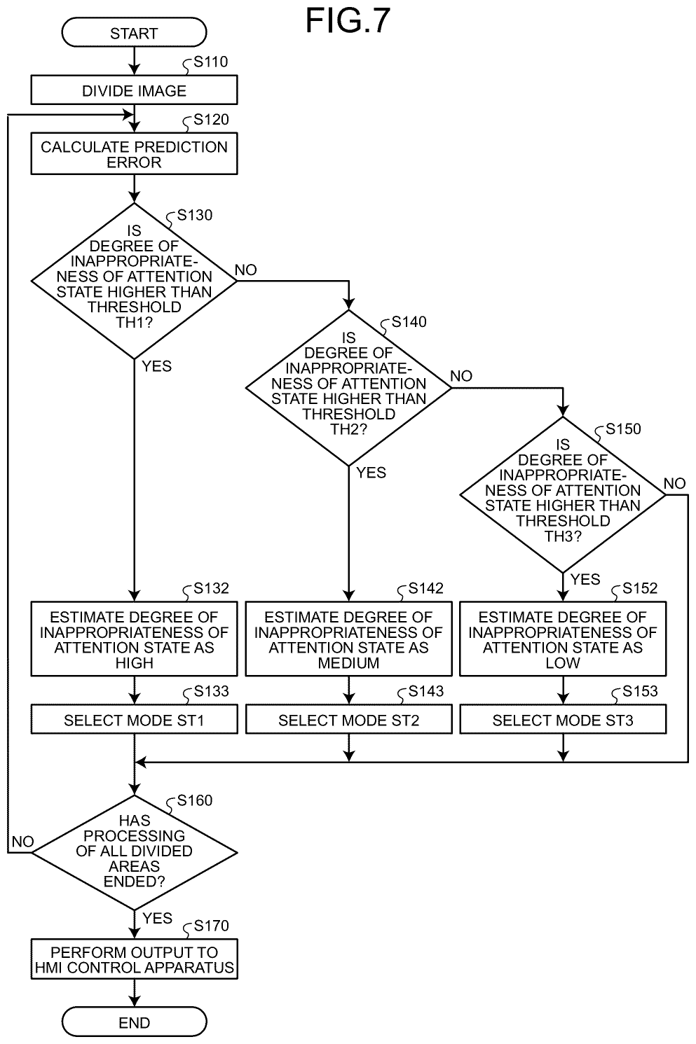

Next, an example of driving assistance processing in the driving assistance apparatus 10 of the first embodiment will be described with reference to FIG. 7. FIG. 7 is a flowchart illustrating an example of a procedure of the driving assistance processing performed by the driving assistance apparatus 10 according to the first embodiment.

As illustrated in FIG. 7, the prediction error calculation unit 110 of the driving assistance apparatus 10 generates predicted images corresponding to a plurality of images based on the respective images, and divides each of the predicted images into a plurality of areas (Step S110). Furthermore, the prediction error calculation unit 110 calculates, for each of the plurality of areas, a value related to the prediction error, such as a sum or an average of the prediction errors, which can be used to estimate the attention state of the driver (Step S120).

The driver attention state estimation unit 120 similarly divides an image captured by the vehicle exterior camera 41 into a plurality of areas, and determines whether or not a degree to which the attention state of the driver is not appropriate in a predetermined area is higher than a threshold TH1 based on the value related to the prediction error (Step S130).

When the prediction error is larger than the threshold TH1 (Step S130: Yes), the driver attention state estimation unit 120 estimates that the degree of inappropriateness of the attention state is high, for example, as the attention of the driver to the area is biased, excessively concentrated, or excessively dispersed (Step S132). The output control unit 130 extracts an area opposite to the area, and selects a mode ST1 having a strong intensity of attention calling as a mode of presentation information to be displayed in the extracted area (Step S133).

When the prediction error is equal to or smaller than the threshold TH1 (Step S130: No), the driver attention state estimation unit 120 determines whether or not the degree to which the attention state of the driver is not appropriate in the area is higher than a threshold TH2 based on the value related to the prediction error (Step S140). A value smaller than the threshold TH1 is set as the threshold TH2.

When the prediction error is larger than the threshold TH2 (Step S140: Yes), the driver attention state estimation unit 120 estimates that the degree of inappropriateness of the attention state of the driver for the area is medium (Step S142). The output control unit 130 extracts an area opposite to the area, and selects a mode ST2 having a medium intensity of attention calling as a mode of presentation information to be displayed in the extracted area (Step S143).

When the prediction error is equal to or smaller than the threshold TH2 (Step S140: No), the driver attention state estimation unit 120 determines whether or not the degree to which the attention state of the driver is not appropriate in the area is higher than a threshold TH3 based on the value related to the prediction error (Step S150). A value smaller than the threshold TH2 is set as the threshold TH3.

When the prediction error is larger than the threshold TH3 (Step S150: Yes), the driver attention state estimation unit 120 estimates that the degree of inappropriateness of the attention state of the driver for the area is low (Step S152). The output control unit 130 extracts an area opposite to the area, and selects a mode ST3 having a low intensity of attention calling as a mode of presentation information to be displayed in the extracted area (Step S153).

When the prediction error is equal to or smaller than the threshold TH3 (Step S150: No), the driver attention state estimation unit 120 determines that the attention state of the driver between the area and an area opposite to the area is not in an inappropriate state to the extent that driving of the vehicle 100 may be hindered, and proceeds to a process of Step S160.

After these processes, the driving assistance apparatus 10 determines whether or not the processing for all the divided areas has ended (Step S160). When there is an unprocessed area (Step S160: No), the driving assistance apparatus 10 repeats the processing from Step S120. When the processing for all the areas has ended (Step S160: Yes), the output control unit 130 outputs the generated driving assistance information to the HMI control apparatus 30 (Step S170).

Thus, the driving assistance processing by the driving assistance apparatus 10 of the first embodiment ends.

### Overview

According to the driving assistance apparatus 10 of the first embodiment, the attention state of the driver is estimated for each of the plurality of areas in the image based on the prediction error, which is the difference between the predicted image predicted from the image in the traveling direction of the vehicle 100 captured by the vehicle exterior camera 41 and the actual image in which an actual situation is captured, and the driving assistance information including the information regarding the area to which the attention of the driver is to be called among the plurality of areas in the image is output based on the estimated attention state.

As a result, it is possible to grasp an area where a cognitive error is likely to occur even if the driver's attention function is normal, an area where a cognitive error is likely to occur even if information is presented to be easily recognized, and the like as the area to which the attention of the driver is to be called or the area to which the attention needs to be distributed to return the attention of the driver to an appropriate state.

According to the driving assistance apparatus 10 of the first embodiment, an area in which the prediction error is larger than a predetermined threshold is extracted from among the plurality of areas in the image, and at least any state in which the extracted area is biased from the center of the plurality of areas, excessively concentrated on a part, and/or excessively dispersed throughout is estimated. Furthermore, when it is estimated that the attention state of the driver corresponds to any of the above states, an area opposite to the extracted area is extracted as the area to which the attention of the driver is to be called. As a result, it is possible to extract the area opposite to the area in which the degree of inappropriateness of the attention state of the driver is high as the area where the driver is likely to make a cognitive error.

According to the driving assistance apparatus 10 of the first embodiment, pieces of information, such as the latent information 601 to 603 and the arrow 604 which are associated with the areas for calling the attention of the driver and presented to the driver, are output to the HMI control apparatus 30, and the latent information 601 to 603, the arrow 604, and the like are presented to the information presentation apparatus 60 in association with the areas for calling the attention. As a result, it is possible to distribute the attention of the driver to an area to which the driver tends to pay little attention and a cognitive error is likely to occur.

According to the driving assistance apparatus 10 of the first embodiment, as the degree of inappropriateness of the attention state in the area to which the attention of the driver is to be called is higher, information, such as the latent information 601 to 603, having a higher intensity of calling the attention of the driver or having a higher effect of guiding the attention of the driver to an appropriate state is output. As a result, it is possible to cause the information presentation apparatus 60 to present the latent information 601 to 603 or the like by adjusting the intensity of calling the attention of the driver according to the degree of inappropriateness of the attention state of the driver.

### First Modification

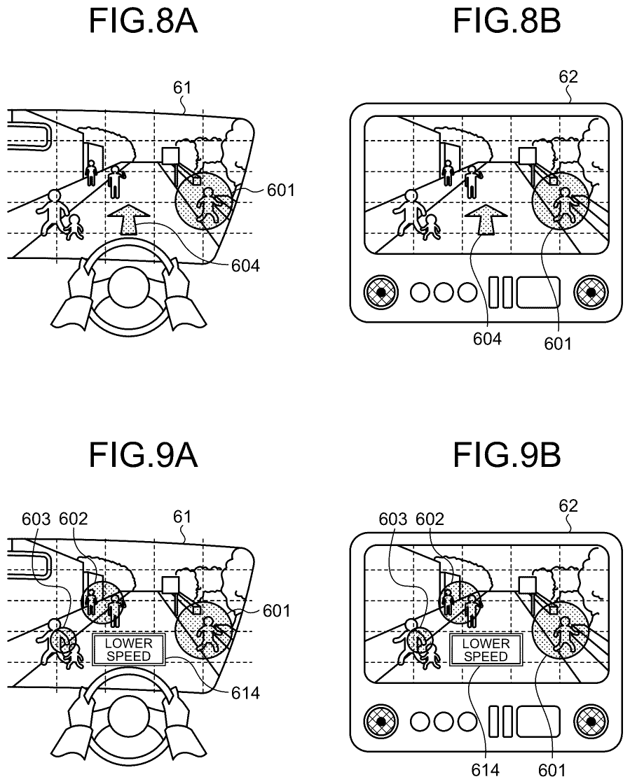

Next, a driving assistance apparatus according to a first modification of the first embodiment will be described with reference to FIGS. 8 to 11. The driving assistance apparatus of the first modification is different from that of the above-described first embodiment described above in that the number of pieces, an amount, a position, a type, and the like of information to be presented by the information presentation apparatus 60 are changed.

FIGS. 8A and 8B are schematic views illustrating an example in which the driving assistance apparatus according to the first modification of the first embodiment changes the number of pieces or amount of presentation information.

As illustrated in FIGS. 8A and 8B, the driving assistance apparatus according to the first modification causes the HUD 61 or the in-vehicle monitor 62 to display only the latent information 603 based on the highest degree of inappropriateness among pieces of the latent information 601 to 603 based on a magnitude of the degree of inappropriateness of the attention state of the driver classified by the plurality of thresholds TH1 to TH3, for example.

As a result, it is possible to preferentially present information such as the latent information 603 in an area where the attention of the driver is extremely little and risk is higher. Therefore, it is possible to prevent a plurality of pieces of information from being presented and distracting the attention of the driver, and to distribute the attention of the driver to a more important portion.

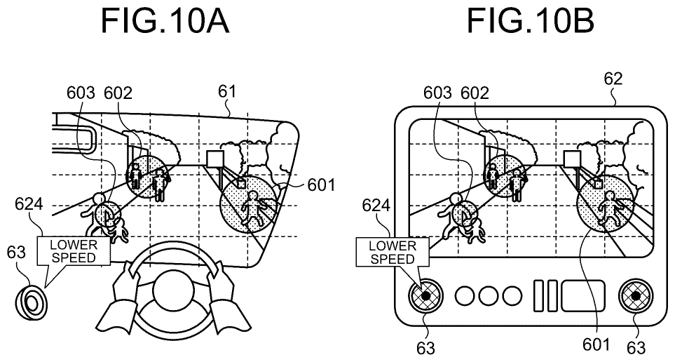

FIGS. 9 and 10 are schematic views illustrating examples of a case where the driving assistance apparatus according to the first modification of the first embodiment changes a type of presentation information.

As illustrated in FIGS. 9A and 9B, the driving assistance apparatus according to the first modification causes the HUD 61 or the in-vehicle monitor 62 to display a message 614 for calling attention, for example, “Lower speed” instead of the arrow 604 indicating the traveling direction of the vehicle.

As illustrated in FIGS. 10A and 10B, the driving assistance apparatus according to the first modification may cause the speaker 63 to output an announcement 624 for calling attention, for example, “Lower speed” instead of the arrow 604 indicating the traveling direction of the vehicle. The presentation information output from the speaker 63 may be a warning sound or the like.

With configurations of FIGS. 9 and 10, since pieces of the presentation information of types different from the latent information 601 to 603 are presented, the attention of the driver is more reliably distributed to each piece of information. Furthermore, since information presentation with respect to the driver is performed with language information such as the message 614 or the announcement 624 depending on the content of attention calling, the driver can more accurately grasp the information.

FIG. 11 is a schematic view illustrating an example of a case where the driving assistance apparatus according to the first modification of the first embodiment changes a position of presentation information.

As illustrated at (Aa) and (Ba) in FIG. 11, it is assumed that a plurality of areas where the degree of inappropriateness of the attention state of the driver is high are extracted by the driving assistance apparatus of the first modification. The driving assistance apparatus of the first modification determines ease of recognition by the driver according to the extracted areas, and preferentially presents information in an area which is more difficult for the driver to recognize and in which a cognitive error is more likely to occur.

The ease of recognition by the driver may be set in advance for each of a plurality of divided areas of an image, for example. Alternatively, the ease of recognition by the driver may be appropriately determined by the driving assistance apparatus of the first modification according to a road situation in the traveling direction of the vehicle or the like grasped from the image at that time.

In an example illustrated at (Ab) and (Bb) in FIG. 11, the driving assistance apparatus according to the first modification determines that areas including a person on the near right opposite to areas including a parent accompanying a child among the plurality of extracted areas are areas that are more difficult for the driver to recognize, and displays latent information 612 indicating the person on the near right.

In an example illustrated at (Ac) and (Bc) in FIG. 11, the driving assistance apparatus according to the first modification determines that areas including the parent accompanying the child on the near left and two persons on the far left opposite to the areas including the person on the near right among the plurality of extracted areas are areas that are more difficult for the driver to recognize, and displays the latent information 612 indicating the parent accompanying the child and the people.

As a result, the presentation information such as the latent information 612 can be preferentially presented in an area where the driver is more likely to make a cognitive error. Therefore, the cognitive error by the driver can be further suppressed.

According to the driving assistance apparatus of the first modification, effects similar to those of the driving assistance apparatus 10 of the first embodiment described above are obtained in addition to the above.

### Second Modification

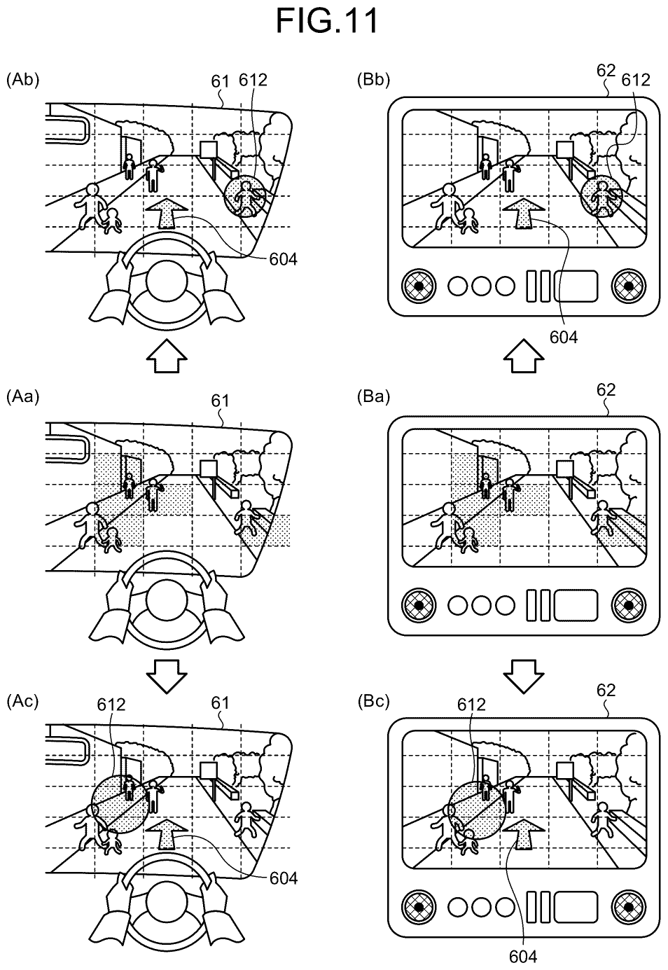

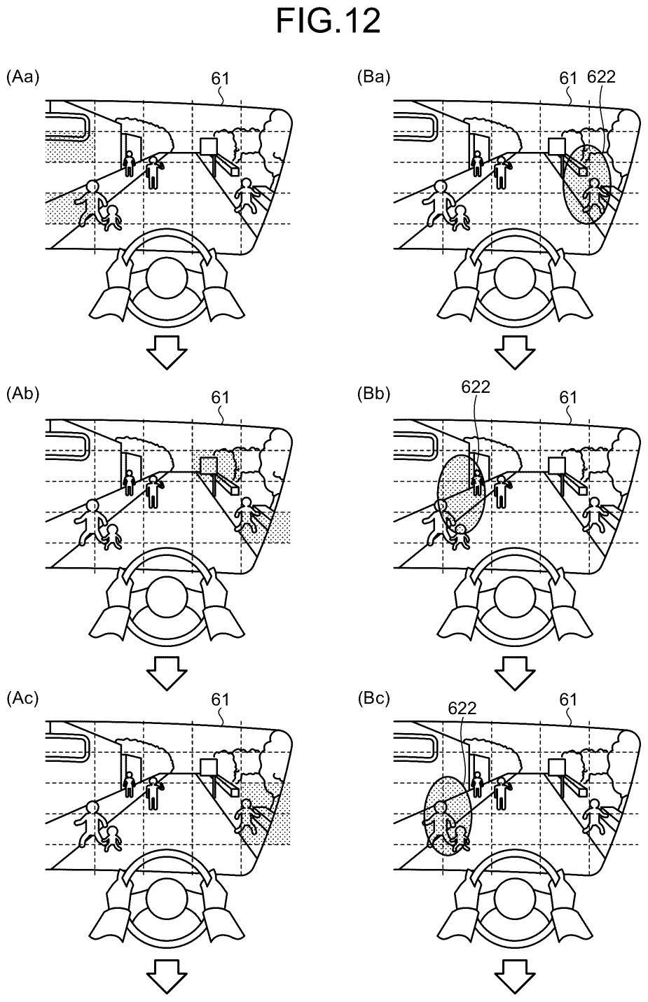

Next, a driving assistance apparatus according to a second modification of the first embodiment will be described with reference to FIGS. 12 to 21. The driving assistance apparatus of the second modification is different from that of the above-described first embodiment in that driving assistance information is generated based on time-series data.

FIG. 12 is a schematic view illustrating an example of the driving assistance information generated by the driving assistance apparatus according to the second modification of the first embodiment in a case where areas in which a degree at which the attention of the driver is attracted is high are scattered in time series.

FIG. 12 illustrates, at (Aa) to (Ac), time-series data referred to when the driving assistance apparatus of the second modification generates the driving assistance information. At (Aa) to (Ac) in FIG. 12, hatching is applied to areas where a degree at which the attention of the driver is attracted is estimated to be high. However, this does not mean that images illustrated at (Aa) to (Ac) in FIG. 12 are actually displayed on the HUD 61 or the like.

In an example illustrated at (Aa) in FIG. 12, areas where a degree at which the attention of the driver is attracted is high are extracted on the left of the image by the driving assistance apparatus of the second modification. In an example illustrated at (Ab) in FIG. 12, areas where a degree at which the attention of the driver is attracted is high are extracted on the right of the image by the driving assistance apparatus of the second modification. In an example illustrated at (Ac) in FIG. 12, areas where a degree at which the attention of the driver is attracted is high are extracted on the near right of the image by the driving assistance apparatus of the second modification.

As described above, in the examples of (Aa) to (Ac) in FIG. 12, the areas where a degree at which the attention of the driver is attracted is high are scattered in time series.

FIG. 12 illustrates, at (Ba) to (Bc), a state in which the driving assistance apparatus of the second modification generates the driving assistance information based on the time-series data. That is, FIG. 12 illustrates, at (Ba) to (Bc), processes performed at the same timings as the images illustrated at (Aa) to (Ac) in FIG. 12, respectively.

As illustrated at (Ba) in FIG. 12, the driving assistance apparatus according to the second modification causes latent information 622 to be displayed in areas on the right opposite to the areas where a degree at which the attention of the driver is attracted is high, extracted on the left of the image, in accordance with a display timing of the image at (Aa) in FIG. 12.

As illustrated at (Bb) in FIG. 12, the driving assistance apparatus according to the second modification causes the latent information 622 to be displayed in areas on the left opposite to the areas where a degree at which the attention of the driver is attracted is high, extracted on the right of the image, in accordance with a display timing of the image at (Ab) in FIG. 12.

As illustrated at (Bc) in FIG. 12, the driving assistance apparatus according to the second modification causes the latent information 622 to be displayed in areas on the near left opposite to the areas where a degree at which the attention of the driver is attracted is high, extracted on the near right of the image, in accordance with a display timing of the image at (Ac) in FIG. 12.

In the case where the areas where a degree at which the attention of the driver is attracted is high are scattered in time series, the driving assistance apparatus according to the second modification appropriately presents information in areas opposite to these areas as described above.

Note that, in examples of (Ba) to (Bc) in FIG. 12, for example, the latent information 622 is displayed in a case where the attention state of the driver is biased in the areas on the image. However, information presentation other than the above may be performed in the case where the attention state of the driver is biased.

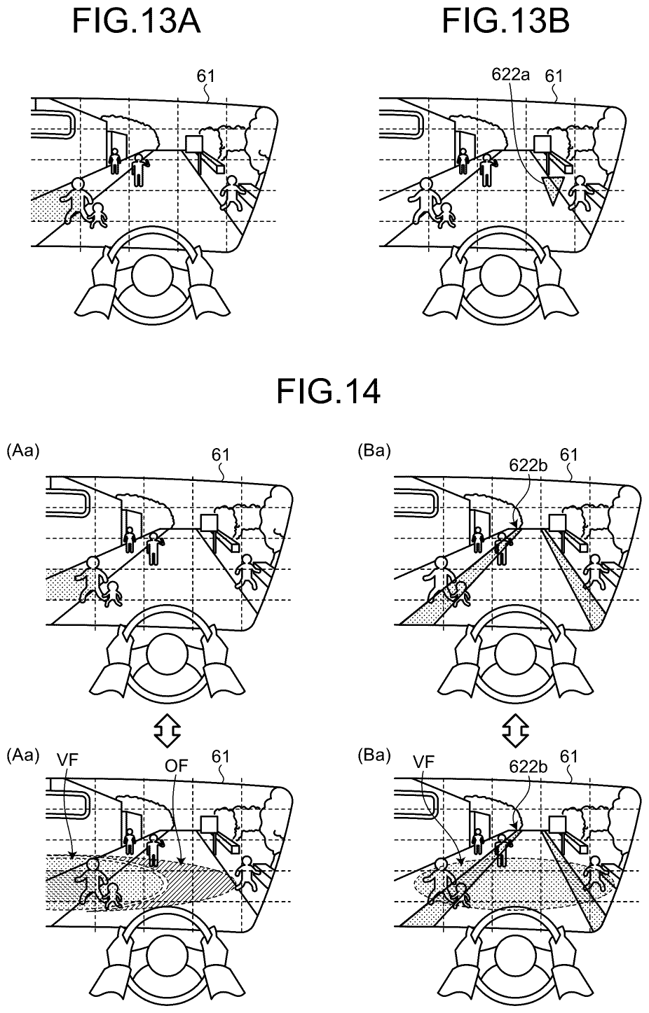

FIGS. 13 to 15 are schematic views illustrating another example of information presentation by the driving assistance apparatus according to the second modification of the first embodiment in the case where the attention state of the driver is biased.

In an example illustrated in FIG. 13A, an area where a degree at which the attention of the driver is attracted is high is extracted on the near right of an image by the driving assistance apparatus of the second modification.

As illustrated in FIG. 13B, the driving assistance apparatus according to the second modification may display, instead of the latent information 622, a triangular icon 622a in an area on the near left opposite to the area where a degree at which the attention of the driver is attracted is high, extracted on the near right of the image, the icon pointing to the area in accordance with a display timing of the image in FIG. 13A. However, presentation information pointing to the area may have another shape or mode such as an arrow.

In an example illustrated at (Aa) in FIG. 14, an area where a degree at which the attention of the driver is attracted is high is extracted on the near left of an image by the driving assistance apparatus of the second modification.

As illustrated at (Ab) in FIG. 14, when the area where a degree at which the attention of the driver is attracted is high is located on the near left of the image, it is estimated that an effective visual field VF of the driver is also biased to the near left of the vehicle as the driver gazes at the area. In this case, for example, the vicinity of the center of a road in front of the vehicle is considered to be outside OF of the effective visual field of the driver.

As illustrated at (Ba) in FIG. 14, the driving assistance apparatus of the second modification may display straight lines 622b extending from the front to the far side on the left and right of the center of a screen, instead of the latent information 622, in accordance with a display timing of the image at (Aa) in FIG. 14.

As illustrated at (Bb) in FIG. 14, the display of the lines 622b and the like at (Ba) in FIG. 14 causes the driver to direct the gaze to the lines 622b, so that the effective visual field VF of the driver also moves to the vicinity of the center of the road in front of the vehicle, and the attention of the driver can be returned to an appropriate state.

Note that information to be presented may have a shape or a mode other than the lines 622b as long as the effective visual field VF of the driver can be returned to the vicinity of the center of the road.

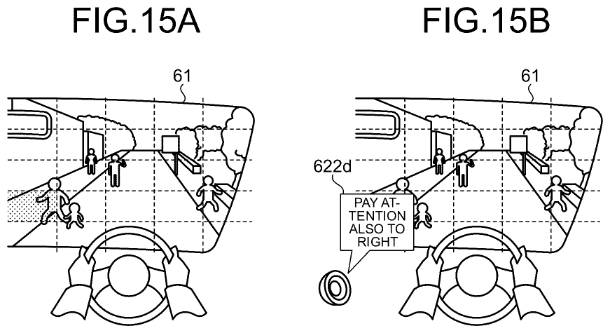

In an example illustrated in FIG. 15A, an area where a degree at which the attention of the driver is attracted is high is extracted on the near left of an image by the driving assistance apparatus of the second modification.

As illustrated in FIG. 15B, the driving assistance apparatus according to the second modification may cause the speaker 63 to output an announcement 622d for calling attention, for example, “Pay attention to the right”, instead of the latent information 622, in accordance with a display timing of the image in FIG. 15A. The presentation information output from the speaker 63 may be a warning sound or the like.

FIG. 16 is a schematic view illustrating an example of the driving assistance information generated by the driving assistance apparatus according to the second modification of the first embodiment in a case where areas where a degree at which the attention of the driver is attracted is high are localized in time series.

FIG. 16 illustrates, (a) to (d), time-series data referred to when the driving assistance apparatus of the second modification generates the driving assistance information. At (a) to (d) in FIG. 16, hatching is applied to areas where a degree at which the attention of the driver is attracted is estimated to be high. However, this does not mean that images illustrated at (a) to (d) in FIG. 16 are actually displayed on the HUD 61 or the like.

In an example illustrated at (a) in FIG. 16, areas where a degree at which the attention of the driver is attracted is high are extracted on the near left of the image by the driving assistance apparatus of the second modification. In an example illustrated at (b) in FIG. 16, areas where a degree at which the attention of the driver is attracted is high are extracted near the center on the near left of the image by the driving assistance apparatus according to the second modification. In an example illustrated at (c) in FIG. 16, areas where a degree at which the attention of the driver is attracted is high are extracted near the center in the left of the image by the driving assistance apparatus according to the second modification. In an example illustrated at (d) in FIG. 16, areas where a degree at which the attention of the driver is attracted is high are extracted on the left of the image by the driving assistance apparatus of the second modification.

As described above, in the examples of (a) to (d) in FIG. 16, the areas where a degree at which the attention of the driver is attracted is high are biased to the left of the image in time series.

FIG. 16 illustrates, at (e), a state in which the driving assistance apparatus of the second modification generates the driving assistance information based on the time-series data. That is, FIG. 16 illustrates, at (e), a process performed at a timing after acquisition of the images illustrated at (a) to 16 in FIG. 16.

As illustrated at (e) in FIG. 16, the driving assistance apparatus according to the second modification displays latent information 632 in areas on the right opposite to the areas where a degree at which the attention is attracted is high, extracted to be biased to the left of the image, based on the images of (a) to (d) in FIG. 16.

In the case where the areas where a degree at which the attention of the driver is attracted is high are localized in time series, as described above, the driving assistance apparatus according to the second modification can present information such as the latent information 632 in areas opposite to the areas where the degree at which the attention of the driver is attracted is localized in time series, instead of sequentially switching information presentation positions at the same timings as the images illustrated at (a) to (d) in FIG. 16.

FIG. 17 is a schematic view illustrating an example of the driving assistance information generated by the driving assistance apparatus according to the second modification of the first embodiment in a case where areas where a degree at which the attention of the driver is attracted is high are ubiquitous in time series.

FIG. 17 illustrates, at (a) to (d), time-series data referred to when the driving assistance apparatus of the second modification generates the driving assistance information. At (a) to (d) in FIG. 17, hatching is applied to areas where a degree at which the attention of the driver is attracted is estimated to be high. However, this does not mean that images illustrated at (a) to (d) in FIG. 17 are actually displayed on the HUD 61 or the like.

In an example illustrated at (a) in FIG. 17, an area where a degree at which the attention of the driver is attracted is high is extracted on the near right of the image by the driving assistance apparatus of the second modification. In an example illustrated at (b) in FIG. 17, an area where a degree at which the attention of the driver is attracted is high is extracted near the center on the left of the image by the driving assistance apparatus according to the second modification. In an example illustrated at (c) in FIG. 17, an area where a degree at which the attention of the driver is attracted is high is extracted on the near left of the image by the driving assistance apparatus of the second modification. In an example illustrated at (d) in FIG. 17, an area where a degree at which the attention of the driver is attracted is high is extracted on the far right of the image by the driving assistance apparatus of the second modification.

As described above, in the examples of (a) to (d) of FIG. 17, the areas where a degree at which the attention of the driver is attracted is high appear evenly in the entire image in time series.

FIG. 17 illustrates, at (e), a state in which the driving assistance apparatus of the second modification generates the driving assistance information based on the time-series data. That is, FIG. 17 illustrates, at (e), a process performed at a timing after acquisition of the images illustrated at (a) to (d) in FIG. 17.

As illustrated at (e) in FIG. 17, the driving assistance apparatus of the second modification determines that display of presentation information such as the latent information 622 by the HUD 61 is unnecessary based on the images of (a) to (d) in FIG. 17.

In the case where the areas where a degree at which the attention of the driver is attracted is high are ubiquitous in time series, as described above, the driving assistance apparatus according to the second modification can intentionally skip presentation of information such as the latent information 622 on the assumption that the driver pays attention evenly to the entire front of the vehicle.

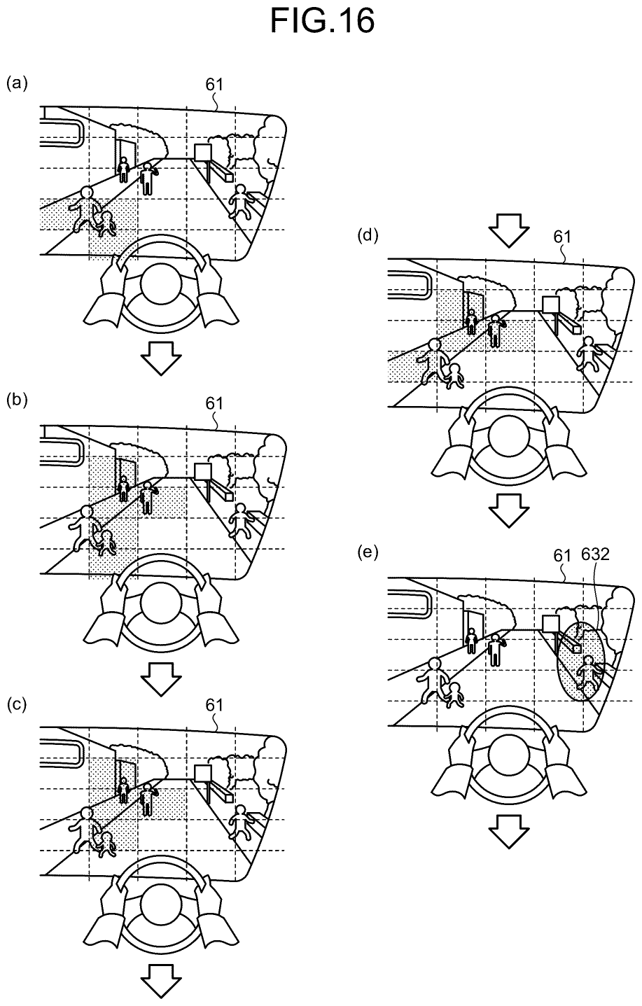

FIG. 18 is a schematic view illustrating an example of the driving assistance information generated by the driving assistance apparatus according to the second modification of the first embodiment in a case where the number of areas where a degree at which the attention of the driver is attracted is high increases or decreases in time series.

FIG. 18 illustrate, at (a) to (d), time-series data referred to when the driving assistance apparatus of the second modification generates the driving assistance information. At (a) to (d) in FIG. 18, hatching is applied to areas where a degree at which the attention of the driver is attracted is estimated to be high. However, this does not mean that the images illustrated at (a) to (d) in FIG. 18 are actually displayed on the HUD 61 or the like.

In an example illustrated at (a) in FIG. 18, one area where a degree at which the attention of the driver is attracted is high is extracted near the center on the left of the image by the driving assistance apparatus according to the second modification. In an example illustrated at (b) in FIG. 18, two areas where a degree at which the attention of the driver is attracted is high are extracted on the left closer to the center of the image by the driving assistance apparatus according to the second modification. In an example illustrated at (c) in FIG. 18, three areas where a degree at which the attention of the driver is attracted is high are extracted on the near left of the image by the driving assistance apparatus of the second modification. In an example illustrated at (d) in FIG. 18, five areas where a degree at which the attention of the driver is attracted is high are extracted near the center on the near left of the image by the driving assistance apparatus according to the second modification.

As described above, in the examples of (a) to (d) in FIG. 18, the number of areas where a degree at which the attention of the driver is attracted is high gradually increases in time series.

FIG. 18 illustrates, at (e), a state in which the driving assistance apparatus of the second modification generates the driving assistance information based on the time-series data. That is, FIG. 18 illustrates, at (e), a process performed at a timing after acquisition of the images illustrated at (a) to (d) in FIG. 18.

As illustrated at (e) in FIG. 18, the driving assistance apparatus according to the second modification does not cause the HUD 61 to display of the latent information 622 or the like in a specific area of an image, but causes the HUD 61 to display a message 642 indicating that a cognitive load of the driver is increasing, for example, “Drive slowly” based on the images of (a) to (d) in FIG. 18. Information indicating that the cognitive load of the driver is increasing may be presented by, for example, an announcement from the speaker 63.

In the case where the number of areas where a degree at which the attention of the driver is attracted is high increases in time series, as described above, the driving assistance apparatus of the second modification can detect that the cognitive load of the driver is increasing, and present the information for reducing the cognitive load of the driver, instead of the presentation information associated with the specific area of the image.

FIG. 19 is a schematic view illustrating an example of the driving assistance information generated by the driving assistance apparatus according to the second modification of the first embodiment in a case where an area where a degree at which the attention of the driver is attracted is high hardly occurs in time series.

FIG. 19 illustrate at (A) to (D), time-series data referred to when the driving assistance apparatus of the second modification generates the driving assistance information. At (A) to (D) in FIG. 19, hatching is applied to an area which easily attracts the attention of the driver and is estimated to have a high degree of inappropriateness of the attention state of the driver. However, this does not mean that images illustrated at (A) to (D) in FIG. 19 are actually displayed on the HUD 61 or the like.

In an example illustrated at (A) in FIG. 19, any area where the degree of inappropriateness of the attention state of the driver exceeds a predetermined threshold has not been extracted. Also in an example illustrated at (B) in FIG. 19, any area where the degree of inappropriateness of the attention state of the driver exceeds the predetermined threshold has not been extracted. In an example illustrated at (C) in FIG. 19, an area having a high degree of inappropriateness of the attention state of the driver has been extracted on the near right of the image by the driving assistance apparatus of the second modification. In an example illustrated at (D) in FIG. 19, a state in which any area where the degree of inappropriateness of the attention state of the driver exceeds the predetermined threshold has not been extracted is repeated.

As described above, in the examples of (A) to (D) in FIG. 19, the area which easily attracts the attention of the driver and has a high degree of inappropriateness of the attention state of the driver hardly appears even in time series.

FIG. 19 illustrates, at (Ea), a state in which the driving assistance apparatus of the second modification generates the driving assistance information based on the time-series data. That is, FIG. 19 illustrates, at (Ea), a process performed at a timing after acquisition of the images illustrated at (A) to (D) in FIG. 19.

As illustrated at (Ea) in FIG. 19, based on the images of (A) to (D) in FIG. 19, the driving assistance apparatus according to the second modification does not cause the HUD 61 to display the latent information 622 or the like in a specific area of an image, but causes the HUD 61 to display a message 642a indicating that the attention of the driver to the entire front of the vehicle is little, for example, “Pay attention to the front”. Information indicating that the attention to the entire front of the vehicle is little may be presented by, for example, an announcement from the speaker 63.

FIG. 19 illustrates, at (Eb), another example illustrating a state in which the driving assistance apparatus of the second modification generates the driving assistance information based on the time-series data. FIG. 19 also illustrates, at (Eb), an exemplary process performed at a timing after acquisition of the images illustrated at (A) to (D) in FIG. 19.

As illustrated at (Ea) in FIG. 19, the driving assistance apparatus of the second modification may display, for example, straight lines 642b extending from the near side to the far side on the left and right of the center of the screen, instead of displaying the message 642a such as “Pay attention to the front”, based on the images of (A) to (D) in FIG. 19. As a result, it is possible to call the attention of the driver to the front of the vehicle similarly to the example illustrated at (Ba) and (Bb) in FIG. 14 described above.

In the case where the area where a degree at which the attention of the driver is attracted is high hardly occurs even in time series, as described above, the driving assistance apparatus of the second modification can present information for suppressing careless driving of the driver assuming that the attention of the driver to the entire front of the vehicle is little.

Note that presentation information for suppressing the careless driving of the driver is not limited to the example of FIG. 19, and may be presented in a mode different from the above.

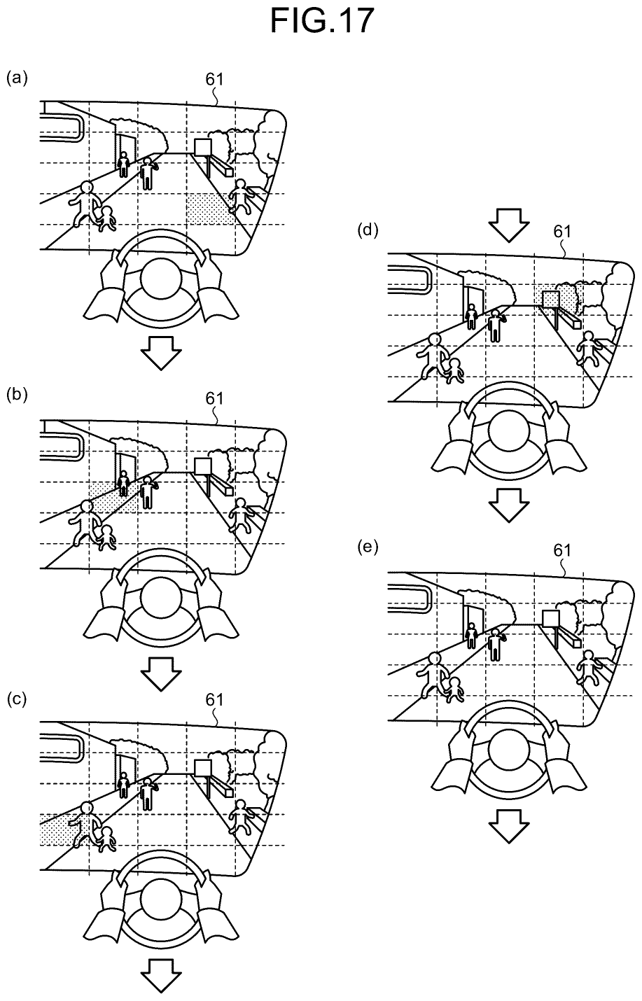

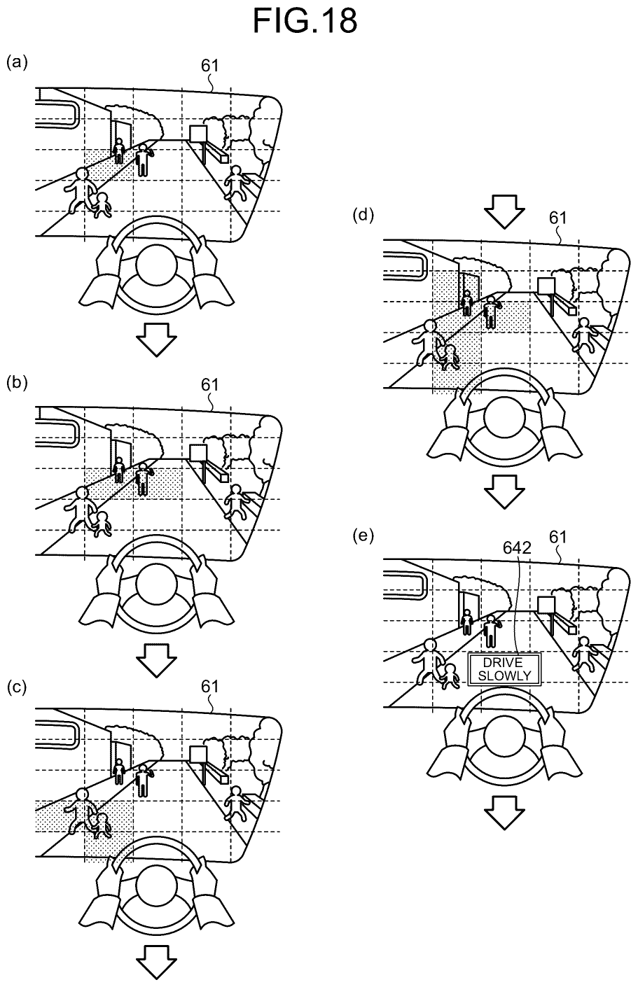

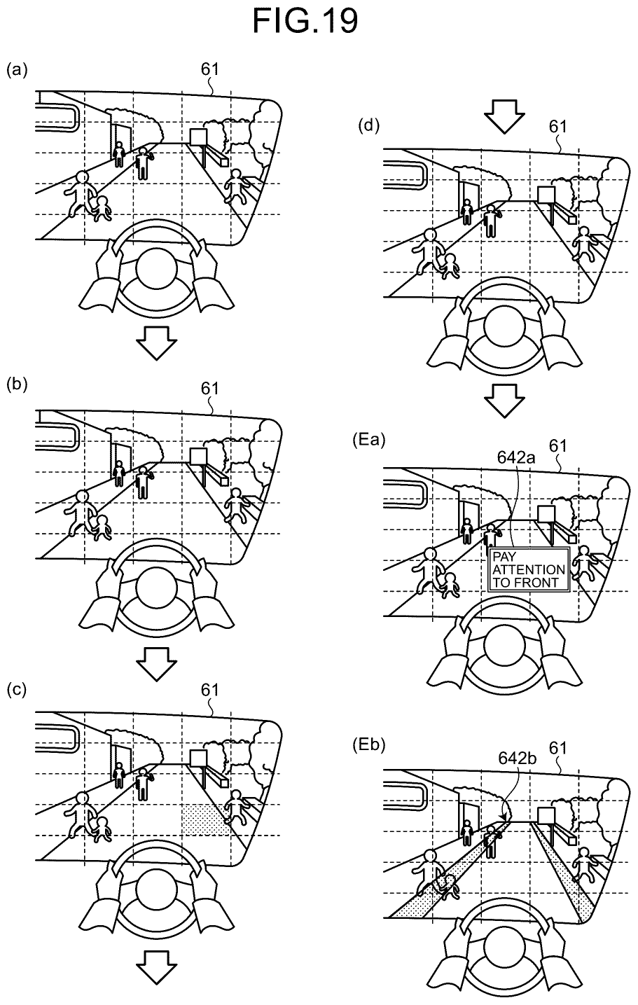

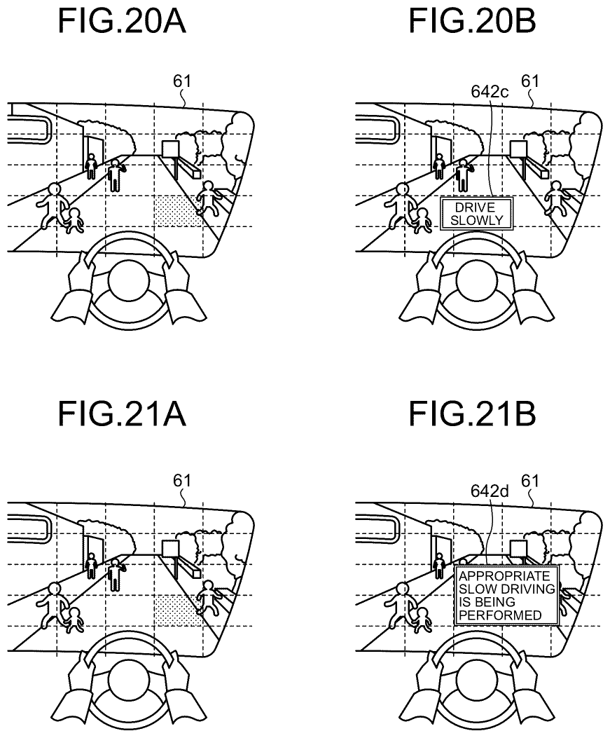

FIGS. 20A and 20B are schematic views illustrating another example of presentation in a case where the driving assistance apparatus according to the second modification of the first embodiment suppresses the careless driving of the driver.

FIG. 20A illustrates only the state of (C) in FIG. 19 among the time-series data illustrated at (A) to (D) in FIG. 19 described above.

As illustrated in FIG. 20B, the driving assistance apparatus according to the second modification detects that the driver is likely to fall into careless driving based on the time-series data including FIG. 20A, and causes the HUD 61 to display a message 642c recommending “defensive driving” to the driver, such as “Drive slowly”.

“Defensive driving” is driving performed with a high sense of safety while predicting that a dangerous situation will occur. Examples of “defensive driving” include predicting that “a pedestrian may jump out” at the time of approaching a crosswalk or the like and preparing for a danger, and predicting that “an oncoming vehicle may increase speed” at the time of turning right at an intersection and preparing for a danger.

As described above, information for recommending the driver to “defensive driving” may be presented by, for example, an announcement from the speaker 63 or the like.

FIGS. 21A and 21B are schematic views illustrating still another example of presentation in the case where the driving assistance apparatus according to the second modification of the first embodiment suppresses the careless driving of the driver.

FIG. 21A also illustrates only the state of (C) in FIG. 19 among the time-series data illustrated, at (A) to (D), in FIG. 19 described above.

As illustrated in FIG. 21B, the driving assistance apparatus according to the second modification detects that the driver is likely to fall into careless driving based on the time-series data including FIG. 20A, and then, for example, if the driver is driving slowly, displays a message 642d complimenting “defensive driving” such as “Appropriately slow driving is being performed” on the HUD 61.

Such “defensive driving” of the driver can be detected, for example, as the driving assistance apparatus of the second modification acquires a detection result of the detection apparatus 40 (see FIG. 1) such as the vehicle speed sensor 43, the accelerator sensor 44, the brake sensor 45, and the steering angle sensor 46 directly or via the above-described ECU 20 (see FIG. 1).

The driving assistance apparatus of the second modification can detect that the driver decelerates the vehicle and is performing slow driving from the detection results of the vehicle speed sensor 43, the accelerator sensor 44, and the brake sensor 45, for example. Furthermore, the driving assistance apparatus of the second modification can detect that the driver has been appropriately steering the vehicle from a detection result of the steering angle sensor 46 or the like, for example.

As described above, information complimenting “defensive driving” of the driver may be presented by, for example, an announcement from the speaker 63 or the like.

The presentation of the information complimenting “defensive driving” of the driver enables the driver to recognize that a current traveling manipulation of the vehicle is proper and to be continuously motivated to perform the traveling manipulation with a high sense of safety.

Note that FIGS. 12 to 21 described above illustrate the examples in which the driving assistance apparatus of the second modification causes the HUD 61 to exclusively present information. However, the driving assistance apparatus of the second modification may cause the in-vehicle monitor 62 to present the above-described various types of information illustrated in FIGS. 12 to 21.

According to the driving assistance apparatus of the second modification, it is possible to prompt at least any of a more appropriate attention state for driving at that time, and a behavior change and a consciousness change in relation to a driving manipulation based on the attention state of the driver, such as returning the effective visual field VF of the driver to an appropriate position as in the examples of FIGS. 14 and 15 described above, reducing the cognitive load of the driver as in the example of FIG. 18, suppressing the careless driving of the driver as in the example of FIG. 19, or encouraging “defensive driving” as in the example of FIGS. 20A and 20B or 21A and 21B.

That is, it is possible to unconsciously change visual behavior to correct the bias when there is the bias in the attention state estimated by the attention state estimation unit, to disperse the concentration when there is the excessive concentration on a part, and to cause concentration when there is excessive dispersion throughout, and is possible to change or fix driving behavior such as slow driving in order to create a time for which necessary attention can be distributed.

According to the driving assistance apparatus of the second modification, effects similar to those of the driving assistance apparatus 10 of the first embodiment described above are obtained in addition to the above.

### Third Modification

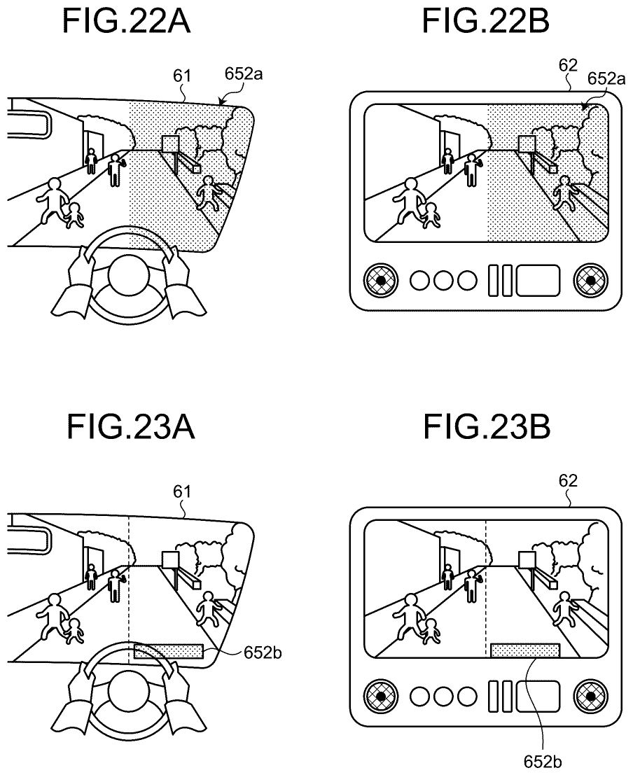

Next, a driving assistance apparatus according to a third modification of the first embodiment will be described with reference to FIGS. 22 and 23. The driving assistance apparatus of the third modification is different from that of the above-described first embodiment in that an image is divided by a different number of divisions.

FIGS. 22A and 22B are schematic views illustrating an example in which the driving assistance apparatus according to the third modification of the first embodiment bisects the image to generate driving assistance information.

As illustrated in FIGS. 22A and 22B, the driving assistance apparatus according to the third modification divides the image obtained by capturing the traveling direction of the vehicle into left and right halves, and calculates whether or not the degree of inappropriateness of the attention state of the driver exceeds a predetermined threshold for each of left and right areas. When a difference in the degree of inappropriateness of the attention state exceeds the predetermined threshold in any area, the driving assistance apparatus of the third modification displays latent information 652a in the entire area opposite to the area.

In examples illustrated in FIGS. 22A and 22B, the degree of inappropriateness of the attention state of the driver exceeds the predetermined threshold in the left area out of the left and right divided areas, and the driving assistance apparatus of the third modification displays the latent information 652a in the entire right area opposite to the left area. At this time, the driving assistance apparatus of the third modification may adjust the magnitude of the intensity of calling the attention of the driver by changing, for example, a brightness, a color, or the like of the latent information 652a according to a magnitude of the degree of inappropriateness of the attention state of the driver.

FIGS. 23A and 23B are schematic views illustrating another example in which the driving assistance apparatus according to the third modification of the first embodiment bisects the image to generate the driving assistance information.

Also in examples illustrated in FIGS. 23A and 23B, the driving assistance apparatus according to the third modification divides the image obtained by capturing the traveling direction of the vehicle into left and right halves, and calculates whether or not the degree of inappropriateness of the attention state of the driver exceeds a predetermined threshold for each of left and right areas. When the degree of inappropriateness of the attention state exceeds the predetermined threshold in any area, the driving assistance apparatus of the third modification displays latent information 652b in a part of an area, instead of the entire area, opposite to the area.

In the examples illustrated in FIGS. 23A and 23B, the degree of inappropriateness of the attention state of the driver exceeds the predetermined threshold in the left area out of the left and right divided areas, and the driving assistance apparatus of the third modification displays the latent information 652b in a presentation area, which is a rectangular area in the lower part of the windshield along the dashboard, for example, at a lower end of the right area opposite to the left area. At this time, the driving assistance apparatus of the third modification may adjust the magnitude of the intensity of calling the attention of the driver by changing, for example, a length, a thickness, a brightness, a color, or the like of the latent information 652b according to the magnitude of the degree of inappropriateness of the attention state of the driver.

Note that the driving assistance apparatus of the third modification may display the latent information 652a and 652b in an area opposite to an area where the degree of inappropriateness of the attention state of the driver is higher when the degree of inappropriateness of the attention state of the driver exceeds the predetermined threshold in both the left and right areas.

As described above, information to be presented to the driver can be simplified, for example, by reducing the number of divisions of the image, and it is possible to more appropriately present the information to the driver by suppressing distraction of the driver.

According to the driving assistance apparatus of the third modification, other effects similar to those of the driving assistance apparatus 10 of the first embodiment described above are obtained.

Note that the example of bisecting the image has been described in the third modification described above. Furthermore, the example of dividing the image into the total of 25 areas of 5×5 in height×width has been described in the above-described the first embodiment and the like. However, examples of image division are not limited thereto, and the image can be divided into various numbers and arrangements. For example, the image may be divided for each pixel. In this case, the image is divided into 160×120, 1920×1080, or the like in height×width.

### Fourth Modification

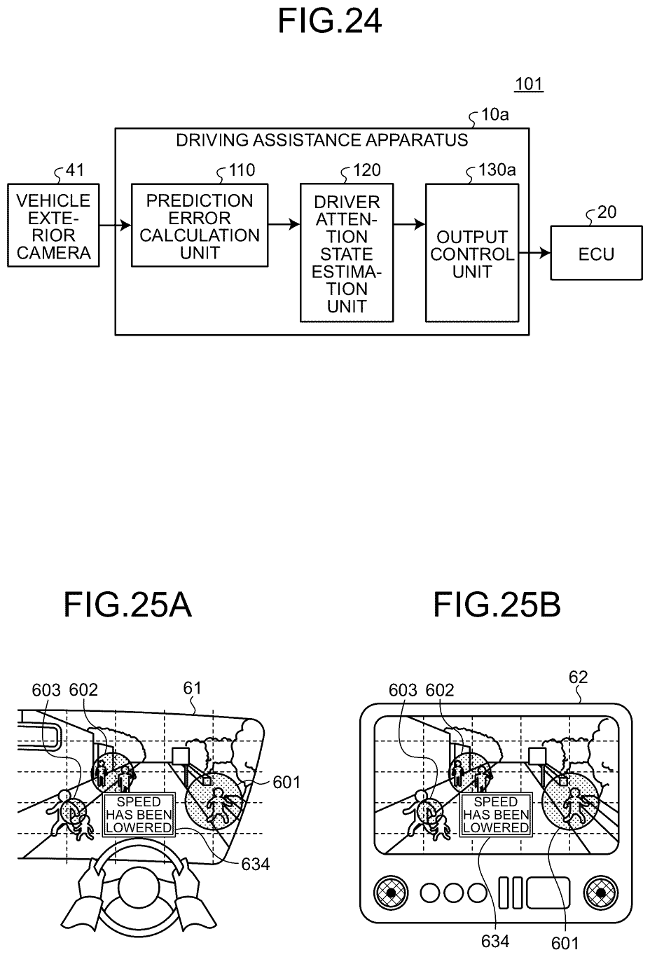

Next, a driving assistance apparatus 10a according to a fourth modification of the first embodiment will be described with reference to FIGS. 24 and 25. The driving assistance apparatus 10a of the fourth modification is different from that of the above-described first embodiment in that the driving assistance information is output to the ECU 20.

FIG. 24 is a block diagram illustrating an example of a functional configuration of the driving assistance apparatus 10a according to the fourth modification of the first embodiment together with peripheral devices.

As illustrated in FIG. 24, instead of the driving assistance apparatus 10 of the first embodiment described above, the driving assistance apparatus 10a of the fourth modification is mounted in a vehicle 101 of the fourth modification. The driving assistance apparatus 10a includes an output control unit 130a that outputs driving assistance information to the ECU 20, instead of the output control unit 130 of the first embodiment described above.

The output control unit 130a generates the driving assistance information associated with an area to which the attention of the driver is to be called. The driving assistance information includes, for example, operation information giving an instruction on an operation of the vehicle 101, a degree of the operation determined based on the magnitude of the degree of inappropriateness of the attention state of the driver, and the like in association with the area to which the attention is to be called.

The instruction of the operation of the vehicle 101 included in the driving assistance information includes, for example, at least any of an instruction of an operation of braking the vehicle 101 and an instruction of an operation of reducing acceleration of the vehicle 101. The degree of the operation included in the driving assistance information can be, for example, a magnitude of a deceleration effect of the vehicle 101.

That is, the output control unit 130a can output the driving assistance information including the operation information having a higher deceleration effect of the vehicle 101 as the area to which the attention of the driver is to be called is based on a higher degree of inappropriateness of the attention state of the driver.

The ECU 20, which is the on-vehicle electronic unit, causes at least any (see FIG. 1) of the brake actuator 51 and the engine controller 52 included in the above-described vehicle control apparatus 50 to perform an operation of decelerating the vehicle 101 based on the driving assistance information output from the driving assistance apparatus 10a to the ECU 20.

That is, the ECU 20 brakes the vehicle 101 by, for example, the brake actuator 51 which is a braking device. Furthermore, the ECU 20 reduces the acceleration of the vehicle 101 by the engine controller 52, which is an engine control apparatus, instead of or in addition to the operation of braking the vehicle 101 by the brake actuator 51.

As a result, in a case where the area to which the attention of the driver is to be called is extracted by the driving assistance apparatus 10a, it is possible to cause the vehicle 101 to perform an operation of avoiding a danger that may exist in the area. That is, for example, in a case where the driver is not paying attention to the area and there is a pedestrian or the like having a concern of contact with the vehicle 101 in the area, it is possible to avoid the contact with the pedestrian by decelerating the vehicle 101.

Furthermore, the output control unit 130a is associated with the area to which the attention of the driver is to be called, and also generates the driving assistance information to be output to the HMI control apparatus 30 (see FIG. 1). The driving assistance information to be output to the HMI control apparatus 30 includes, for example, presentation information for notifying the driver of an operation that has been performed by the vehicle 101 in association with the area to which the attention is to be called.

Based on the driving assistance information output from the driving assistance apparatus 10a, the HMI control apparatus 30 causes the information presentation apparatus 60 (see FIG. 1) to present the presentation information for notifying the driver that the vehicle 101 has been caused to perform the avoidance operation as described above.

FIGS. 25A and 25B are schematic views illustrating an example of information presentation by the driving assistance apparatus 10a according to the fourth modification of the first embodiment.

As illustrated in FIGS. 25A and 25B, in order to cause the vehicle 101 to perform the avoidance operation as described above, the driving assistance apparatus 10a of the fourth modification outputs the above-described driving assistance information to the HMI control apparatus 30, and causes the HUD 61 or the in-vehicle monitor 62 to display a message 634 indicating that deceleration control of the vehicle 101 has been performed, for example, “Slow driving has been performed”. Information indicating that the deceleration control of the vehicle 101 has been performed may be presented by, for example, an announcement from the speaker 63.

As a result, when the driving assistance apparatus 10a has caused the vehicle 101 to perform the avoidance operation, it is possible to prevent the driver from misunderstanding that a failure occurs in the vehicle or the like due to unintended deceleration control of the vehicle.

Note that a case where the deceleration control of the vehicle 101 is performed has been described in the examples of FIGS. 24 and 25, but other operation control, such as adjustment of a traveling lane by a steering angle control of the steering wheel and a blinker manipulation, may be performed on the vehicle 101.

According to the driving assistance apparatus 10a of the fourth modification, the operation information that is associated with the area to which the attention of the driver is to be called and gives an instruction on the operation of the vehicle 101 is output to the ECU 20 that controls the vehicle 101. The ECU 20 causes the brake actuator 51, the engine controller 52, and the like, which decelerate the vehicle, to perform the operation based on the operation information output from the driving assistance apparatus 10a. As a result, it is possible to more reliably avoid a danger that is likely to be overlooked by the driver.

According to the driving assistance apparatus 10a of the fourth modification, the operation information with a higher deceleration effect of the vehicle 101 is output as the area to which the attention of the driver is to be called is based on a larger prediction error. This further enhances the accuracy of danger avoidance.

According to the driving assistance apparatus 10a of the fourth modification, other effects similar to those of the driving assistance apparatus 10 of the first embodiment described above are obtained.

### Fifth Modification

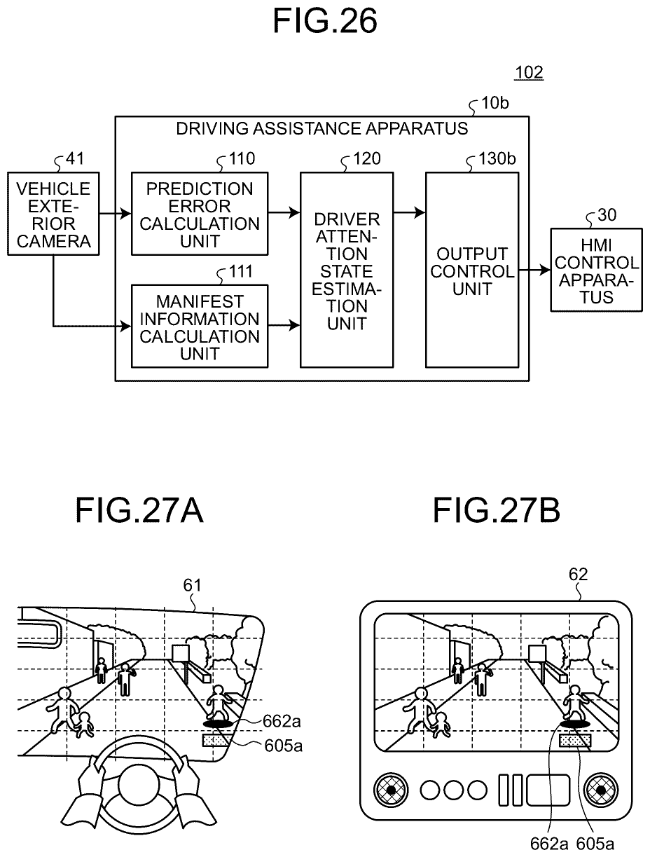

Next, a driving assistance apparatus according to a fifth modification of the first embodiment will be described with reference to FIGS. 26 to 45. The driving assistance apparatus of the fifth modification is different from that of the above-described first embodiment in that manifest information is presented in addition to the latent information.

FIG. 26 is a block diagram illustrating an example of a functional configuration of a driving assistance apparatus 10b according to the fifth modification of the first embodiment together with peripheral devices.

As illustrated in FIG. 26, instead of the driving assistance apparatus 10 according to the first embodiment described above, the driving assistance apparatus 10b according to the fifth modification is mounted in a vehicle 102 according to the fifth modification.

The driving assistance apparatus 10b includes a manifest information calculation unit 111 that generates the manifest information in addition to the configuration of the driving assistance apparatus 10 of the first embodiment described above, and further includes an output control unit 130b that acquires the attention state of the driver estimated by the driver attention state estimation unit 120 and the manifest information generated by the manifest information calculation unit 111 and outputs driving assistance information, instead of the output control unit 130 of the first embodiment described above.

As described above, dangers during traveling of the vehicle include the danger manifested at that time and the latent danger not manifested at that time. With respect to the above-described various types of latent information for notifying the driver of the latent danger, the manifest information calculation unit 111 generates the manifest information for notifying the driver of the danger manifested at that time.

More specifically, the manifest information calculation unit 111 extracts, from an image in a traveling direction of a vehicle 102 captured by the vehicle exterior camera 41, the danger manifested at that time, such as a pedestrian who has suddenly jumped out to a roadway, and generates the manifest information including such danger information.

The manifest information includes, for example, presentation information for notifying the driver of the manifest danger, a presentation mode, information on a magnitude of an intensity of attention calling of the presentation information, and the like in association with the area to which the attention is to be called.

The driver attention state estimation unit 120 passes the estimated driver's attention state and the manifest information generated by the manifest information calculation unit 111 to the output control unit 130b.

The output control unit 130b outputs, to the HMI control apparatus 30, the driving assistance information including information regarding the area to which the attention of the driver is to be called, extracted based on the attention state of the driver, the manifest information passed from the driver attention state estimation unit 120, and the latent information.

FIGS. 27A and 27B are schematic views illustrating an example of information presentation by the driving assistance apparatus 10b according to the fifth modification of the first embodiment.

As illustrated in FIGS. 27A and 27B, the driving assistance apparatus 10b of the fifth modification causes the HUD 61 or the in-vehicle monitor 62 to display manifest information 662a and latent information 605a. In the example of FIGS. 27A and 27B, for example, an area including a person on the near right is assumed as the area to which the attention of the driver is to be called.

The driving assistance apparatus 10b of the fifth modification displays the manifest information 662a, which is elliptical and indicates the person on the near right, at the feet of the person. Furthermore, the driving assistance apparatus 10b of the fifth modification displays the latent information 605a, which is rectangular and indicates the person on the near right, at a lower position away from the feet of the person.

However, the shapes, presentation positions, presentation modes, and the like of the manifest information 662a and the latent information 605a are not limited to the example of FIGS. 27A and 27B described above.

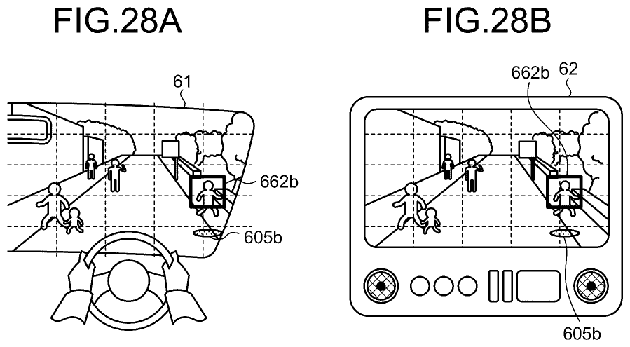

FIGS. 28A and 28B are schematic views illustrating another example of information presentation by the driving assistance apparatus 10b according to the fifth modification of the first embodiment.

In examples illustrated in FIGS. 28A and 28B, the driving assistance apparatus 10b of the fifth modification displays manifest information 662b, which is rectangular and indicates the person on the near right, so as to surround the person. Furthermore, the driving assistance apparatus 10b of the fifth modification displays the latent information 605b, which is elliptical and indicates the person on the near right, at a lower position away from the feet of the person.

Note that the driving assistance apparatus 10b of the fifth modification may change, for example, a size, a brightness, a color, or the like of each piece of the manifest information 662a and 662b to adjust the magnitude of the intensity of calling the attention of the driver. Furthermore, the driving assistance apparatus 10b of the fifth modification may adjust the magnitude of the intensity of calling the attention of the driver by changing a size, a brightness, a color, or the like of each piece of the latent information 605a and 605b according to the magnitude of the degree of inappropriateness of the attention state of the driver.

As described above, the shapes, presentation positions, presentation modes, and the like of the manifest information 662 and the latent information 605 can be presented in various different modes.

With the above configuration, the attention state of the driver can be enhanced by presenting not only the latent danger but also the danger that has been already manifested to the driver. Therefore, it is possible to even more appropriately present the information to the driver.

Note that, when both the manifest information and the latent information are presented to the driver as in the above-described configuration, the manifest information and the latent information may be presented to different information presentation apparatuses 60, respectively. At this time, it is preferable to present the manifest information indicating a higher risk to the HUD 61, the in-vehicle monitor 62, or the like which has high visibility and are easily noticed by the driver among various configurations included in the information presentation apparatus 60.

On the other hand, the latent information indicating a relatively low risk can be presented to a configuration in which information presentation is possible without distracting the driver's attention to the front or a target to be noted among the various configurations included in the information presentation apparatus 60.

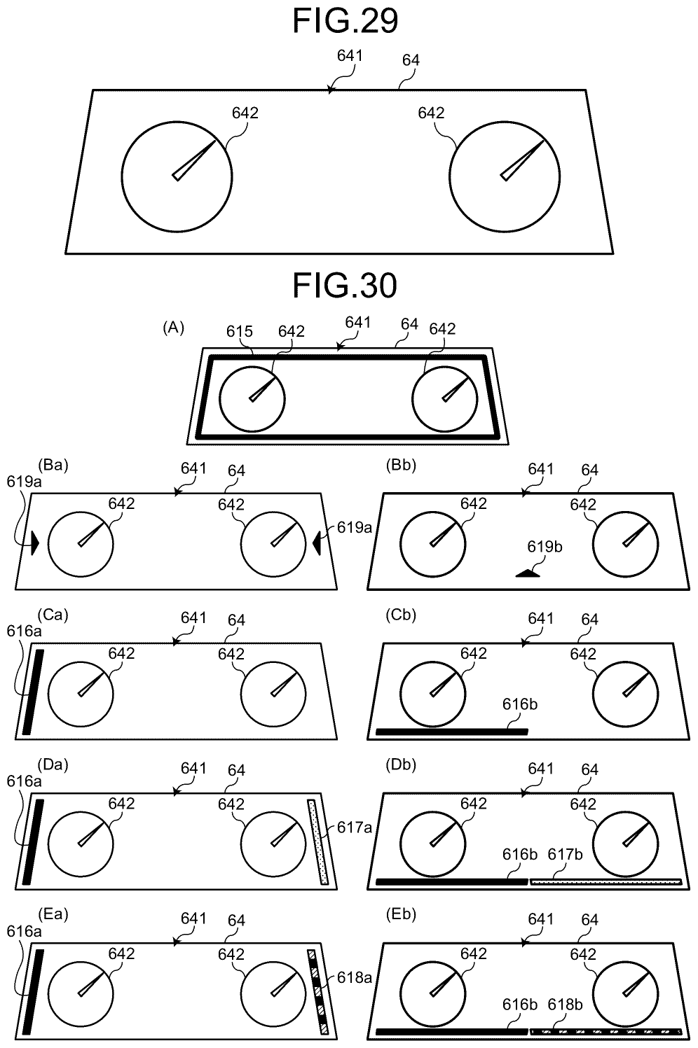

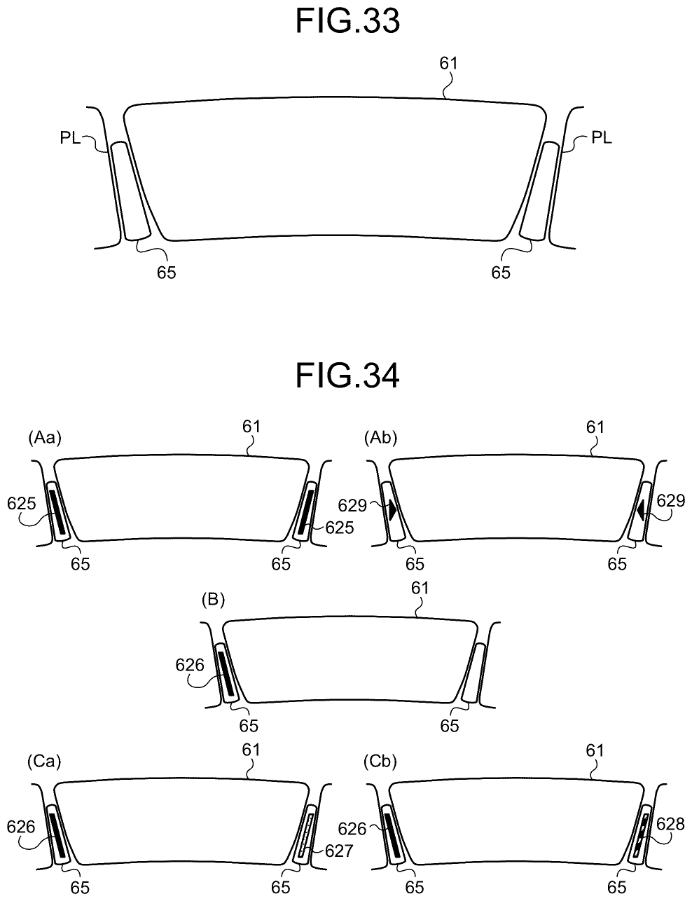

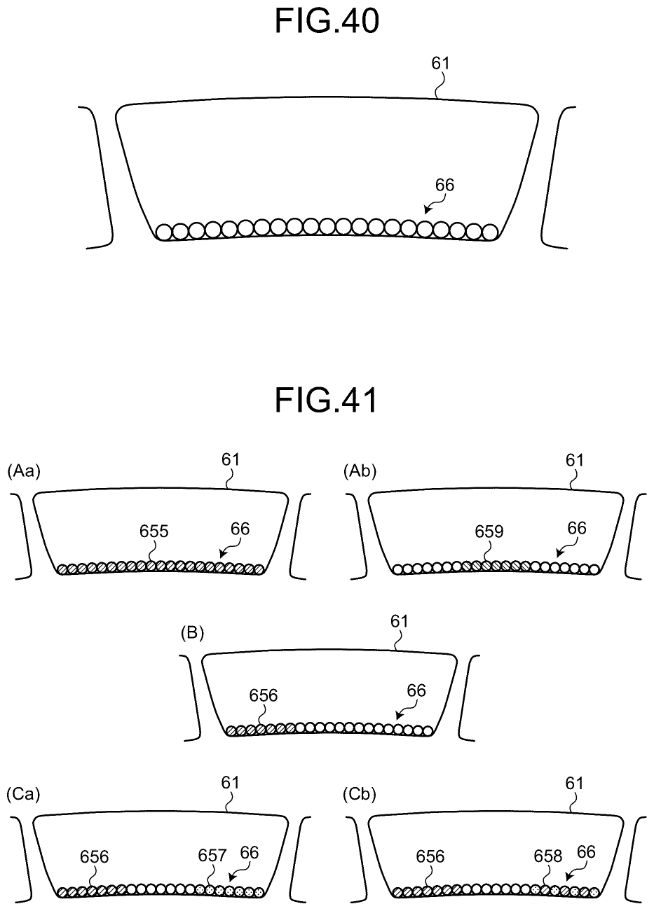

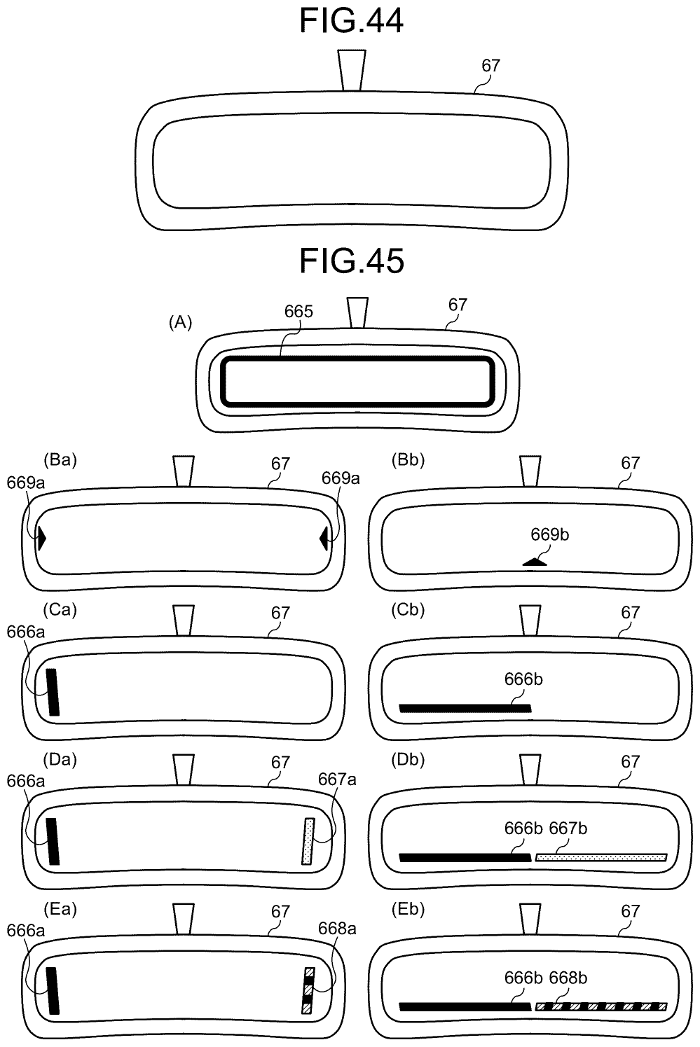

As an example of such a configuration, examples in which the latent information is presented to a meter display 64 (see FIG. 29), a pillar display 65 (see FIG. 33), the speaker 63, an outer peripheral area of the HUD 61, an LED display 66 (see FIG. 40), a mirror display 67 (see FIG. 44), and the like will be described below.

FIG. 29 is a schematic view illustrating an example of a configuration of the meter display 64 on which the driving assistance apparatus 10b according to the fifth modification of the first embodiment presents the latent information.

As illustrated in FIG. 29, the meter display 64 includes various meters 642 such as a speedometer, an engine tachometer, a fuel gauge, a water temperature gauge, and an odometer, and a center information display (CID) 641 provided between these meters 642 and around these meters 624, and is provided on an instrument panel or the like. The meter 642 may be a meter having a physical configuration, or the meter 624 itself may be a video displayed on a display.

FIG. 30 is a schematic view illustrating an example of presentation of latent information on the meter display 64 by the driving assistance apparatus 10b according to the fifth modification of the first embodiment.

As illustrated at (A) in FIG. 30, for example, in a case where there is an area where the degree of inappropriateness of the attention state of the driver is high over the entire front of the vehicle, the driving assistance apparatus 10b of the fifth modification displays latent information 615 surrounding an outer peripheral portion of the meter display 64 on the entire periphery of the meter display 64. However, the latent information for prompting strong attention calling with respect to the entire front of the vehicle may have a shape or a mode different from that of the latent information 615.

As illustrated at (Ba) in FIG. 30, for example, in a case where there is an area where the degree of inappropriateness of the attention state of the driver is relatively low over the entire front of the vehicle, the driving assistance apparatus 10b of the fifth modification displays a pair of pieces of latent information 619a at both left and right ends of the meter display 64.

The latent information 619a can have, for example, a shape obtained by combining a pair of triangles pointing to the vicinity of the center of the meter display 64 likened to the front of the vehicle. However, the latent information for prompting weak attention calling to the entire front of the vehicle may have other shapes or modes such as an arrow.

As illustrated at (Bb) in FIG. 30, as another mode of the latent information 619a, for example, in a case where there is an area where the degree of inappropriateness of the attention state of the driver is relatively low over the entire front of the vehicle, the driving assistance apparatus 10b of the fifth modification can display latent information 619b, which is triangular and points to the center of the meter display 64, at a lower end of the center of the meter display 64.

As illustrated at (Ca) in FIG. 30, for example, in a case where there is an area where the degree of inappropriateness of the attention state of the driver is high, the area being biased to the right of the vehicle, the driving assistance apparatus 10b of the fifth modification displays latent information 616a, which indicates an area on the left opposite to the area, at the left end of the meter display 64.

The latent information 616a can be, for example, presentation information presented in a rectangular area arranged along the left end of the meter display 64 that is likened to the area on the left of the vehicle. However, the latent information for prompting strong attention calling with respect to the driver having a large bias in the attention state may have another shape or mode different from that of the latent information 616a.

As illustrated at (Cb) in FIG. 30, as another mode of the latent information 616a, for example, in a case where an area where the degree of inappropriateness of the attention state of the driver is high is located to be biased to the right of the vehicle, the driving assistance apparatus 10b of the fifth modification can display latent information 616b, which indicates an area on the left opposite to the area, at a left lower end of the meter display 64.

The latent information 616b can be, for example, presentation information presented in a rectangular area arranged along the left lower end of the meter display 64 that is likened to the area on the left of the vehicle.

As illustrated at (Da) in FIG. 30, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification displays latent information 617a, which indicates an area on the right opposite to the area on the left of the vehicle, at the right end of the meter display 64 in addition to the latent information 616a indicating an area on the left opposite to the area on the right of the vehicle.

The latent information 617a can be, for example, presentation information presented in a rectangular area arranged along the left end of the meter display 64 that is likened to the area on the right of the vehicle.

Furthermore, the latent information 617a is presented in a mode in which a brightness, a color, or the like thereof is different from that of the latent information 616a, so that the intensity of attention calling can be suppressed to be lower than that of the latent information 616a.

Note that the latent information for prompting weak attention calling with respect to the driver having a small bias in the attention state may have another shape or mode different from that of the latent information 617a.

As illustrated at (Db) in FIG. 30, as another mode of the latent information 617a, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification can display, in addition to the latent information 616b, latent information 617b, which indicates an area on the right opposite to the area on the left, at the left lower end of the meter display 64.

The latent information 617b can be, for example, presentation information presented in a rectangular area arranged along a right lower end of the meter display 64 that is likened to the area on the left of the vehicle. Furthermore, the latent information 617b has a mode in which the intensity of calling attention is lower than that of the latent information 616b.

As illustrated at (Ea) in FIG. 30, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification displays latent information 618a, which indicates an area on the right opposite to the area on the left of the vehicle, at the right end of the meter display 64 in addition to latent information 616a indicating an area on the left opposite to the area on the right of the vehicle.

The latent information 618a can be, for example, presentation information presented in the rectangular area arranged along the left end of the meter display 64 that is likened to the area on the right of the vehicle. Furthermore, the latent information 618a is presented in a mode in which a brightness, a color, or the like thereof is different from those of the latent information 616a and 617a, so that the intensity of attention calling can be suppressed to be lower than that of the latent information 616a while being set to be higher than that of the latent information 617a.

Note that the latent information for prompting moderate attention calling with respect to the driver having a moderate bias in the attention state may have another shape or mode different from that of the latent information 618a.

As illustrated at (Eb) in FIG. 30, as another mode of the latent information 618a, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification can display, in addition to the latent information 616b, latent information 618b, which indicates an area on the right opposite to the area on the left, at the left lower end of the meter display 64.

The latent information 618b can be, for example, presentation information presented in a rectangular area arranged along a right lower end of the meter display 64 that is likened to the area on the left of the vehicle. Furthermore, the latent information 617b has a mode in which the intensity of attention calling is higher than that of the latent information 617b and the intensity of attention calling is lower than that of the latent information 616b.

With the above configuration, various types of the latent information 615, 616a to 619a, 616b to 619b, and the like based on the magnitude of the degree of inappropriateness of the attention state of the driver, the position in the image of the area where the degree of inappropriateness of the attention state is equal to or greater than the predetermined threshold, and the like can be displayed on the meter display 64.

Next, an example in which the driving assistance apparatus 10b according to the fifth modification presents information on the HUD 61 and the meter display 64 in combination will be described.

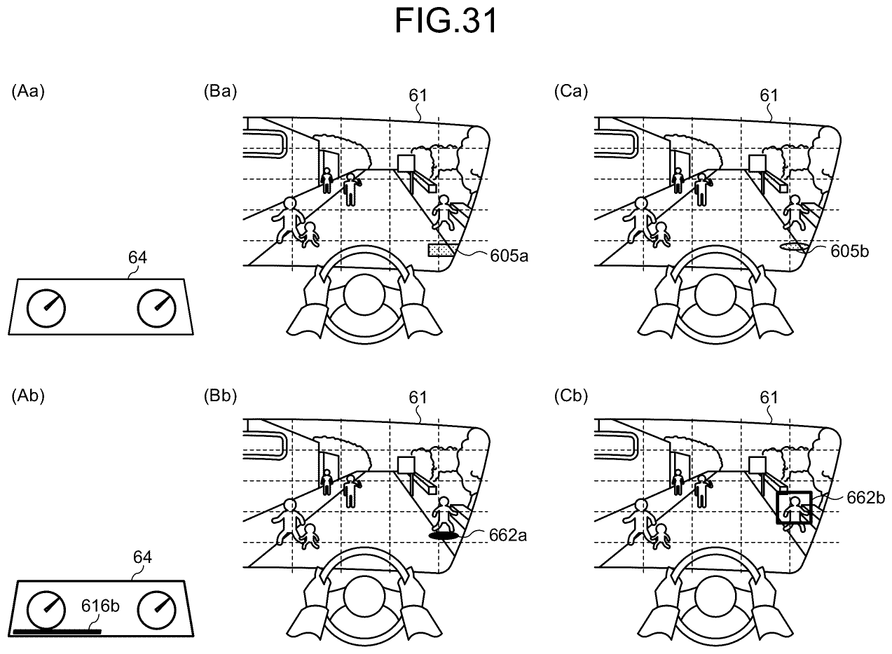

FIG. 31 is a schematic view illustrating an example in which presentation information generated by the driving assistance apparatus 10b according to the fifth modification of the first embodiment is divided and displayed on the HUD 61 and the meter display 64.

In examples illustrated at (Aa), (Ba), and (Ca) in FIG. 31, the driving assistance apparatus 10b of the fifth modification is in a state of detecting the latent danger such as a bias in the attention state of the driver, but not detecting the manifest danger such as a pedestrian who is likely to collide with the host vehicle.

In this case, the driving assistance apparatus 10b of the fifth modification causes the HUD 61 to display the above-described rectangular latent information 605a, the above-described elliptical latent information 605b, or the like so as to point to, for example, the person on the near right. On the other hand, the driving assistance apparatus 10b according to fifth modification does not cause the meter display 64 to display information.

When only the latent danger is detected, the driving assistance apparatus 10b of the fifth modification can display the latent information 605a, 605b, or the like preferentially on the HUD 61 having high visibility as described above.

In examples illustrated at (Ab), (Bb), and (Cb) in FIG. 31, the driving assistance apparatus 10b of the fifth modification is in a state of detecting the manifest danger in addition to the latent danger.

In this case, the driving assistance apparatus 10b of the fifth modification causes the HUD 61 to display the above-described elliptical manifest information 662a, the above-described rectangular manifest information 662b, or the like so as to point to, for example, the person on the near right. At this time, the driving assistance apparatus 10b of the fifth modification changes a size, a brightness, a color, or the like of each piece of the manifest information 662a and 662b according to a magnitude of the detected manifest danger.

The driving assistance apparatus 10b according to the fifth modification causes the meter display 64 to display the latent information 616a or the like described above.

Although the latent information 616a is displayed in the example of (Ab) in FIG. 31 at this time, the driving assistance apparatus 10b of the fifth modification can display any of the latent information 615, 616a to 619a, and 616b to 619b on the meter display 64 according to a magnitude of the detected latent danger, that is, a magnitude of the degree of inappropriateness of the attention state of the driver.

When both the latent danger and the manifest danger are detected, the driving assistance apparatus 10b of the fifth modification can display the manifest information 662a, 662b, or the like on the HUD 61 having high visibility and display the latent information 616a or the like on the meter display 64 that is less likely to distract the attention of the driver as described above.

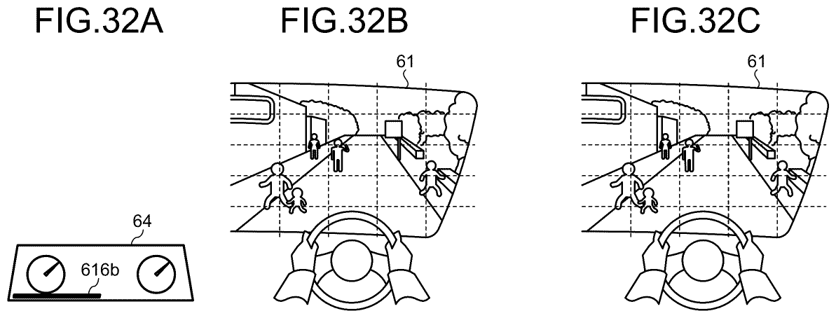

FIGS. 32A to 32C are schematic views illustrating another example in which presentation information generated by the driving assistance apparatus 10b according to the fifth modification of the first embodiment is divided and displayed on the HUD 61 and the meter display 64.

In examples illustrated in FIGS. 32A, 32B, and 32C, the driving assistance apparatus 10b of the fifth modification is in a state of detecting the latent danger but not detecting the manifest danger, that is, the state similar to that in the examples illustrated at (Aa), (Ba), and (Ca) in FIG. 31 described above.

Also in this case, the driving assistance apparatus 10b of the fifth modification can cause the meter display 64 to display the above-described latent information 616a or the like. In this case, the driving assistance apparatus 10b according to the fifth modification does not cause the HUD 61 to display information.

Even when only the latent danger is detected, the driving assistance apparatus 10b of the fifth modification may always cause the meter display 64 to display the latent information 616a or the like as described above.

FIG. 33 is a schematic view illustrating an example of a configuration of the pillar display 65 on which the driving assistance apparatus 10b according to the fifth modification of the first embodiment presents latent information.

As illustrated in FIG. 33, the pillar display 65 is provided, for example, in each of pillars PL on both sides of the windshield. As images of portions hidden by the pillars PL as viewed from the driver are displayed on the pillar displays 65, it is possible to provide the driver with a view as if the driver is looking outside the vehicle through the pillars PL, for example. The driving assistance apparatus 10b of the fifth modification causes, for example, such pillar displays 65 to display latent information.

FIG. 34 is a schematic view illustrating an example of presentation of latent information on the pillar display 65 by the driving assistance apparatus 10b according to the fifth modification of the first embodiment.

As illustrated at (Aa) in FIG. 34, for example, in a case where there is an area where the degree of inappropriateness of the attention state of the driver is high over the entire front of the vehicle, the driving assistance apparatus 10b of the fifth modification causes the pillar displays 65 on both sides of the windshield to display latent information 625.

The latent information 625 can be presentation information presented in rectangular areas arranged along the pillars PL on both sides of the windshield. However, the latent information for prompting strong attention calling with respect to the entire front of the vehicle may have another shape or mode different from that of the latent information 625 described above.

As illustrated at (Ab) in FIG. 34, for example, in a case where there is an area where the degree of inappropriateness of the attention state of the driver is relatively low over the entire front of the vehicle, the driving assistance apparatus 10b of the fifth modification causes the pillar displays 65 on both sides of the windshield to display a pair of pieces of latent information 629.

The latent information 629 can have, for example, a shape obtained by combining a pair of triangles pointing to the vicinity of the center of the windshield arranged on the front of the vehicle. However, the latent information for prompting weak attention calling to the entire front of the vehicle may have other shapes or modes such as an arrow.

As illustrated at (B) in FIG. 34, for example, in a case where there is an area where the degree of inappropriateness of the attention state of the driver is high, the area being biased to the right of the vehicle, the driving assistance apparatus 10b of the fifth modification causes the pillar display 65 on the left of the windshield to display latent information 626 indicating an area on the left opposite to the area.

The latent information 626 can be, for example, presentation information presented in a rectangular area arranged along the pillar PL on the left of the windshield arranged on the front of the vehicle. However, the latent information for prompting strong attention calling with respect to the driver having a large bias in the attention state may have another shape or mode different from that of the latent information 626.

As illustrated at (Ca) in FIG. 34, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification causes the pillar displays 65 on both sides of the windshield to display latent information 627 indicating an area on the right opposite to the area on the left of the vehicle in addition to the latent information 626 indicating the area on the left opposite to the area on the right of the vehicle.

The latent information 627 can be, for example, presentation information presented in a rectangular area arranged along the pillar PL on the right of the windshield arranged on the front of the vehicle. Furthermore, the latent information 627 is presented in a mode in which a brightness, a color, or the like thereof is different from that of the latent information 626, so that the intensity of attention calling can be suppressed to be lower than that of the latent information 626.

Note that the latent information for prompting weak attention calling with respect to the driver having a small bias in the attention state may have another shape or mode different from that of the latent information 627.

As illustrated at (Cb) in FIG. 34, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification causes the pillar displays 65 on both sides of the windshield to display latent information 628 indicating an area on the right opposite to the area on the left of the vehicle in addition to the latent information 626 indicating the area on the left opposite to the area on the right of the vehicle.

The latent information 628 can be, for example, presentation information presented in a rectangular area arranged along the pillar PL on the right of the windshield arranged on the front of the vehicle. Furthermore, the latent information 628 is presented in a mode in which a brightness, a color, or the like thereof is different from those of the latent information 626 and 627, so that the intensity of attention calling can be suppressed to be lower than that of the latent information 626 while being set to be higher than that of the latent information 627.

Note that the latent information for prompting moderate attention calling with respect to the driver having a moderate bias in the attention state may have another shape or mode different from that of the latent information 628.

With the above configuration, various types of the latent information 625 and 626 to 629 and the like based on the magnitude of the degree of inappropriateness of the attention state of the driver, the position in the image of the area where the degree of inappropriateness of the attention state is equal to or greater than the predetermined threshold, and the like can be displayed on the pillar displays 65.

Next, an example in which the driving assistance apparatus 10b according to the fifth modification presents information on the HUD 61 and the pillar display 65 in combination will be described.

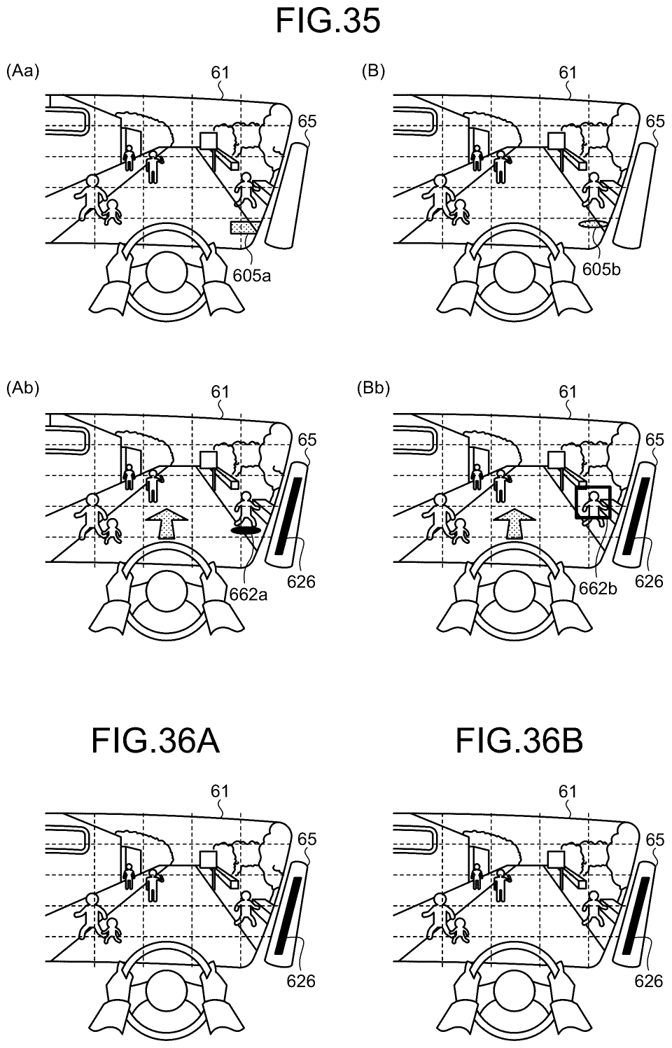

FIG. 35 is a schematic view illustrating an example in which presentation information generated by the driving assistance apparatus 10b according to the fifth modification of the first embodiment is divided and displayed on the HUD 61 and the pillar display 65.

In examples illustrated at (Aa) and (Ba) in FIG. 35, the driving assistance apparatus 10b of the fifth modification is in a state of detecting the latent danger such as a bias in the attention state of the driver, but not detecting the manifest danger such as a pedestrian who is likely to collide with the host vehicle.

In this case, the driving assistance apparatus 10b of the fifth modification causes the HUD 61 to display the above-described rectangular latent information 605a, the above-described elliptical latent information 605b, or the like so as to point to, for example, the person on the near right. On the other hand, the driving assistance apparatus 10b of the fifth modification does not cause the pillar display 65 to display information.

When only the latent danger is detected, the driving assistance apparatus 10b of the fifth modification can display the latent information 605a, 605b, or the like preferentially on the HUD 61 having high visibility as described above.

In examples illustrated at (Ab) and (Bb) in FIG. 35, the driving assistance apparatus 10b of the fifth modification is in a state of detecting the manifest danger in addition to the latent danger.

In this case, the driving assistance apparatus 10b of the fifth modification causes the HUD 61 to display the above-described elliptical manifest information 662a, the above-described rectangular manifest information 662b, or the like so as to point to, for example, the person on the near right. At this time, the driving assistance apparatus 10b of the fifth modification changes a size, a brightness, a color, or the like of each piece of the manifest information 662a and 662b according to a magnitude of the detected manifest danger.

Furthermore, the driving assistance apparatus 10b of the fifth modification displays the above-described latent information 626 or the like on the pillar display 65 on the right of the windshield.

Although the latent information 626 is displayed in the examples of (Ab) and (Bb) in FIG. 35 at this time, the driving assistance apparatus 10b of the fifth modification can display any of the latent information 625 and 626 to 629 described above on the pillar display 65 according to a magnitude of the detected latent danger, that is, a magnitude of the degree of inappropriateness of the attention state of the driver.

When both the latent danger and the manifest danger are detected, the driving assistance apparatus 10b of the fifth modification can display the manifest information 662a, 662b, or the like on the HUD 61 having high visibility and display the latent information 626 or the like on the pillar display 65 that is less likely to distract the attention of the driver as described above.

FIGS. 36A and 36B is a schematic view illustrating another example in which presentation information generated by the driving assistance apparatus 10b according to the fifth modification of the first embodiment is divided and displayed on the HUD 61 and the pillar display 65.

In examples illustrated in FIGS. 36A and 36B, the driving assistance apparatus 10b of the fifth modification is in a state of detecting the latent danger but not detecting the manifest danger, that is, the state similar to that in the examples illustrated at (Aa) and (Ba) in FIG. 35 described above.

Also in this case, the driving assistance apparatus 10b of the fifth modification can cause the pillar display 65 to display the above-described latent information 626 or the like. In this case, the driving assistance apparatus 10b according to the fifth modification does not cause the HUD 61 to display information.

Even when only the latent danger is detected, the driving assistance apparatus 10b of the fifth modification may always cause the pillar display 65 to display the latent information 626 or the like as described above.

Next, an example in which the driving assistance apparatus 10b according to the fifth modification presents information through the HUD 61 and the speaker 63 in combination will be described.

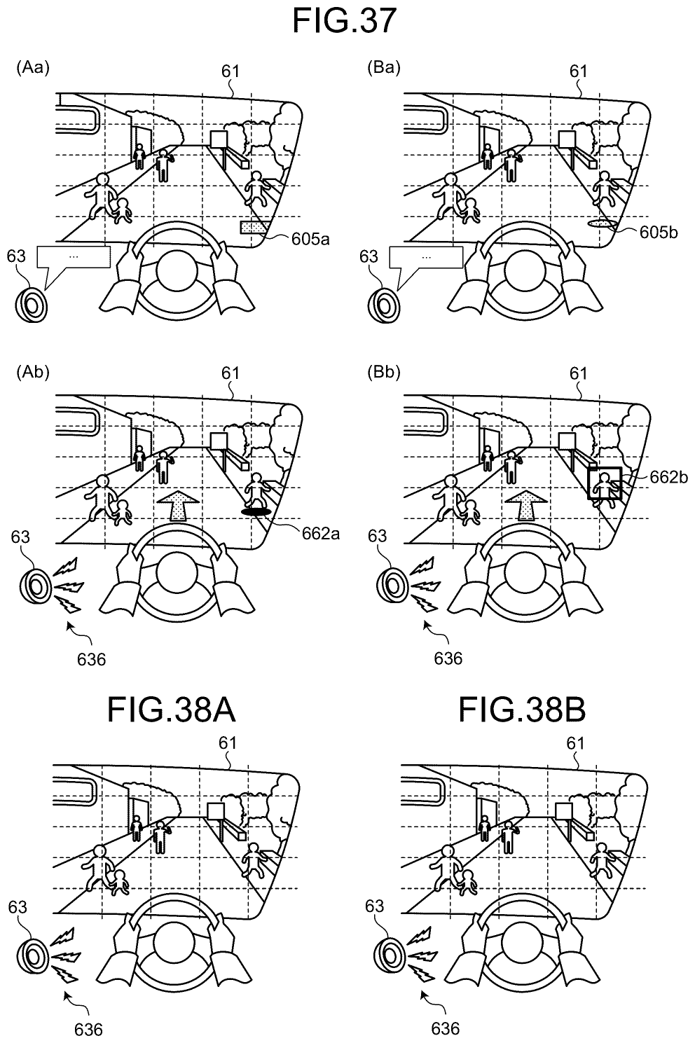

FIG. 37 is a schematic view illustrating an example in which presentation information generated by the driving assistance apparatus 10b according to the fifth modification of the first embodiment is divided and presented through the HUD 61 and the speaker 63.

In examples illustrated at (Aa) and (Ba) in FIG. 37, the driving assistance apparatus 10b of the fifth modification is in a state of detecting the latent danger such as a bias in the attention state of the driver, but not detecting the manifest danger such as a pedestrian who is likely to collide with the host vehicle.

In this case, the driving assistance apparatus 10b of the fifth modification causes the HUD 61 to display the above-described rectangular latent information 605a, the above-described elliptical latent information 605b, or the like so as to point to, for example, the person on the near right. On the other hand, the driving assistance apparatus 10b according to fifth modification does not cause the speaker 63 to output information.

When only the latent danger is detected, the driving assistance apparatus 10b of the fifth modification can display the latent information 605a, 605b, or the like preferentially on the HUD 61 having high visibility as described above.

In examples illustrated at (Ab) and (Bb) in FIG. 37, the driving assistance apparatus 10b of the fifth modification is in a state of detecting the manifest danger in addition to the latent danger.

In this case, the driving assistance apparatus 10b of the fifth modification causes the HUD 61 to display the above-described elliptical manifest information 662a, the above-described rectangular manifest information 662b, or the like so as to point to, for example, the person on the near right. At this time, the driving assistance apparatus 10b of the fifth modification changes a size, a brightness, a color, or the like of each piece of the manifest information 662a and 662b according to a magnitude of the detected manifest danger.

Furthermore, the driving assistance apparatus 10b of the fifth modification causes the speaker 63 to output audio 636 including latent information such as an announcement or a warning sound for warning to pay attention to an area on the right.

When both the latent danger and the manifest danger are detected, the driving assistance apparatus 10b of the fifth modification can display the manifest information 662a, 662b, or the like on the HUD 61 having high visibility as described above, and can output the latent information such as the audio 636 to the speaker 63 that is less likely to hinder the driver's view.

FIGS. 38A and 38B are schematic views illustrating another example in which presentation information generated by the driving assistance apparatus 10b according to the fifth modification of the first embodiment is divided and displayed through the HUD 61 and the speaker 63.

In examples illustrated in FIGS. 38A and 38B, the driving assistance apparatus 10b of the fifth modification is in a state of detecting the latent danger but not detecting the manifest danger, that is, the state similar to that in the examples illustrated at (Aa) and (Ba) in FIG. 37 described above.

Also in this case, the driving assistance apparatus 10b of the fifth modification causes the speaker 63 to output the audio 636 including the latent information. In this case, the driving assistance apparatus 10b according to the fifth modification does not cause the HUD 61 to display information.

Even when only the latent danger is detected, the driving assistance apparatus 10b of the fifth modification may always cause the speaker 63 to output the latent information such as the audio 636 as described above.

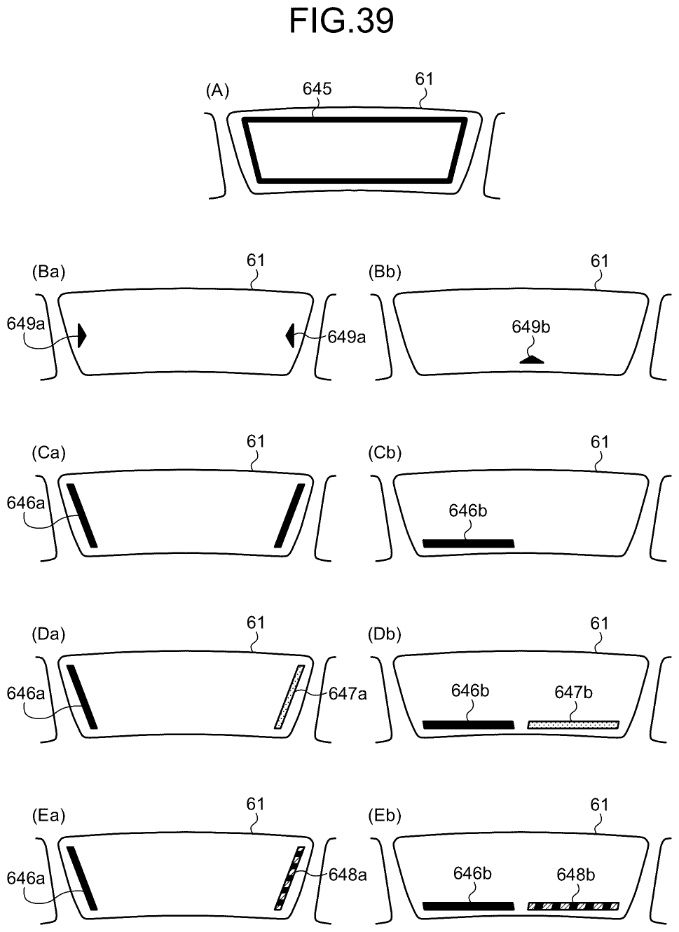

FIG. 39 is a schematic view illustrating an example of presentation of latent information on the outer peripheral area of the HUD 61 by the driving assistance apparatus 10b according to the fifth modification of the first embodiment.

As described below, the display of the latent information using the outer peripheral area of the HUD 61 may be performed similarly to the display of the latent information using the meter display 64 illustrated in FIG. 30 described above, for example.

As illustrated at (A) in FIG. 39, for example, in a case where there is an area where the degree of inappropriateness of the attention state of the driver is high over the entire front of the vehicle, the driving assistance apparatus 10b of the fifth modification displays latent information 645 surrounding an outer peripheral portion of the HUD 61 on the entire periphery of the HUD 61. However, the latent information for prompting strong attention calling with respect to the entire front of the vehicle may have a shape or a mode different from that of the latent information 645.

As illustrated at (Ba) in FIG. 39, for example, in a case where there is an area where the degree of inappropriateness of the attention state of the driver is relatively low over the entire front of the vehicle, the driving assistance apparatus 10b of the fifth modification displays a pair of pieces of latent information 649a at both left and right ends of the HUD 61.

The latent information 649a can have, for example, a shape obtained by combining a pair of triangles pointing to the vicinity of the center of the HUD 61 arranged on the front of the vehicle. However, the latent information for prompting weak attention calling to the entire front of the vehicle may have other shapes or modes such as an arrow.

As illustrated at (Bb) in FIG. 39, as another mode of the latent information 649a, for example, in a case where there is an area where the degree of inappropriateness of the attention state of the driver is relatively low over the entire front of the vehicle, the driving assistance apparatus 10b of the fifth modification can display latent information 649b, which is triangular and points to the center of the HUD 61, at a lower end of the center of the HUD 61.

As illustrated at (Ca) in FIG. 39, for example, in a case where there is an area where the degree of inappropriateness of the attention state of the driver is high, the area being biased to the right of the vehicle, the driving assistance apparatus 10b of the fifth modification displays latent information 646a, which indicates an area on the left opposite to the area, at the left end of the HUD 61.

The latent information 646a can be, for example, presentation information presented in a rectangular area arranged along the left end of the HUD 61 arranged on the front of the vehicle. However, the latent information for prompting strong attention calling with respect to the driver having a large bias in the attention state may have another shape or mode different from that of the latent information 646a.

As illustrated at (Cb) in FIG. 39, as another mode of the latent information 646a, for example, in a case where an area where the degree of inappropriateness of the attention state of the driver is high is located to be biased to the right of the vehicle, the driving assistance apparatus 10b of the fifth modification can display latent information 646b, which indicates an area on the left opposite to the area, at a left lower end of the HUD 61.

The latent information 646b can be, for example, presentation information presented in a rectangular area arranged along the left lower end of the HUD 61 arranged on the front of the vehicle.

As illustrated at (Da) in FIG. 39, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification displays latent information 647a, which indicates an area on the right opposite to the area on the left of the vehicle, at the right end of the HUD 61 in addition to the latent information 646a indicating an area on the left opposite to the area on the right of the vehicle.

The latent information 647a can be, for example, presentation information presented in a rectangular area arranged along the right of an A-pillar of the HUD 61 arranged on the front of the vehicle. Furthermore, the latent information 647a is presented in a mode in which a brightness, a color, or the like thereof is different from that of the latent information 646a, so that the intensity of attention calling can be suppressed to be lower than that of the latent information 646a.

Note that the latent information for prompting weak attention calling with respect to the driver having a small bias in the attention state may have another shape or mode different from that of the latent information 647a.

As illustrated at (Db) in FIG. 39, as another mode of the latent information 647a, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification can display, in addition to the latent information 646b, latent information 647b, which indicates an area on the right opposite to the area on the left, at the left lower end of the HUD 61.

The latent information 647b can be, for example, presentation information presented in a rectangular area arranged along a right lower end of the HUD 61 arranged on the front of the vehicle. Furthermore, the latent information 647b has a mode in which the intensity of calling attention is lower than that of the latent information 646b.

As illustrated at (Ea) in FIG. 39, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification displays latent information 648a, which indicates an area on the right opposite to the area on the left of the vehicle, at the right end of the HUD 61 in addition to the latent information 646a indicating an area on the left opposite to the area on the right of the vehicle.

The latent information 648a can be, for example, presentation information presented in a rectangular area arranged along the right end of the HUD 61 arranged on the front of the vehicle. Furthermore, the latent information 648a is presented in a mode in which a brightness, a color, or the like thereof is different from those of the latent information 646a and 647a, so that the intensity of attention calling can be suppressed to be lower than that of the latent information 646a while being set to be higher than that of the latent information 647a.

Note that the latent information for prompting moderate attention calling with respect to the driver having a moderate bias in the attention state may have another shape or mode different from that of the latent information 648a.

As illustrated at (Eb) in FIG. 39, as another mode of the latent information 648a, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification can display, in addition to the latent information 646b, latent information 658b, which indicates an area on the right opposite to the area on the left, at the left lower end of the HUD 61.

The latent information 648b can be, for example, presentation information presented in a rectangular area arranged along a right lower end of the HUD 61 arranged on the front of the vehicle. Furthermore, the latent information 648b has a mode in which the intensity of attention calling is higher than that of the latent information 647b and the intensity of attention calling is lower than that of the latent information 646b.

With the above configuration, various types of the latent information 645, 646a to 649a, 646b to 649b, and the like based on the magnitude of the degree of inappropriateness of the attention state of the driver, the position in the image of the area where the degree of inappropriateness of the attention state is equal to or greater than the predetermined threshold, and the like can be displayed on the HUD 61.

Note that, even when various types of the latent information 645, 646a to 649a, 646b to 649b, and the like are displayed using the outer peripheral area of the HUD 61, various images illustrated in FIGS. 31, 32, and the like described above are displayed in the central area of the HUD 61 excluding the outer peripheral area.

FIG. 40 is a schematic view illustrating an example of a configuration of the LED display 66 on which the driving assistance apparatus 10b according to the fifth modification of the first embodiment presents latent information.

As illustrated in FIG. 40, the LED display 66, which is a light emitting device, includes, for example, a plurality of LEDs arranged along a lower end of the HUD 61 arranged on the windshield. The driving assistance apparatus 10b of the fifth modification turns on/off these LEDs in a predetermined mode to present latent information on the LED display 66.

FIG. 41 is a schematic view illustrating an example of presentation of latent information on the LED display 66 by the driving assistance apparatus 10b according to the fifth modification of the first embodiment.

As illustrated at (Aa) in FIG. 41, for example, in a case where there is an area where the degree of inappropriateness of the attention state of the driver is high over the entire front of the vehicle, the driving assistance apparatus 10b of the fifth modification presents latent information 655 in which the entire LED display 66 extending along the lower end of the HUD 61 is turned on.

That is, the latent information 655 can be presentation information in a state in which all of the plurality of LEDs arranged along the lower end of the HUD 61 are turned on. However, the latent information for prompting strong attention calling with respect to the entire front of the vehicle may have another mode different from the latent information 655 described above.

As illustrated at (Ab) in FIG. 41, for example, in a case where there is an area where the degree of inappropriateness of the attention state of the driver is relatively low over the entire front of the vehicle, the driving assistance apparatus 10b of the fifth modification presents latent information 659 in which a central portion of the LED display 66 extending along the lower end of the HUD 61 is turned on.

That is, the latent information 659 can be presentation information in a state in which some LEDS arranged in the central portion among the plurality of LEDS arranged along the lower end of the HUD 61 are turned on. However, the latent information for prompting weak attention calling with respect to the entire front of the vehicle may have another mode different from the latent information 655 described above.

As illustrated at (B) in FIG. 41, for example, in a case where there is an area where the degree of inappropriateness of the attention state of the driver is high, the area being biased to the right of the vehicle, the driving assistance apparatus 10b of the fifth modification causes the LED display 66 to present latent information 656 indicating an area on the left opposite to the area.

The latent information 656 can be presentation information in a state in which a left portion of the LED display 66 extending along the lower end of the HUD 61 is turned on. That is, some LEDs arranged on the left among the plurality of LEDs arranged along the lower end of the HUD 61 are turned on. However, the latent information for prompting strong attention calling with respect to the driver having a large bias in the attention state may have another shape or mode different from that of the latent information 656.

As illustrated at (Ca) in FIG. 41, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification causes the LED display 66 to display latent information 657, which indicates an area on the right opposite to the area on the left of the vehicle, in addition to the latent information 656 indicating an area on the left opposite to the area on the right of the vehicle.

The latent information 657 can be presentation information in a state in which a right portion of the LED display 66 extending along the lower end of the HUD 61 is turned on. That is, some LEDs arranged on the right among the plurality of LEDs arranged along the lower end of the HUD 61 are turned on. Furthermore, the latent information 657 is presented in a mode in which the number, brightness, color, or the like of LEDs to be turned on is different from that of the latent information 656, so that the intensity of attention calling can be suppressed to be lower than that of the latent information 656.

Note that the latent information for prompting weak attention calling with respect to the driver having a small bias in the attention state may have another shape or mode different from that of the latent information 657.

As illustrated at (Cb) in FIG. 41, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification causes the LED display 66 to display latent information 658, which indicates an area on the right opposite to the area on the left of the vehicle, in addition to the latent information 656 indicating an area on the left opposite to the area on the right of the vehicle.

The latent information 658 can be presentation information in a state in which a right portion of the LED display 66 extending along the lower end of the HUD 61 is turned on. Furthermore, the latent information 658 is presented in a mode in which the number, brightness, color, or the like of LEDs to be turned on is different from those of the latent information 656 and 657, so that the intensity of attention calling can be suppressed to be lower than that of the latent information 656 while being set to be higher than that of the latent information 657.

Note that the latent information for prompting moderate attention calling with respect to the driver having a moderate bias in the attention state may have another shape or mode different from that of the latent information 658.

With the above configuration, the LED displays 66 can be caused to present various types of the latent information 655 and 656 to 659 and the like based on the magnitude of the degree of inappropriateness of the attention state of the driver, the position in the image of the area where the degree of inappropriateness of the attention state is equal to or greater than the predetermined threshold, and the like.

By the way, in FIG. 41 described above, the intensity of attention calling of each piece of the latent information 655 and 656 to 659 is presented in different modes by presenting, for example, the number, brightness, color, or the like of LEDs to be turned in different modes. However, a method of presenting the intensity of attention calling in different modes by the LED display 66 is not limited to the above.

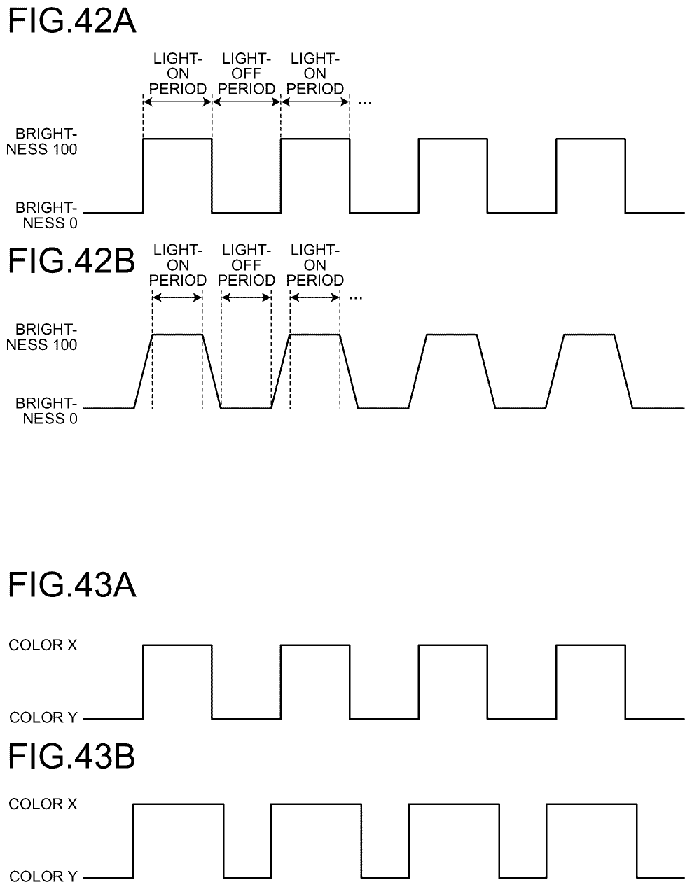

FIGS. 42A and 42B are schematic views illustrating an example in which presentation information generated by the driving assistance apparatus 10b according to the fifth modification of the first embodiment is presented on the LED display 66 by blinking of the LEDS.

As illustrated in FIG. 42A, the driving assistance apparatus 10b of the fifth modification can cause the LED display 66 to present latent information by blinking the LEDS serving as objects by which the latent information is presented. In an example of FIG. 42A, after a light-off period in which the brightness of the LEDs is set to 0% ends, a transition is made to a light-on period in which the brightness of the LEDs is set to 100%. When a transition is made to the light-off period after the end of the light-on period, the brightness of the LEDs is set to 0%.

At this time, it is possible to increase the intensity of attention calling of the latent information by increasing the brightness of the LEDs in the light-on period, and to decrease the intensity of attention calling of the latent information by suppressing the brightness of the LEDS in the light-on period to be low.

Alternatively, it is possible to increase the intensity of attention calling of the latent information by shortening a blinking cycle of the LEDS, and to decrease the intensity of attention calling of the latent information by lengthening the blinking cycle of the LEDS.

Alternatively, it is possible to increase the intensity of attention calling of the latent information by setting the light-on period of the LEDs to be longer than the light-off period, and to decrease the intensity of attention calling of the latent information by setting the light-on period of the LEDs to be shorter than the light-off period.

Furthermore, the LEDs can be switched between on and off by a method different from that in FIG. 4A.

In an example of FIG. 42B, after the end of the light-off period in which the brightness of the LEDs is set to 0%, a transition is made to the light-on period by gradually increasing the brightness of the LEDs up to 100%. When a transition is made to the light-off period after the end of the light-on period, the brightness of the LEDs is gradually reduced to 0%.

In this case, in addition to the method of adjusting the intensity of attention calling in FIG. 42A, for example, the intensity of attention calling of the latent information can be increased as the increase/decrease in the brightness of the LEDs is steeper, and the intensity of attention calling of the latent information can be decreased as the increase/decrease in the brightness of the LEDs is gentler.

FIGS. 43A and 43b are schematic views illustrating an example in which presentation information generated by the driving assistance apparatus 10b according to the fifth modification of the first embodiment is presented on the LED display 66 by lighting the LEDs in a plurality of colors.

As illustrated in FIG. 43A, the driving assistance apparatus 10b of the fifth modification can cause the LED display 66 to present latent information by periodically lighting the LEDs serving as objects by which the latent information is presented in different colors. In an example of FIG. 43A, the LEDs are alternately lit in color X and color Y.

At this time, it is possible to increase the intensity of attention calling of the latent information by increasing a difference in hue, saturation, lightness, or the like between the colors X and Y, and to decrease the intensity of attention calling of the latent information by decreasing the difference in hue, saturation, lightness, or the like between the colors X and Y.

That is, in order to increase a hue difference between the colors X and Y, for example, complementary colors can be used as the colors X and Y. Furthermore, in order to suppress the hue difference between the colors X and Y to be low, for example, similar colors can be used as the colors X and Y.

In order to increase a saturation difference between the colors X and Y, for example, a color with high saturation and a color with low saturation can be used in combination as the colors X and Y. In order to increase a lightness difference between the colors X and Y, for example, a color with high lightness and a color with low lightness can be used in combination as the colors X and Y.

Furthermore, in the above case, the individual LEDS may be alternately lit in the color X or the color Y on an array of the LEDs serving as the objects by which the latent information is presented. Furthermore, it is also possible to present the latent information such that each color of the colors X and Y flows on such an array of the LEDs.

That is, at time t1, odd-numbered LEDs on the array are lit in the color X, and even-numbered LEDs on the array are lit in the color Y. At the subsequent time t2, the odd-numbered LEDs are lit in the color Y, and the even-numbered LEDs are lit in the color X. This is alternately repeated, whereby the above-described visual effect as can be obtained.

Furthermore, it is also possible to adjust the intensity of attention calling of the latent information to be presented on the LED display 66 by a method different from that in FIG. 43A.

In an example of FIG. 43B, the driving assistance apparatus 10b of the fifth modification sets a light-on period of the color X to be longer than a light-on period of the color Y.

At this time, it is possible to increase the intensity of attention calling of the latent information by using a color with high hue, saturation, or lightness as the color X and using a color with low hue, saturation, or lightness as the color Y. Furthermore, it is possible to decrease the intensity of attention calling of the latent information by using a color with low hue, saturation, or lightness as the color X and using a color with high hue, saturation, or lightness as the color Y.

Also with the above configuration, it is possible to adjust the intensity of attention calling of the latent information to be presented on the LED display 66.

Note that the LED display 66 is provided at the lower end of the HUD 61 in the above example, but an arrangement position of the LED display 66 is not limited thereto. For example, the LED display 66 may be provided at both ends of the HUD 61 instead of or in addition to the lower end of the HUD 61, or may be provided so as to surround the outer periphery of the HUD 61.

Also in such a case, it is possible to present various types of latent information based on the magnitude of the degree of inappropriateness of the attention state of the driver, the position in the image of the area where the degree of inappropriateness of the attention state is equal to or greater than the predetermined threshold, and the like in modes conforming to various modes illustrated in FIG. 41 described above.

FIG. 44 is a schematic view illustrating an example of a configuration of the mirror display 67 on which the driving assistance apparatus 10b according to the fifth modification of the first embodiment presents latent information.

As illustrated in FIG. 44, for example, the mirror display 67 is installed at a position of a rearview mirror for checking the rear of the vehicle instead of the rearview mirror. The mirror display 67 is configured as a rearview mirror type, for example, and performs a function equivalent to the rearview mirror by projecting a rear image of the vehicle. The driving assistance apparatus 10b of the fifth modification causes, for example, such a mirror display 67 to display latent information.

FIG. 45 is a schematic view illustrating an example of presentation of latent information on the mirror display 67 by the driving assistance apparatus 10b according to the fifth modification of the first embodiment.

As described below, display of the latent information using an outer peripheral area of the mirror display 67 may be performed similarly to the display of the latent information using the meter display 64 illustrated in FIG. 30 described above, for example.

As illustrated at (A) in FIG. 45, for example, in a case where there is an area where the degree of inappropriateness of the attention state of the driver is high over the entire front of the vehicle, the driving assistance apparatus 10b of the fifth modification displays latent information 665 surrounding an outer peripheral portion of the mirror display 67 on the entire periphery of the mirror display 67. However, the latent information for prompting strong attention calling with respect to the entire front of the vehicle may have a shape or a mode different from that of the latent information 665.

As illustrated at (Ba) in FIG. 45, for example, in a case where there is an area where the degree of inappropriateness of the attention state of the driver is relatively low over the entire front of the vehicle, the driving assistance apparatus 10b of the fifth modification displays a pair of pieces of latent information 669a at both left and right ends of the mirror display 67.

The latent information 669a can have, for example, a shape obtained by combining a pair of triangles pointing to the vicinity of the center of the mirror display 67 likened to the front of the vehicle. However, the latent information for prompting weak attention calling to the entire front of the vehicle may have other shapes or modes such as an arrow.

As illustrated at (Bb) in FIG. 45, as another mode of the latent information 669a, for example, in a case where there is an area where the degree of inappropriateness of the attention state of the driver is relatively low over the entire front of the vehicle, the driving assistance apparatus 10b of the fifth modification can display latent information 669b, which is triangular and points to the center of the mirror display 67, at a lower end of the center of the mirror display 67.

As illustrated at (Ca) in FIG. 45, for example, in a case where there is an area where the degree of inappropriateness of the attention state of the driver is high, the area being biased to the right of the vehicle, the driving assistance apparatus 10b of the fifth modification displays latent information 666a, which indicates an area on the left opposite to the area, at the left end of the mirror display 67.

The latent information 666a can be, for example, presentation information presented in a rectangular area arranged along the left end of the mirror display 67 that is likened to the area on the left of the vehicle. However, the latent information for prompting strong attention calling with respect to the driver having a large bias in the attention state may have another shape or mode different from that of the latent information 666a.

As illustrated at (Cb) in FIG. 45, as another mode of the latent information 666a, for example, in a case where an area where the degree of inappropriateness of the attention state of the driver is high is located to be biased to the right of the vehicle, the driving assistance apparatus 10b of the fifth modification can display latent information 666b, which indicates an area on the left opposite to the area, at a left lower end of the mirror display 67.

The latent information 666b can be, for example, presentation information presented in a rectangular area arranged along the left lower end of the mirror display 67 that is likened to the area on the left of the vehicle.

As illustrated at (Da) in FIG. 45, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification displays latent information 667a, which indicates an area on the right opposite to the area on the left of the vehicle, at the right end of the mirror display 67 in addition to the latent information 666a indicating an area on the left opposite to the area on the right of the vehicle.

The latent information 667a can be, for example, presentation information presented in a rectangular area arranged along the right end of the mirror display 67 that is likened to the area on the right of the vehicle. Furthermore, the latent information 667a is presented in a mode in which a brightness, a color, or the like thereof is different from that of the latent information 666a, so that the intensity of attention calling can be suppressed to be lower than that of the latent information 666a.

Note that the latent information for prompting weak attention calling with respect to the driver having a small bias in the attention state may have another shape or mode different from that of the latent information 667a.

As illustrated at (Db) in FIG. 45, as another mode of the latent information 667a, for example, in a case where an area where the degree of inappropriateness of the attention state of the driver is high is located to be biased to the right of the vehicle and an area where the degree of inappropriateness of the attention state of the driver is relatively low is located to be biased to the left of the vehicle, the driving assistance apparatus 10b of the fifth modification can display, in addition to the latent information 666b, latent information 667b, which indicates an area on the right opposite to the area on the left, at the left lower end of the mirror display 67.

The latent information 667b can be, for example, presentation information presented in a rectangular area arranged along a right lower end of the mirror display 67 that is likened to the area on the right of the vehicle. Furthermore, the latent information 667b has a mode in which the intensity of calling attention is lower than that of the latent information 666b.

As illustrated at (Ea) in FIG. 45, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification displays latent information 668a, which indicates an area on the right opposite to the area on the left of the vehicle, at the right end of the mirror display 67 in addition to latent information 666a indicating an area on the left opposite to the area on the right of the vehicle.

The latent information 668a can be, for example, presentation information presented in a rectangular area arranged along the right end of the mirror display 67 that is likened to the area on the right of the vehicle. Furthermore, the latent information 668a is presented in a mode in which a brightness, a color, or the like thereof is different from those of the latent information 666a and 667a, so that the intensity of attention calling can be suppressed to be lower than that of the latent information 666a while being set to be higher than that of the latent information 667a.

Note that the latent information for prompting moderate attention calling with respect to the driver having a moderate bias in the attention state may have another shape or mode different from that of the latent information 668a.

As illustrated at (Eb) in FIG. 45, as another mode of the latent information 668a, for example, in a case where an area where the degree of inappropriateness of the attention state of the driver is high is located to be biased to the right of the vehicle and an area where the degree of inappropriateness of the attention state of the driver is medium is located to be biased to the left of the vehicle, the driving assistance apparatus 10b of the fifth modification can display, in addition to the latent information 666b, latent information 668b, which indicates an area on the right opposite to the area on the left, at the left lower end of the mirror display 67.

The latent information 668b can be, for example, presentation information presented in a rectangular area arranged along the right lower end of the mirror display 67 that is likened to the area on the right of the vehicle. Furthermore, the latent information 668b has a mode in which the intensity of attention calling is higher than that of the latent information 667b and the intensity of attention calling is lower than that of the latent information 666b.

With the above configuration, various types of the latent information 665, 666a to 669a, 666b to 669b, and the like based on the magnitude of the degree of inappropriateness of the attention state of the driver, the position in the image of the area where the degree of inappropriateness of the attention state is equal to or greater than the predetermined threshold, and the like can be displayed on the mirror display 67.

According to the driving assistance apparatus 10b of the fifth modification, two or more information presentation apparatuses out of the HUD 61, the in-vehicle monitor 62, the speaker 63, the meter display 64, the pillar display 65, the LED display 66, and the mirror display 67 are caused to present pieces of presentation information divided into a plurality of portions, respectively.

As a result, it is possible to present manifest information indicating a higher risk, for example, to a component which has high visibility and easily attracts the attention of the driver among the HUD 61, the in-vehicle monitor 62, the speaker 63, the meter display 64, the pillar display 65, the LED display 66, and the mirror display 67 of the various components included in the information presentation apparatus 60, and to present latent information indicating a relatively low risk, for example, to a configuration in which information presentation is possible without distracting the attention of the driver.

According to the driving assistance apparatus 10b of the fifth modification, other effects similar to those of the driving assistance apparatus 10 of the first embodiment described above are obtained.

Note that, in the driving assistance apparatus 10b of the fifth modification described above, for example, the HUD 61 or the in-vehicle monitor 62 is caused to mainly present the manifest information, any of the other configurations is caused to present the latent information, so that these configurations are combined to present information to the driver.

However, as in the driving assistance apparatus 10 of the first embodiment described above, for example, in a configuration in which the latent information is exclusively presented, any of the other configurations, such as the speaker 63, the meter display 64, the pillar display 65, the outer peripheral area of the HUD 61, the LED display 66, or the mirror display 67, may be used alone to present the latent information without being combined with the HUD 61, the in-vehicle monitor 62, or the like.

### Sixth Modification

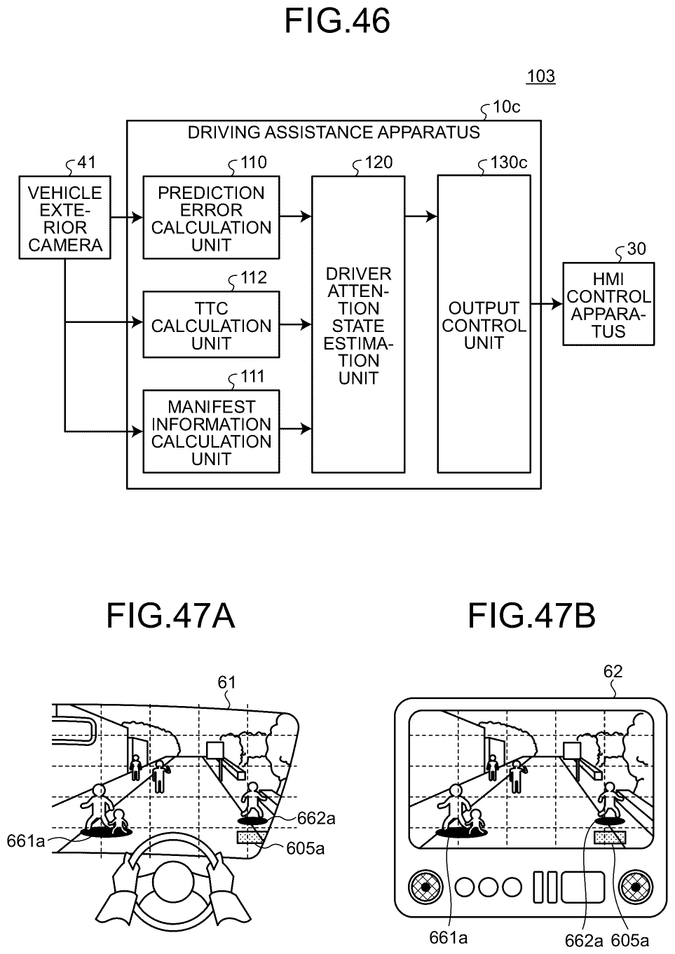

Next, a driving assistance apparatus according to a sixth modification of the first embodiment will be described with reference to FIGS. 46 to 48. The driving assistance apparatus of the sixth modification is different from that of the above-described fifth modification in that a time-to-collision (TTC) is also taken into consideration when latent information and manifest information are presented.

FIG. 46 is a block diagram illustrating an example of a functional configuration of a driving assistance apparatus 10c according to the sixth modification of the first embodiment together with peripheral devices.

As illustrated in FIG. 26, instead of the driving assistance apparatus 10b according to the fifth modification described above, the driving assistance apparatus 10c according to the sixth modification is mounted in a vehicle 103 according to the sixth modification.

The driving assistance apparatus 10c includes a TTC calculation unit 112 that calculates the TTC in addition to the configuration of the driving assistance apparatus 10b of the fifth modification described above, and further includes an output control unit 130c that acquires the attention state of the driver estimated by the driver attention state estimation unit 120, the manifest information generated by the manifest information calculation unit 111, and TTC information calculated by the TTC calculation unit 112 and outputs driving assistance information, instead of the output control unit 130b of the fifth modification described above.

The TTC calculated by the TTC calculation unit 112 is a time until the vehicle actually collides with an obstacle that is likely to collide with the vehicle 103, such as a pedestrian in front of the vehicle 103. As a value of the TTC decreases, it means that there is insufficient time before the collision between the obstacle and the vehicle 103. Furthermore, as the value of the TTC increases, it means that there is sufficient time before the collision between the obstacle and the vehicle 103.

The TTC calculation unit 112 calculates the TTC for an obstacle, such as a pedestrian included in an area as a target of information presentation, from a distance between the vehicle 103 and the obstacle, a speed of the vehicle 103, and the like.

The driver attention state estimation unit 120 passes the estimated driver's attention state, the manifest information generated by the manifest information calculation unit 111, and the TTC information calculated for each obstacle by the TTC calculation unit 112 to the output control unit 130c.

The output control unit 130c outputs, to the HMI control apparatus 30, the driving assistance information including information regarding an area to which the attention of the driver is to be called, extracted based on the attention state of the driver and the manifest information passed from the driver attention state estimation unit 120.

Furthermore, the output control unit 130c determines whether or not to include latent information in the driving assistance information including the manifest information based on the TTC information calculated by the TTC calculation unit 112. When the TTC is equal to or more than a predetermined threshold, the output control unit 130c outputs the driving assistance information including the latent information to the HMI control apparatus 30. When the TTC is less than the predetermined threshold, the output control unit 130c outputs the driving assistance information to the HMI control apparatus 30 without including the latent information.

FIGS. 47A and 47B are schematic views illustrating an example of information presentation by the driving assistance apparatus 10c according to the sixth modification of the first embodiment.

In the example of FIGS. 47A and 47B, for example, an area including a person on the near right and an area including a parent accompanying a child on the near left are assumed as the areas to which the attention of the driver is to be called. Furthermore, it is assumed that a TTC for the person on the near right is equal to or more than the predetermined threshold, and a TTC for the parent accompanying the child on the near left is less than the predetermined threshold.

As illustrated in FIGS. 47A and 47B, the driving assistance apparatus 10c of the sixth modification causes the HUD 61 or the in-vehicle monitor 62 to display pieces of the above-described elliptical manifest information 662a indicating the person on the near right and the parent accompanying the child on the near left, respectively.

Furthermore, the driving assistance apparatus 10c of the sixth modification causes the HUD 61 or the in-vehicle monitor 62 to display the above-described rectangular latent information 605a indicating the person on the near right whose TTC is equal to or more than the predetermined threshold. On the other hand, the driving assistance apparatus 10c according to the sixth modification does not display latent information for the parent accompanying the child whose TTC is less than the predetermined threshold.

As described above, the latent information 605a is displayed in a state where the TTC is sufficiently long and there is sufficient time before the collision, so that it is possible to cause the driver to perform an appropriate manipulation according to the latent information. On the other hand, the latent information is not displayed in a state where the TTC is short and there is insufficient time to the collision, so that it is possible to suppress the driver from being distracted with the latent information and being hindered in performing an appropriate manipulation.

However, the shapes, presentation positions, presentation modes, and the like of the manifest information 662a and the latent information 605a are not limited to the example of FIGS. 47A and 47B described above.

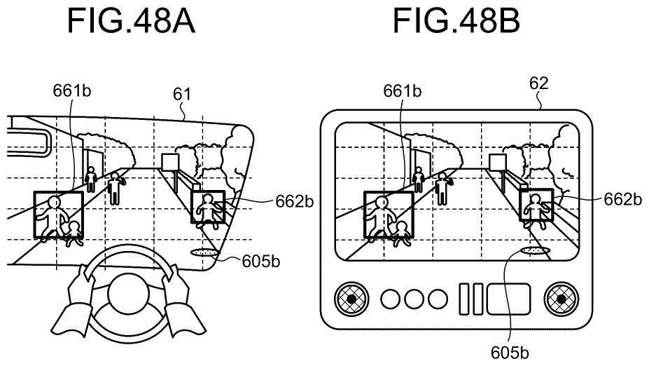

FIGS. 48A and 48B are schematic views illustrating another example of information presentation by the driving assistance apparatus 10c according to the sixth modification of the first embodiment.

In the example illustrated in FIGS. 48A and 48B, the driving assistance apparatus 10c of the sixth modification displays pieces of the rectangular manifest information 662b indicating the person on the near right and the parent accompanying the child on the near left so as to surround the person and the parent accompanying the child, respectively. Furthermore, the driving assistance apparatus 10c of the sixth modification displays the latent information 605b, which is elliptical and indicates the person on the near right, at a lower position away from the feet of the person.

Note that the driving assistance apparatus 10c of the sixth modification may change, for example, the size, brightness, color, or the like of each piece of the manifest information 662a and 662b according to a length of the TTC to adjust the magnitude of the intensity of calling the attention of the driver. Furthermore, the driving assistance apparatus 10c of the sixth modification may adjust the magnitude of the intensity of calling the attention of the driver by changing the size, brightness, color, or the like of each piece of the latent information 605a and 605b according to the magnitude of the degree of inappropriateness of the attention state of the driver.

As described above, the shapes, presentation positions, presentation modes, and the like of the manifest information 662 and the latent information 605 can be presented in various different modes.

Note that the driving assistance apparatus 10c of the sixth modification may also cause different information presentation apparatuses 60 to present the manifest information and the latent information, respectively, as illustrated in FIGS. 29 to 45 and the like of the fifth modification described above.

Furthermore, the driving assistance apparatus 10c of the sixth modification may present information different from those of the above-described examples of FIGS. 47 and 48 based on the prediction error and the TTC.

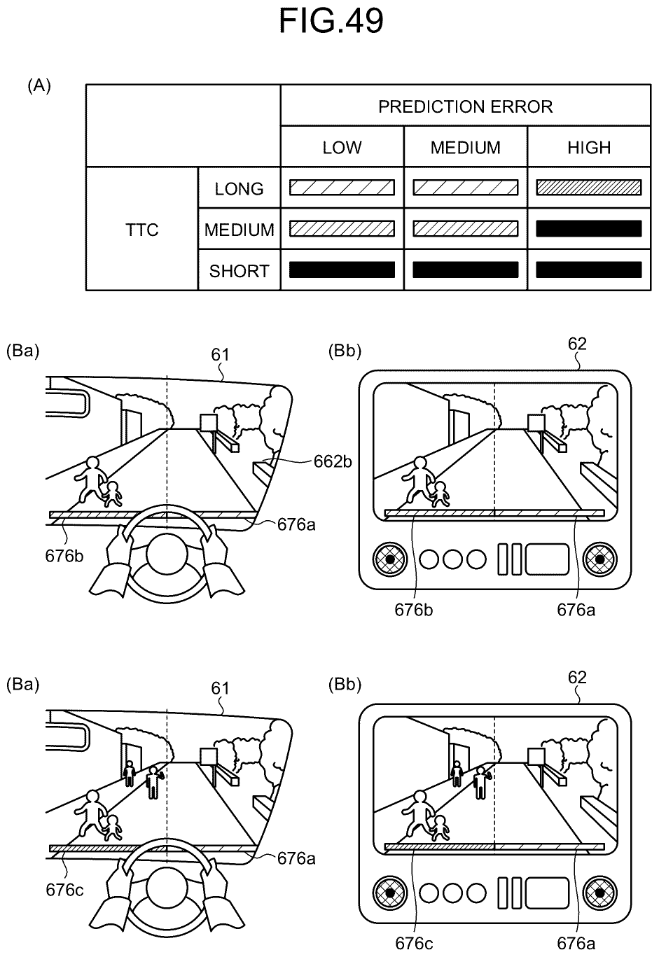

FIG. 49 is a schematic view illustrating still another example of information presentation by the driving assistance apparatus 10c according to the sixth modification of the first embodiment. In the example of FIG. 49, the driving assistance apparatus 10c of the sixth modification presents latent information with different intensities of calling the attention of the driver based on indexes obtained by combining the magnitude of the prediction error and the length of the TTC.

FIG. 49 illustrates, at (A), an example of a presentation mode table of the latent information given to the driving assistance apparatus 10c of the sixth modification. As illustrated at (A) in FIG. 49, in the presentation mode table of the latent information, a plurality of modes of the latent information having different intensities of attention calling are defined. These intensities of attention calling of the latent information are determined by two parameters of the prediction error and the TTC.

That is, three thresholds of low, medium, and high are set for the prediction error, and three thresholds of short, medium, and long are set for the TTC. In the presentation mode table of the latent information, modes of the latent information are defined for nine patterns obtained by combining cases where the prediction error is low, medium, and high and cases where the TTC is short, medium, and long.

Among these nine patterns, in a case where the prediction error is low and the TTC is long, the intensity of attention calling of the latent information is the lowest. Furthermore, in a case where the prediction error is low and the TTC is short, in a case where the prediction error is medium and the TTC is short, and in a case where the prediction error is high and the TTC is short or medium, the intensity of attention calling of the latent information is the highest.

Furthermore, in a case where the prediction error is medium and the TTC is long, the intensity of attention calling of the latent information is higher than that in the case where the prediction error is low and the TTC is long. Furthermore, in a case where the prediction error is low and the TTC is medium, and in a case where both the prediction error and the TTC are medium, the intensity of attention calling of the latent information is higher than that in the case where the prediction error is medium and the TTC is long. Furthermore, in a case where the prediction error is high and the TTC is long, the intensity of attention calling of the latent information is higher than that in a case where the prediction error is low and the TTC is medium or the like.

As described above, in the presentation mode table of the latent information, four modes of the latent information are defined for the nine patterns obtained by combining the magnitude of the prediction error and the length of the TTC. However, the definition of the modes of the latent information illustrated at (A) in FIG. 49 is merely an example, and various modes of the latent information can be defined.

For example, stages of each of the magnitude of the prediction error and the length of the TTC may be two stages or four or more stages instead of the above three stages. In addition, for example, there may be three or less or five or more modes of the latent information instead of the above four modes for the combination patterns of the magnitude of the prediction error and the length of the TTC.

The driving assistance apparatus 10c of the sixth modification determines a presentation mode of the latent information according to, for example, the presentation mode table of the latent information illustrated at (A) in FIG. 49. FIG. 49 illustrates, at (Aa) to (Cb), examples of a case where the latent information is displayed on the HUD 61 or the in-vehicle monitor 62.

As illustrated in FIG. 49, the driving assistance apparatus 10c of the sixth modification divides an image into, for example, left and right areas, and calculates a prediction error and a TTC for each of the areas.

In the examples of (Aa) and (Ba) in FIGS. 49, it is assumed that both the prediction error and the TTC are determined to be medium for the left area including a parent accompanying a child on the near left, and it is determined that the prediction error is low and the TTC is long for the right area including no person.

In this case, the driving assistance apparatus 10c of the sixth modification displays latent information 676b presented in a rectangular area arranged along a lower end of the left area. The latent information 676b has the intensity of attention calling in the case where both the prediction error and the TTC are medium.

Furthermore, the driving assistance apparatus 10c of the sixth modification displays latent information 676a presented in a rectangular area arranged along a lower end of the right area. The latent information 676a has the intensity of attention calling in the case where the prediction error is low and the TTC is long.

In the examples of (Ab) and (Bb) in FIG. 49, it is assumed that it is determined that the prediction error is high and the TTC is long for the left area including a parent accompanying a child on the near left and including two persons on the far left, and it is determined that the prediction error is low and the TTC is long for the right area including no person.

In this case, the driving assistance apparatus 10c of the sixth modification displays latent information 676c presented in a rectangular area arranged along a lower end of the left area. The latent information 676c has the intensity of attention calling in the case where the prediction error is high and the TTC is long.

Furthermore, the driving assistance apparatus 10c of the sixth modification displays the latent information 676a extending along a lower end of the right area, similarly to the examples of (Aa) and (Ba) in FIG. 49 described above.

Note that the driving assistance apparatus 10c of the sixth modification can adjust the magnitude of the intensity of calling the attention of the driver by changing, for example, a length, a thickness, a brightness, a color, or the like of each piece of the latent information 676a to 676c when the latent information 676a to 676c or the like is visually displayed on the HUD 61, the in-vehicle monitor 62, or the like as illustrated in FIG. 49 described above.

As described above, since the latent information is presented based on the two parameters of the prediction error and the TTC, the driving assistance information based on more information can be generated with high accuracy, and the presentation mode can be simplified by using, for example, only the latent information 676a to 676c.

According to the driving assistance apparatus 10c of the sixth modification, effects similar to those of the driving assistance apparatus 10b of the fifth modification described above are obtained in addition to the above.

### Seventh Modification

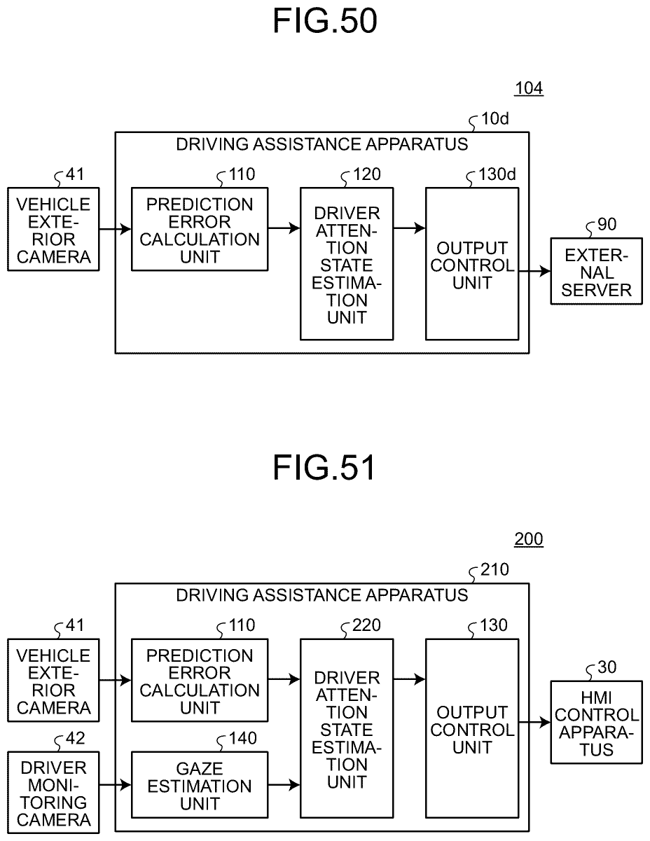

Next, a driving assistance apparatus 10d according to a seventh modification of the first embodiment will be described with reference to FIG. 50. The driving assistance apparatus 10d of the seventh modification is different from that of the above-described first embodiment in that driving assistance information is output to an external server 90.

FIG. 50 is a block diagram illustrating an example of a functional configuration of the driving assistance apparatus 10d according to the seventh modification of the first embodiment together with peripheral devices.

As illustrated in FIG. 50, instead of the driving assistance apparatus 10 according to the first embodiment described above, the driving assistance apparatus 10d according to the seventh modification is mounted in a vehicle 104 according to the seventh modification. The driving assistance apparatus 10d includes an output control unit 130d that outputs the driving assistance information to the external server 90, instead of the output control unit 130 of the first embodiment described above.

The output control unit 130d generates the driving assistance information associated with an area to which the attention of the driver is to be called and outputs the generated driving assistance information to the external server 90.

The external server 90 is connected to a plurality of vehicles including the vehicle 104 of the seventh modification so as to be able to transmit and receive information to and from each other by, for example, a wireless local area network (LAN) or the like. The external server 90 acquires and accumulates driving assistance information generated by driving assistance apparatuses from the driving assistance apparatuses of the plurality of vehicles including the driving assistance apparatus 10d of the seventh modification.

The driving assistance information accumulated in the external server 90 is stored in a database, for example, to be utilized in driving assistance to a driver of another vehicle. As a result, driving assistance information generated by a predetermined vehicle can be shared among the plurality of vehicles to perform driving assistance to drivers. Furthermore, since the driving assistance information collected from the plurality of vehicles is stored in the database, the accuracy of driving assistance can be improved.

According to the driving assistance apparatus 10d of the seventh modification, other effects similar to those of the driving assistance apparatus 10 of the first embodiment described above are obtained.

### Second Embodiment

A second embodiment will be described with reference to the drawings. The second embodiment is different from the above-described first embodiment in that a driving assistance apparatus generates driving assistance information in consideration of a gaze of a driver.

FIG. 51 is a block diagram illustrating an example of a functional configuration of a driving assistance apparatus 210 according to the second embodiment together with peripheral devices.

As illustrated in FIG. 51, instead of the driving assistance apparatus 10 according to the first embodiment described above, the driving assistance apparatus 210 according to the second embodiment is mounted in a vehicle 200 according to the second embodiment.

The driving assistance apparatus 210 includes a gaze estimation unit 140 that estimates a destination of the gaze of the driver in addition to the configuration of the driving assistance apparatus 10 of the first embodiment described above, and further includes a driver attention state estimation unit 220 that acquires information from the prediction error calculation unit 110 and the gaze estimation unit 140 and estimates an attention state of the driver instead of the driver attention state estimation unit 120 of the first embodiment described above.

The gaze estimation unit 140 estimates the destination of the gaze of the driver from a face image of the driver captured by the driver monitoring camera 42, for example. More specifically, when an image in a traveling direction of the vehicle 200 captured by the vehicle exterior camera 41 is divided into, for example, a plurality of areas as described above, the gaze estimation unit 140 estimates an area to which the gaze of the driver is directed among the plurality of areas.

Similarly to the driver attention state estimation unit 120 of the first embodiment described above, the driver attention state estimation unit 220 calculates a level of likelihood of attracting the driver's attention in the plurality of areas in the image. Furthermore, the driver attention state estimation unit 220 estimates the attention state of the driver for each of the plurality of areas based on a magnitude of a degree of inappropriateness of the attention state in each of the plurality of areas and the direction of the gaze of the driver estimated by the gaze estimation unit 140.

Here, as described in FIG. 4 of the first embodiment, the driver tends to pay attention to a portion having a large prediction error. According to the method illustrated in FIG. 4, the driver attention state estimation unit 220 estimates the likelihood of attracting the attention of the driver based on a prediction error of an area to which the driver is directing the gaze and a prediction error of an arbitrary area to which the driver is not directing the gaze.

That is, the driver attention state estimation unit 220 extracts the area to which the driver is directing the gaze and the arbitrary area, calculates an AUC value for the area to which the driver is directing the gaze from a ratio at which the predicted error of each of the areas is equal to or larger than a predetermined threshold, and uses information including an area in which the AUC value is larger than a predetermined threshold for estimation of the attention state of the driver.

As described above, since not only the prediction error but also the gaze of the driver is taken into consideration, it is possible to estimate whether or not the attention state of the driver is in an appropriate state for a predetermined area with higher accuracy. Note that the AUC value calculated as described above is also referred to as an attention state index hereinafter.

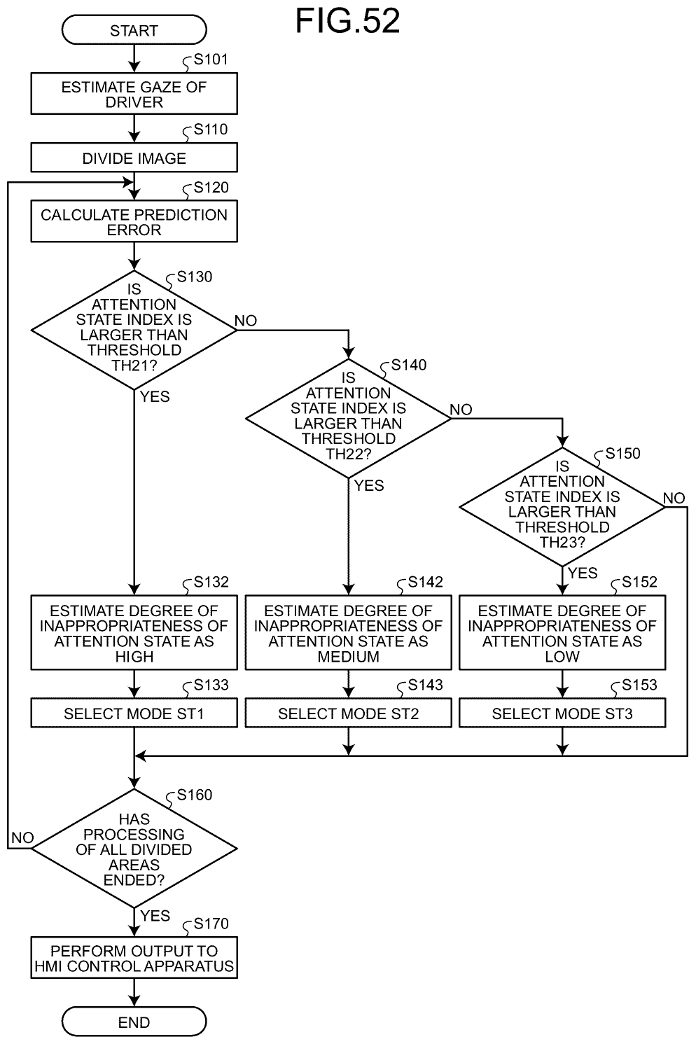

FIG. 52 is a flowchart illustrating an example of a procedure of driving assistance processing performed by the driving assistance apparatus 210 according to the second embodiment. Note that, in the processing illustrated in FIG. 52, Step S101 is a process newly added to the processing illustrated in FIG. 7 of the first embodiment described above.

As illustrated in FIG. 52, the gaze estimation unit 140 included in the driving assistance apparatus 210 according to the second embodiment estimates a destination of the gaze of the driver from a face image of the driver captured by the driver monitoring camera 42 (Step S101). Furthermore, the driver attention state estimation unit 220 divides an image captured by the vehicle exterior camera 41 into a plurality of areas (Step S110), and calculates a prediction error for each of the areas (Step S120).

Furthermore, when an AUC value of a predetermined area obtained from the calculated prediction error and the estimated gaze, that is, an attention state index is larger than a threshold TH21 (Step S130: Yes), the driver attention state estimation unit 220 estimates that a degree of inappropriateness of the attention state of the driver for the area is high (Step S132).

Based on such estimation by the driver attention state estimation unit 220, the output control unit 130 selects the mode ST1 having the strong intensity of attention calling for information to be presented in an area opposite to the area.

When the attention state index of the predetermined area is larger than a threshold TH22, which is smaller than the threshold TH21 (Step S130: No, Step S140: Yes), the driver attention state estimation unit 220 estimates that the degree of inappropriateness of the attention state of the driver for the area is medium (Step S142).

Based on such estimation by the driver attention state estimation unit 220, the output control unit 130 selects the mode ST2 having the medium intensity of attention calling for driving information to be presented in the area opposite to the area.

When the attention state index of the predetermined area is larger than a threshold TH23, which is smaller than the threshold TH22 (Step S140: No, Step S150: Yes), the driver attention state estimation unit 220 estimates that the degree of inappropriateness of the attention state of the driver for the area is low (Step S152).

Based on such estimation by the driver attention state estimation unit 220, the output control unit 130 selects the mode ST2 having the low intensity of attention calling for driving information to be presented in the area opposite to the area.

When the attention state index of the predetermined area is smaller than the threshold TH23 (Step S150: No), the driver attention state estimation unit 220 determines that the attention state of the driver for the area is sufficiently appropriate, and the output control unit 130 does not generate driving assistance information to be presented in the area opposite to the area.

The driving assistance apparatus 210 of the second embodiment repeats the above processing for all the areas (Step S160: No), and after the processing for all the areas ends (Step S160: Yes), outputs the generated driving assistance information to the HMI control apparatus 30 (Step S170).

Thus, the driving assistance processing by the driving assistance apparatus 210 of the second embodiment ends.

As described above, the driving assistance apparatus 210 divides the image into the plurality of areas and performs various processes in the above description, which is similar to the driving assistance apparatus 10 of the first embodiment. However, in the second embodiment, it is only necessary to extract the destination of the gaze of the driver and any other portion, and it is not always necessary to divide the image into the plurality of areas. That is, the above processing may be executed by performing extraction for each of pixels in the image, for example, a pixel to which the gaze of the driver is directed and a pixel to which the gaze of the driver is not directed.

Note that information included in the driving assistance information output to the HMI control apparatus 30 as described above by the driving assistance apparatus 210 of the second embodiment can be presented by the information presentation apparatus 60 in the various modes described in the first embodiment and the first to third modifications, for example.

As a result, in a state where the attention is likely to be attracted, the state being estimated by the attention state estimation unit, visual behavior can be unconsciously changed so as to guide the driver to an appropriate attention state, and it is possible to call attention so as to make the driver conscious.

At this time, the driving assistance apparatus 210 of the second embodiment may be provided with the manifest information calculation unit 111, the TTC calculation unit 112, or the like similarly to the fifth or sixth modification or the like of the first embodiment described above such that latent information and manifest information included in the driving assistance information can be presented.

Alternatively, the driving assistance apparatus 210 of the second embodiment may be configured to be able to output the driving assistance information to the ECU 20, the external server 90, or the like, similarly to the fourth or seventh modification or the like of the first embodiment described above.

According to the driving assistance apparatus 210 of the second embodiment, the attention state of the driver is estimated based on the direction of the gaze of the driver in addition to the prediction error. As a result, it is possible to estimate the attention state of the driver with higher accuracy and present more appropriate information to the driver.

According to the driving assistance apparatus 210 of the second embodiment, the likelihood of attracting attention is estimated based on the prediction error of the area to which the driver is directing the gaze and the prediction error of the arbitrary area among the plurality of areas in the image obtained by capturing the traveling direction of the vehicle 104.

As a result, for example, even in an area with a high prediction error, unnecessary information presentation can be prevented when there is no bias in the attention state of the driver.

According to the driving assistance apparatus 210 of the second modification, other effects similar to those of the driving assistance apparatus 10 of the first embodiment described above are obtained.

### Third Embodiment

A third embodiment will be described with reference to the drawings. The third embodiment is different from the above-described first embodiment in that a driving assistance apparatus generates driving assistance information in consideration of a skill level of a driver.

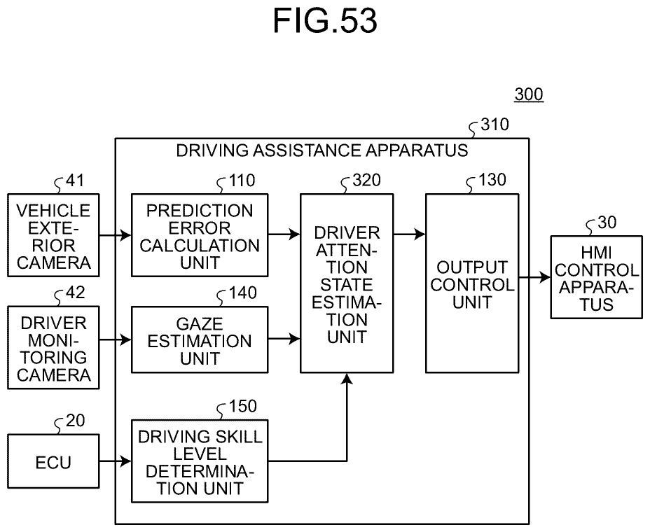

FIG. 53 is a block diagram illustrating an example of a functional configuration of a driving assistance apparatus 310 according to the third embodiment together with peripheral devices.

As illustrated in FIG. 53, instead of the driving assistance apparatus 10 according to the first embodiment described above, the driving assistance apparatus 310 according to the third embodiment is mounted in a vehicle 300 according to the third embodiment.

The driving assistance apparatus 310 includes a gaze estimation unit 140 and a driver skill level determination unit 150 that determines the skill level of the driver in addition to the configuration of the driving assistance apparatus 10 of the first embodiment described above, and further includes a driver attention state estimation unit 320 that acquires information from the prediction error calculation unit 110, the gaze estimation unit 140, and the driver skill level determination unit 150 to estimate an attention state of the driver, instead of the driver attention state estimation unit 120 of the first embodiment described above.

The driver skill level determination unit 150 determines the skill level of the driver, for example, based on various detection results obtained by the ECU 20 from the detection apparatus 40 (see FIG. 1). From the various detection results of the detection apparatus 40, it is possible to know a driving manipulation situation of the vehicle 104 by the driver. Therefore, it is possible to estimate that the skill level of the driver is low from a detection result in which sudden steering, sudden start, and sudden stop are frequent or the like, for example.

The driver attention state estimation unit 320 estimates the attention state of the driver for each of a plurality of areas based on a magnitude of a degree of inappropriateness of the attention state of the driver based on a prediction error in each of the plurality of areas and a direction of a gaze of the driver estimated by the gaze estimation unit 140 similarly to the driver attention state estimation unit 220 of the second embodiment described above.

At this time, the driver attention state estimation unit 320 changes thresholds of attention state indexes in the plurality of areas for estimating the attention state of the driver according to the skill level of the driver. That is, the driver attention state estimation unit 320 sets the thresholds of the attention state indexes to be low when the skill level of the driver is low. Furthermore, the driver attention state estimation unit 320 sets the thresholds of the attention state indexes to be high when the skill level of the driver is high.

Such setting by the driver attention state estimation unit 320 is based on the fact that a driver with a lower skill level has a higher tendency to direct his/her gaze to an area with a large prediction error than a driver with a higher skill level.

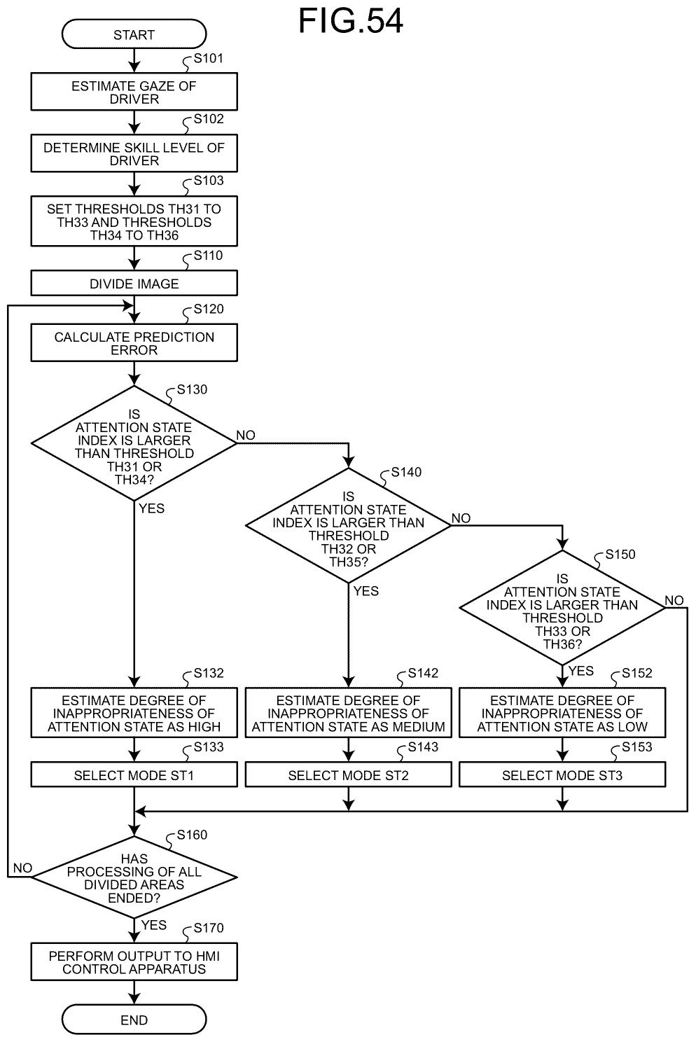

FIG. 54 is a flowchart illustrating an example of a procedure of driving assistance processing performed by the driving assistance apparatus 310 according to the third embodiment. Note that, in the processing illustrated in FIG. 54, Steps S102 and S103 are processes newly added to the processing illustrated in FIG. 52 of the second embodiment described above.

As illustrated in FIG. 54, the gaze estimation unit 140 included in the driving assistance apparatus 310 according to the third embodiment estimates a destination of the gaze of the driver from a face image of the driver captured by the driver monitoring camera 42 (Step S101). Furthermore, the driver skill level determination unit 150 acquires detection results of the detection apparatus 40 from the ECU 20, and determines a skill level of the driver based on these detection results (Step S102).

The driver attention state estimation unit 320 changes the setting of the thresholds of the attention state indexes calculated from the prediction error, the gaze of the driver, and the like based on a determination result of the driver skill level determination unit 150 (Step S103).

When it is determined that the skill level of the driver is low, the driver attention state estimation unit 320 sets a threshold TH31, a threshold TH32 larger than the threshold TH31, and a threshold TH33 larger than the threshold TH32. When it is determined that the skill level of the driver is high, the driver attention state estimation unit 320 sets a threshold TH34 larger than the threshold TH31, a threshold TH35 larger than the thresholds TH32 and TH34, and a threshold TH36 larger than the thresholds TH33 and TH35.

Furthermore, the driver attention state estimation unit 220 divides an image captured by the vehicle exterior camera 41 into a plurality of areas (Step S110), and calculates a prediction error for each of the areas (Step S120).

Furthermore, the driver attention state estimation unit 220 sorts the attention state indexes calculated from the prediction error and the gaze of the driver according to the thresholds TH31 to TH33 or the thresholds TH34 to TH36 set based on the skill level of the driver (Steps S130, S140, and S150), and estimates the attention state of the driver based on these attention state indexes (Steps S132, S142, and S152).

The output control unit 130 selects the modes ST1 to ST3 of presentation of latent information based on an estimation result of the driver attention state estimation unit 220 (Steps S133, S143, and S153).

The driving assistance apparatus 310 of the third embodiment repeats the above processing for all the areas (Step S160: No), and after the processing for all the areas ends (Step S160: Yes), outputs the generated driving assistance information to the HMI control apparatus 30 (Step S170).

Thus, the driving assistance processing by the driving assistance apparatus 310 of the third embodiment ends.

Note that information included in the driving assistance information output to the HMI control apparatus 30 as described above by the driving assistance apparatus 310 of the third embodiment can be presented by the information presentation apparatus 60 in the various modes described in the first embodiment and the first to third modifications, for example.

At this time, the driving assistance apparatus 310 of the third embodiment may be provided with the manifest information calculation unit 111, the TTC calculation unit 112, or the like similarly to the fifth or sixth modification or the like of the first embodiment described above such that latent information and manifest information included in the driving assistance information can be presented.

Alternatively, the driving assistance apparatus 310 of the third embodiment may be configured to be able to output the driving assistance information to the ECU 20, the external server 90, or the like, similarly to the fourth or seventh modification or the like of the first embodiment described above.

According to the driving assistance apparatus 310 of the third embodiment, the attention state of the driver is estimated based on the skill level of driving of the driver in addition to the prediction error. As a result, it is possible to estimate the attention state with higher accuracy according to the individual driver.

According to the driving assistance apparatus 310 of the third embodiment, an area in which the attention state index is larger than any of the thresholds TH31 to TH33 is extracted from among the plurality of areas when the skill level of the driver is low, and an area in which the attention state index exceeds any of the thresholds TH34 to TH36 is extracted from among the plurality of areas when the skill level of the driver is high.

As a result, it is possible to detect the degree of inappropriateness of the attention state of the driver according to the skill level of the driver. Therefore, it is possible to perform appropriate information presentation according to the individual driver.

Note that the driving assistance apparatus 310 includes the gaze estimation unit 140 in the third embodiment described above. However, the driving assistance apparatus 310 does not necessarily include the gaze estimation unit 140, and in this case, the driving assistance apparatus 310 according to the third embodiment may be configured to perform processing of switching the setting of the thresholds according to the skill level of the driver in addition to the processing of the driving assistance apparatus 10 according to the first embodiment.

Furthermore, in the above-described first to third embodiments and first to seventh modifications, the driving assistance apparatus 10, 210, 310, or the like determines a magnitude of an index calculated from the prediction error and the like based on, for example, three thresholds. However, the number of thresholds set for such an index may be two or less, or may be four or more.

Furthermore, in the above-described first to third embodiments and first to seventh modifications, the driving assistance apparatus 10, 210, 310, or the like is configured as one apparatus such as an ECU, for example. However, the functions described in the above-described first to third embodiments and first to seventh modifications may be implemented by a driving assistance system configured by combining a plurality of apparatuses. In this case, an apparatus that implements some functions may be provided outside the vehicle.

Although some embodiments of the present invention have been described, these embodiments have been presented as examples, and are not intended to limit the scope of the invention. These embodiments can be implemented in various other modes, and various omissions, substitutions, and changes can be made within a scope not departing from the gist of the invention. These embodiments and modifications thereof are included in the scope and gist of the invention and are also included in the invention described in the claims and the equivalent scope thereof.

What is claimed is:

1. A driving assistance apparatus comprising:
a memory; and
a processor coupled to the memory, and configured to:
calculate a prediction error that is a difference between a predicted image and an actual image, the predicted image being predicted from an image in a traveling direction of a vehicle captured by a vehicle exterior camera that captures a periphery of the vehicle, an actual situation being captured in the actual image;
estimate an attention state of a driver, based on the prediction error; and
output driving assistance information for prompting an attention state and/or a behavior change and/or a consciousness change in relation to a driving manipulation, which are more appropriate for driving at that time, based on the attention state.

2. The driving assistance apparatus according to claim 1, wherein
the processor is configured to extract an area in which the prediction error is larger than a predetermined threshold among a plurality of areas in the image, and estimates one or more states in which the extracted area is biased from a center of the plurality of areas, excessively concentrated on a part, and/or excessively dispersed throughout.

3. The driving assistance apparatus according to claim 1, wherein
the processor is configured to extract an area in which a temporal variance value of the prediction error is larger than a predetermined threshold among a plurality of areas of a temporally continuous image group, and estimates one or more states in which the extracted area is biased from a center of the plurality of areas, excessively concentrated on a part, and/or excessively dispersed throughout.

4. The driving assistance apparatus according to claim 1, wherein
the processor is configured to output driving assistance information for unconsciously changing visual behavior to correct a bias when there is the bias in the estimated attention state, to disperse an excessive concentration when there is the excessive concentration on a part, and to concentrate an excessive dispersion when there is the excessive dispersion throughout.

5. The driving assistance apparatus according to claim 1, wherein
the processor is configured to outputs driving assistance information for calling attention to correct a bias when there is the bias in the estimated attention state, to disperse an excessive concentration when there is the excessive concentration on a part, and to concentrate an excessive dispersion when there is the excessive dispersion throughout.

6. The driving assistance apparatus according to claim 1, wherein
the processor is further configured to estimate, from a face image of the driver captured by a driver monitoring camera that captures an image of an interior of the vehicle, an area to which a gaze of the driver is directed in the prediction error, and
the processor is configured to estimate the attention state of the driver based on a direction of the gaze in addition to the prediction error.

7. The driving assistance apparatus according to claim 6, wherein
the processor is configured to estimate likelihood of attracting attention based on a prediction error of an area to which the gaze of the driver is directed and a prediction error of an arbitrary area to which the gaze is not directed.

8. The driving assistance apparatus according to claim 7, wherein
the processor is configured to output driving assistance information for unconsciously changing visual behavior to induce an appropriate attention state when the likelihood of attracting the attention is high in the estimated attention state.

9. The driving assistance apparatus according to claim 7, wherein
the processor is configured to output driving assistance information for calling an attention to make the driver conscious when the likelihood of attracting the attention is high in the estimated attention state.

10. The driving assistance apparatus according to claim 1, wherein
the processor is further configured to determine a skill level of driving by the driver based on manipulation information of the vehicle by the driver obtained from a detection apparatus that detects a state of each part of the vehicle, and
the processor is configured to control output based on the skill level in addition to the prediction error.

11. The driving assistance apparatus according to claim 10, wherein
the processor is configured to output, in a more conspicuous mode in a case where the skill level is lower, driving assistance information for unconsciously changing visual behavior to correct a bias when there is the bias in the estimated attention state, to disperse an excessive concentration when there is the excessive concentration on a part, and to concentrate an excessive dispersion when there is the excessive dispersion throughout.

12. The driving assistance apparatus according to claim 10, wherein
the processor is configured to output, in a more conspicuous mode in a case where the skill level is lower, driving assistance information for calling attention to correct a bias when there is the bias in the estimated attention state, to disperse an excessive concentration when there is the excessive concentration on a part, and to concentrate an excessive dispersion when there is the excessive dispersion throughout.

13. The driving assistance apparatus according to claim 1, wherein
the processor is configured to output the driving assistance information to an information presentation control apparatus controlling an information presentation apparatus that presents information to the driver,
the information presentation apparatus includes a head-up display, and an in-vehicle monitor, a meter display, a pillar display, a mirror display, a light emitting device, and a speaker which are mounted in the vehicle, and
the information presentation control apparatus causes at least any of the head-up display, the in-vehicle monitor, the meter display, the pillar display, the mirror display, the light emitting device, and the speaker to present the information.

14. The driving assistance apparatus according to claim 1, wherein
the processor is configured to output the driving assistance information to an information presentation control apparatus controlling an information presentation apparatus that presents information to the driver,
the information presentation apparatus includes a head-up display, and an in-vehicle monitor, a meter display, a pillar display, a mirror display, a light emitting device, and a speaker which are mounted in the vehicle, and
the information presentation control apparatus causes two or more information presentation apparatuses among the head-up display, the in-vehicle monitor, the meter display, the pillar display, the mirror display, the light emitting device, and the speaker to present the information divided into a plurality of portions, respectively.

15. The driving assistance apparatus according to claim 1, wherein
the processor is configured to output, to an on-vehicle electronic controller that controls the vehicle, operation information that is associated with an area to which attention of the driver is to be called and gives an instruction on an operation of the vehicle; and
the on-vehicle electronic controller is configured to cause a vehicle control apparatus that decelerates the vehicle to perform the operation based on the operation information.

16. The driving assistance apparatus according to claim 15, wherein
the vehicle control apparatus includes a braking device that brakes the vehicle and an engine control apparatus that performs control of an engine output of the vehicle, and
the on-vehicle electronic controller is configured to decelerate the vehicle by performing at least any of
braking the vehicle by the braking device, and
reducing acceleration of the vehicle by the engine control apparatus.

17. The driving assistance apparatus according to claim 15, wherein
the processor is configured to output the operation information having a higher deceleration effect of the vehicle as the prediction error on which the area to which the attention of the driver is to be called is based is larger.

18. The driving assistance apparatus according to claim 1, wherein
the processor is configured to output information of the attention state and vehicle manipulation information acquired from a vehicle network to an external server that accumulates the information of the attention state.

19. A driving assistance system comprising:
a memory; and
a processor coupled to the memory, and configured to:
calculate a prediction error that is a difference between a predicted image and an actual image, the predicted image being predicted from an image in a traveling direction of a vehicle captured by a vehicle exterior camera that captures a periphery of the vehicle, an actual situation being captured in the actual image;
estimate an attention state of a driver, based on the prediction error; and
output driving assistance information for prompting an attention state and/or a behavior change and/or a consciousness change in relation to a driving manipulation, which are more appropriate for driving at that time, based on the attention state.

20. A driving assistance method comprising:
calculating a prediction error that is a difference between a predicted image and an actual image, the predicted image being predicted from an image in a traveling direction of a vehicle captured by a vehicle exterior camera that captures a periphery of the vehicle, an actual situation being captured in the actual image;
estimating an attention state of a driver, based on the prediction error; and
outputting driving assistance information for prompting an attention state and/or a behavior change and/or a consciousness change in relation to a driving manipulation, which are more appropriate for driving at that time, based on the attention state.
